(19) United States
(12) Patent Application Publication
(10) Pub. No.: US 2007/0020566 A1
(43) Pub. Date: Jan. 25, 2007

(54) Photothermographic material and image forming method

(75) Inventor: Tomoyuki Ohzeki, Kanagawa (JP)

Correspondence Address: TAIYO CORPORATION, 401 HOLLAND LANE, #407, ALEXANDRIA, VA, 22314, US

(73) Assignee: FUJI PHOTO FILM., LTD.

(21) Appl. No.: 11/529,243

(22) Filed: Sep. 29, 2006

Related U.S. Application Data
(63) Continuation-in-part of application No. 11/196,403, filed on Aug. 4, 2005.
(63) Continuation-in-part of application No. 10/736,561, filed on Dec. 17, 2003.

(30) Foreign Application Priority Data
Aug. 9, 2004 (JP) 2004-232752
Dec. 19, 2002 (JP) 2002-367663
Mar. 5, 2003 (JP) 2003-58440

(51) Int. Cl. G03C 1/00

(52) U.S. Cl. 430/619

(57) ABSTRACT

A photothermographic material having, on at least one side of a support, an image forming layer containing at least a photosensitive silver halide, a non-photosensitive organic silver salt, a reducing agent, and a binder, wherein (1) the photosensitive silver halide comprises tabular grains having a mean aspect ratio of 2 to 100 and a mean equivalent spherical diameter of 0.3 μm to 10 μm; (2) 50% by weight or more of the binder is a hydrophilic binder; (3) the photothermographic material comprises a means for nucleation; and (4) an average gradient of a photographic characteristic curve of the photothermographic material is from 1.8 to 4.3. An X-ray image forming method using the above photothermographic material is also disclosed. A photothermographic material that is improved in coated surface state and has high sensitivity and high image quality, and an X-ray image forming method using the same are provided.

### CROSS-REFERENCE TO RELATED APPLICATIONS

This application is a continuation-in-part of U.S. patent application Ser. No. 11/196,403 which claims priority under 35 USC 119 from Japanese Patent Application No. 2004-232752; this application is a continuation-in-part of U.S. patent application Ser. No. 10/736,561, which claims priority under 35 USC 119 from Japanese Patent Application Nos. 2002-367,663 and 2003-58,440; the entire disclosures of all the patent documents listed above are hereby expressly incorporated by reference herein.

### BACKGROUND OF THE INVENTION

1. Field of the Invention

The present invention relates to a photothermographic material and an image forming method using the same.

2. Description of the Related Art

In recent years, decreasing the amount of processing liquid waste in the field of films for medical imaging has been desired from the viewpoints of protecting the environment and economy of space. Technology is therefore required for photosensitive thermal developing image recording materials which can be imagewise exposed effectively by laser image setters or laser imagers and thermally developed to obtain clear black-toned images of high resolution and sharpness, for use in medical diagnostic applications. An image forming system using photosensitive thermal developing image recording materials does not require liquid processing chemicals and can therefore be supplied to customers as a simpler and environmentally friendly system.

While similar requirements also exist in the field of general image forming materials, images for medical imaging in particular require high image quality excellent in sharpness and granularity because fine depiction is required, and further require blue-black image tone from the viewpoint of easy diagnosis. Various kinds of hard copy systems utilizing dyes or pigments, such as ink jet printers and electrophotographic systems, have been marketed as general image forming systems, but they are not satisfactory as output systems for medical images.

Photothermographic materials utilizing organic silver salts are described in many documents. Photothermographic materials generally have an image forming layer including a catalytically active amount of a photocatalyst (for example, silver halide), a reducing agent, a reducible silver salt (for example, an organic silver salt), and if necessary, a toner for controlling the color tone of developed silver images, dispersed in a binder. Photothermographic materials form black silver images by being heated to a high temperature (for example, 80° C. or higher) after imagewise exposure to cause an oxidation-reduction reaction between a silver halide or a reducible silver salt (functioning as an oxidizing agent) and a reducing agent. The oxidation-reduction reaction is accelerated by the catalytic action of a latent image on the silver halide generated by exposure. As a result, a black silver image is formed on the exposed region. The Fuji Medical Dry Imager FM-DPL is an example of a medical image forming system that has been made commercially available.

Methods of manufacturing such photothermographic material include a method of manufacturing by a solvent coating, and a method of coating an aqueous coating solution using an aqueous dispersion of fine polymer particles or an aqueous solution of a water soluble polymer as a main binder followed by drying. Since the latter method does not require a process of solvent recovery or the like, a production facility therefor is simple, environmental burden is small, and the method is advantageous for mass production. However, because the coating solution has no setting ability, there are problems such as drying unevenness caused by disturbance of the coated layers due to drying wind after coating of the coating solution.

In U.S. Pat. (USP) Nos. 6,713,241 and 6,391,537, use of a hydrophilic binder such as gelatin as a binder is described; however, there are problems in that it is difficult to obtain high sensitivity and that various sensitizing means for increasing the sensitivity cause a large amount of fogging.

In the photothermographic material, it is necessary that chemical components necessary for forming an image are contained in the film in advance. For this reason, these chemical components exert influences on storage stability of the photothermographic material up until it is used. Further, even after an image has been formed by subjecting the photothermographic material to thermal development, since these chemical components remain in the film as unreacted components or reaction products, these chemical components exert influences on transparency of the film and the image color tone and, moreover, exert significant influences on the storage stability of the image. The use of a hydrophilic binder in the image forming layer further worsens the storage stability, and therfore, development of means for improvement is desired.

On the other hand, attempts have also been made at applying the above-mentioned photothermographic material as photosensitive material for photographing. The term “photosensitive material for photographing” as used herein means a photosensitive material on which images are recorded by a one-shot exposure through a lens, rather than by writing the image information by a scanning exposure with a laser beam or the like. Conventionally, photosensitive materials for photographing are generally used in the field of wet developing photosensitive materials, and include films for medical use such as direct or indirect radiography films, mammography films and the like. For example, a photothermographic material containing tabular silver iodobromide grains described in Japanese Patent Application Laid-Open (JP-A) No. 59-142539, and a photosensitive material for medical use containing tabular grains that have a high content of silver chloride and have (100) major faces, and that are coated on both sides of a support, which is described in JP-A No. 10-282606, are known.

However, photosensitive materials for photographing require even higher sensitivity, and thus, increase in the grain size of the photosensitive silver halide and increase in the amount of coated silver are necessary. As a result, the above means exert adverse influences such as increase in haze of the film and deterioration of storage stability, whereby more serious technical problems have arisen.

### SUMMARY OF THE INVENTION

A first aspect of the invention is to provide a photothermographic material comprising, on at least one side of a support, an image forming layer comprising at least a photosensitive silver halide, a non-photosensitive organic silver salt, a reducing agent, and a binder, wherein

(1) the photosensitive silver halide comprises tabular grains having a mean aspect ratio of 2 to 100 and a mean equivalent spherical diameter of 0.3 μm to 10 μm;

(2) 50% by weight or more of the binder is a hydrophilic binder;

(3) the photothermographic material comprises a means for nucleation; and

(4) an average gradient of a photographic characteristic curve of the photothermographic material is from 1.8 to 4.3.

A second aspect of the invention is to provide an image forming method comprising:

(a) providing a photothermographic material comprising, on at least one side of a support, an image forming layer comprising at least a photosensitive silver halide, a non-photosensitive organic silver salt, a reducing agent, and a binder, wherein the photosensitive silver halide comprises tabular grains having a mean aspect ratio of 2 to 100 and a mean equivalent spherical diameter of 0.3 μm to 10 μm, 50% by weight or more of the binder is a hydrophilic binder, the photothermographic material contains a means for nucleation, and an average gradient of a photographic characteristic curve of the photothermographic material is from 1.8 to 4.3;

(b) providing an assembly for forming an image by placing the photothermographic material between a pair of fluorescent intensifying screens;

(c) putting an analyte between the assembly and an X-ray source;

(d) irradiating the analyte with X-rays;

(e) taking the photothermographic material out of the assembly, and

(f) heating the removed photothermographic material in a temperature range of 90° C. to 180° C.

### BRIEF DESCRIPTION OF THE DRAWINGS

FIG. 1 is a structural diagram illustrating an embodiment of a thermal developing apparatus according to the present invention.

FIG. 2 shows an emission spectrum of a fluorescent intensifying screen A.

### DETAILED DESCRIPTION OF THE INVENTION

An object of the present invention is to provide a photothermographic material and an image forming method which are improved in coated surface state and excellent in image quality with high sensitivity, and in particular, it is to provide an improved photothermographic material and an X-ray image forming method which give a clear image with low haze.

As a result of intense research regarding a composition to provide a photosensitive material for photographing which can produce an excellent coating state and high image quality, the present inventors found that the use of a hydrophilic binder as a binder for the image forming layer, the use of large tabular grains for the photosensitive silver halide, and the use of nucleating means are effective for solving the problems described above, and thereby have achieved the invention. Furthermore, the inventors found that the use of a compound represented by formula (I) or (II) as a silver ion carrier is more effective. Moreover, the inventors have achieved the invention of an X-ray image forming method using the photothermographic materials described above.

The present invention provides a photothermographic material and an X-ray image forming method which exhibit high image quality with high sensitivity. Particularly, the present invention provides an improved photothermographic material and an X-ray image forming method which give a clear image with low haze.

The present invention is explained below in detail.

1. Photothermographic Material

In the present invention, a photographic characteristic curve is a D-log E curve representing a relationship between the common logarithm (log E) of a light exposure value, i.e., the exposure energy, and the optical density (D), i.e., a scattered light photographic density, by plotting the former on the abscissa axis and the latter on the ordinate axis. Gradation in the present invention is expressed as a gradient of a line joining the points at fog+(optical density of 0.25) and fog+(optical density of 2.0) on a photographic characteristic curve (i.e., the value equals tan θ when the angle between the line and the horizontal axis is θ).

In the present invention, an average gradient is from 1.8 to 4.3. It is preferably from 2.0 to 4.0, and more preferably from 2.2 to 3.8.

The photothermographic material of the invention has, on at least one side of a support, an image forming layer containing at least a photosensitive silver halide, a non-photosensitive organic silver salt, a reducing agent, and a binder.

The photothermographic material of the invention has one or more image forming layers constructed on a support. The image forming layer may further comprise additional materials as desired and necessary, such as an antifoggant, a development accelerator, a film-forming promoting agent, and other auxiliary agents. The photothermographic material of the invention preferably has a non-photosensitive layer. The non-photosensitive layer according to the present invention may be one layer or plural layers.

Concerning the photosensitive silver halide grains used in the present invention, any grain size large enough to achieve the required high sensitivity can be selected. In the present invention, a mean equivalent spherical diameter of the tabular silver halide is from 0.3 μm to 10.0 μm, preferably from 0.35 μm to 7.0 μm, and more preferably from 0.4 μm to 5.0 μm. The term “equivalent spherical diameter” used here means a diameter of a sphere having the same volume as the volume of one silver halide grain. As for a measuring method, the volume of a grain is calculated from projected area and thickness of individual grains by observation through an electron microscope, and thereafter the equivalent spherical diameter is determined by converting the volume to a sphere having a volume equivalent to the obtained volume.

Concerning the image forming layer according to the present invention, 50% by weight or more of the binder is a hydrophilic binder, and the image forming layer comprises a means for nucleation.

Further the image forming layer preferably comprises at least one compound having an imide group represented by the following formula (I) or (II) as a silver ion carrier.

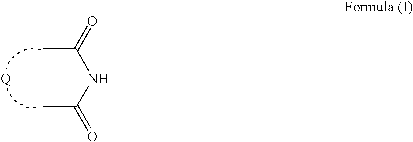

In formula (I), Q represents an atomic group necessary for forming a 5- or 6-membered imide ring.

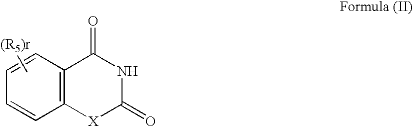

In formula (II), R₅ independently represents one selected from a hydrogen atom, an alkyl group, a cycloalkyl group, an alkoxy group, an alkylthio group, an arylthio group, a hydroxyl group, a halogen atom, or an N(R₈R₉) group, wherein R₈ and R₉ each independently represent one selected from a hydrogen atom, an alkyl group, an aryl group, a cycloalkyl group, an alkenyl group, or a heterocyclic group. r represents 0, 1, or 2. R₈ and R₉ may bond to each other to form a substituted or unsubstituted 5 to 7-membered heterocycle. Two R₅'s may link together to form an aromatic, heteroaromatic, alicyclic, or heterocyclic condensed ring. X represents one selected from O, S, Se, or N(R₆), wherein R₆ represents one selected from a hydrogen atom, an alkyl group, an aryl group, a cycloalkyl group, an alkenyl group, or a heterocyclic group.

The photothermographic material of the invention preferably contains at least one compound selected from among polyacrylamide and derivatives thereof. More preferably, the non-photosensitive organic silver salt is prepared in the presence of at least one compound selected from among the above-mentioned polyacrylamide and derivatives thereof, and even more preferably, the non-photosensitive organic silver salt is nano-particles.

The means for nucleation according to the present invention is preferably at least one of a nucleator and an infectious developing reducing agent. The nucleator is preferably a compound selected from the group consisting of a hydrazine derivative, a vinyl compound, and a quaternary onium compound. The infectious developing reducing agent is preferably a compound represented by formula (R1) described below.

In the invention, the non-photosensitive organic silver salt preferably has a silver behenate content of 50 mol % or higher. Further, the hydrophilic binder of the image forming layer is preferably gelatin or a gelatin derivative. It is more preferred that the mass ratio of the non-photosensitive organic silver salt relative to the binder in the image forming layer is from 1.0 to 2.5.

In the invention, it is preferred that the amount of coated silver contained in organic silver salt and silver halide is from 0.1 g/m² to 5.0 g/m² per one side and the optical density after thermal development is 2.5 or more. It is more preferred that the amount of coated silver is from 0.5 g/m² to 2.0 g/m² per one side and the optical density after thermal development is 2.7 or more.

(Organic Silver Salt)

1) Composition

The organic silver salt which can be used in the present invention is relatively stable to light but serves as to supply silver ions and forms silver images when heated to 80° C. or higher in the presence of an exposed photosensitive silver halide and a reducing agent. The non-photosensitive organic silver salt may be any material containing a source capable of supplying silver ions that are reducible by a reducing agent. Such a non-photosensitive organic silver salt is disclosed, for example, in JP-A No. 10-62899 (paragraph Nos. 0048 to 0049), European Patent (EP) No. 0803764A1 (page 18, line 24 to page 19, line 37), EP No. 0962812A1, JP-A Nos. 11-349591, 2000-7683, and 2000-72711, and the like. A silver salt of an organic acid, particularly, a silver salt of long chained aliphatic carboxylic acid (having 10 to 30 carbon atoms, and preferably having 15 to 28 carbon atoms) is preferable. Preferred examples of the silver salt of fatty acid can include, for example, silver lignocerate, silver behenate, silver arachidinate, silver stearate, silver oleate, silver laurate, silver capronate, silver myristate, silver palmitate, silver erucate, and mixtures thereof. In the invention, among these silver salts of fatty acid, it is preferred to use a silver salt of fatty acid with a silver behenate content of 50 mol % or higher, more preferably, 85 mol % or higher, and even more preferably, 95 mol % or higher. Further, it is preferred to use a silver salt of fatty acid with a silver erucate content of 2 mol % or lower, more preferably, 1 mol % or lower, and even more preferably, 0.1 mol % or lower.

It is preferred that the content of silver stearate is 1 mol % or lower. When the content of silver stearate is 1 mol % or lower, a silver salt of organic acid having low fog, high sensitivity and excellent image storability can be obtained. The above-mentioned content of silver stearate is preferably 0.5 mol % or lower, and particularly preferably, silver stearate is not substantially contained. Further, in the case where the silver salt of organic acid includes silver arachidinate, it is preferred that the content of silver arachidinate is 6 mol % or lower in order to obtain a silver salt of organic acid having low fog and excellent image storability. The content of silver arachidinate is more preferably 3 mol % or lower.

2) Shape

The organic silver salt in the present invention is preferably nano-particles. A mean particle size of the nano-particles is preferably from 10 nm to 1000 nm, and more preferably from 30 nm to 400 nm.

When the particle size is smaller than the above range, fog increases, fog increases during storage of unused photothermographic material, or deterioration in fog occurs during storage of the processed image.

Further, when the particle size is larger than the above range, it exert bad influences such as increase in haze, retardation of development, and deterioration in precipitation of solid component while keeping the organic silver salt dispersion for a long time.

There is no particular restriction on the shape of the organic silver salt usable in the invention and it may be needle-like, bar-like, tabular, or flake shaped. In the invention, a flake shaped organic silver salt is preferred. Short needle-like, rectangular, cuboidal, or potato-like indefinite shaped particles with the major axis to minor axis ratio being less than 5 are also used preferably. Such organic silver particles suffer less from fogging during thermal development compared with long needle-like particles with the major axis to minor axis length ratio of 5 or more. Particularly, a particle with the major axis to minor axis ratio of 3 or less is preferred since it can improve the mechanical stability of the coating film. In the present specification, the flake shaped organic silver salt is defined as described below. When an organic silver salt is observed under an electron microscope, calculation is made while approximating the shape of an organic silver salt particle to a rectangular body and assuming each side of the rectangular body as a, b, c from the shorter side (c may be identical with b) and determining x based on numerical values a, b for the shorter side as below.
x=b/a

As described above, x is determined for the particles by the number of about 200 and those capable of satisfying the relation: x (average)≧1.5 as an average value x is defined as a flake shape. The relation is preferably: 30≧x (average)≧1.5 and, more preferably, 15≧x (average)≧1.5. By the way, needle-like is expressed as 1≦x (average)≦1.5.

In the flake shaped particle, a can be regarded as a thickness of a tabular particle having a major plane with b and c being as the sides. a in average is preferably from 1 nm to 300 nm and, more preferably, 5 nm to 100 nm. c/b in average is preferably from 1 to 9, more preferably from 1 to 6, even more preferably from 1 to 4 and, most preferably 1 to 3.

In the invention, an equivalent spherical diameter can be measured by a method of photographing a sample directly by using an electron microscope and then image processing the negative images.

In the flake shaped particle, the equivalent spherical diameter of the particle/a is defined as an aspect ratio. The aspect ratio of the flake particle is preferably from 1.1 to 30 and, more preferably from 1.1 to 15, from the viewpoint of causing less agglomeration in the photothermographic material and improving the image storability.

As the particle size distribution of the organic silver salt, monodispersion is preferred. In the monodispersion, the percentage for the value obtained by dividing the standard deviation for the length of minor axis and major axis by the minor axis and the major axis respectively is, preferably, 100% or less, more preferably, 80% or less and, even more preferably, 50% or less. The shape of the organic silver salt can be measured by analyzing a dispersion of an organic silver salt as transmission type electron microscopic images. Another method of measuring the monodispersion is a method of determining of the standard deviation of the volume weighted mean diameter of the organic silver salt, in which the percentage for the value defined by the volume weight mean diameter (variation coefficient) is preferably 100% or less, more preferably, 80% or less and, even more preferably, 50% or less. The monodispersion can be determined from particle size (volume weighted mean diameter) obtained, for example, by a measuring method of irradiating a laser beam to organic silver salts dispersed in a liquid, and determining a self correlation function of the fluctuation of scattered light to the change of time.

3) Preparation

Methods known in the art can be applied to the method for producing the organic silver salt used in the invention and to the dispersing method thereof. For example, reference can be made to JP-A No. 10-62899, EP Nos. 0803763A1 and 0962812A1, JP-A Nos. 11-349591, 2000-7683, 2000-72711, 2001-163889, 2001-163890, 2001-163827, 2001-33907, 2001-188313, 2001-83652, 2002-6442, 2002-49117, 2002-31870, and 2002-107868, and the like.

The organic silver salt used in the present invention is preferably prepared in the presence of a compound represented by the following formulae (W1) or (W2). The compound may be added at the time of the preparing process of organic silver salt, or at the dispersing process.

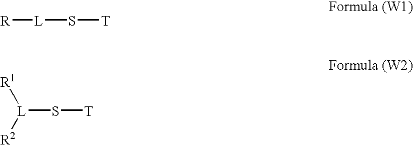

In the formulae, R represents a hydrophobic group, and at least one of R¹ and R² is a hydrophobic group. L represents a linking group. T represents an oligomer part, and L (linking group) and T (oligomer part) combine with thio bond (—S—). In case of formula (W1), L is not an essential group.

The number of the hydrophobic group is determined by the linking group L. The hydrophobic group is a group selected from a saturated or unsaturated alkyl group, an arylalkyl group, or an alkylaryl group, where each alkyl group may be linear or branched. Preferably, the hydrophobic R, R₁, and R₂ each independently has 8 to 21 carbon atoms. The representative examples of the compound represented by formula (W1) are shown in the following formulae.

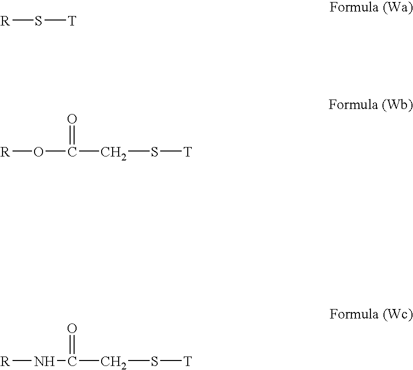

The representative examples of the compound represented by formula (W2) are shown in the following formulae.

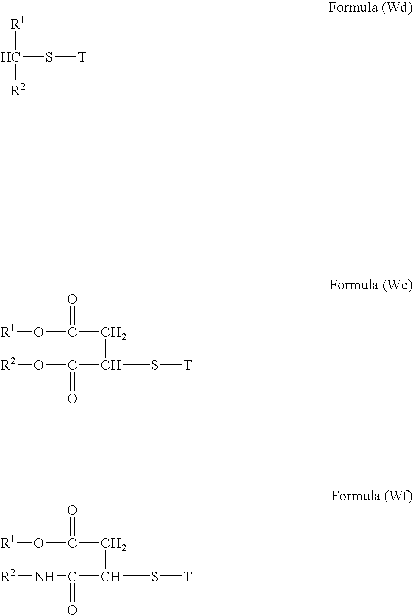

The oligomer part T is based on an oligomer derived from a vinyl monomer having an amide group and is polymerized at the vinyl part, and after forming the oligomer, the amide part becomes a non-ionic polar group which compose a hydrophilic group. The oligomer part T may be a copolymerized oligomer composed by one or plural monomers.

The specific examples of the monomer used for forming the oligomer part T include acrylamide, methacrylamide, an acrylamide derivative, a methacrylamide derivative, and 2-vinyl pyrrolidone.

These monomers can be expressed by the following formulae. 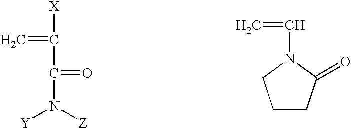
Acrylamide or a derivative thereof, 2-Vinylpyrrolidone methacrylamide or a derivative thereof.

In the formulae, X represents a hydrogen atom or an alkyl group having 1 to 10 carbon atoms. X is preferably a hydrogen atom or a methyl group. Y and Z each independently represent a hydrogen atom, an alkyl group having 1 to 10 carbon atoms, a substituted alkyl group having 1 to 10 carbon atoms. Y and Z are preferably a hydrogen atom, a methyl group, an ethyl group, or —C(CH₂OH)₃ group. X and Y may be the same or different.

The number of repeating units of the oligomer part T is 20 or less, and preferably from 5 to 15.

Examples of the compound represented by formula (W1) or (W2) used in the present invention are set forth below, however, the present invention is not limited to these.

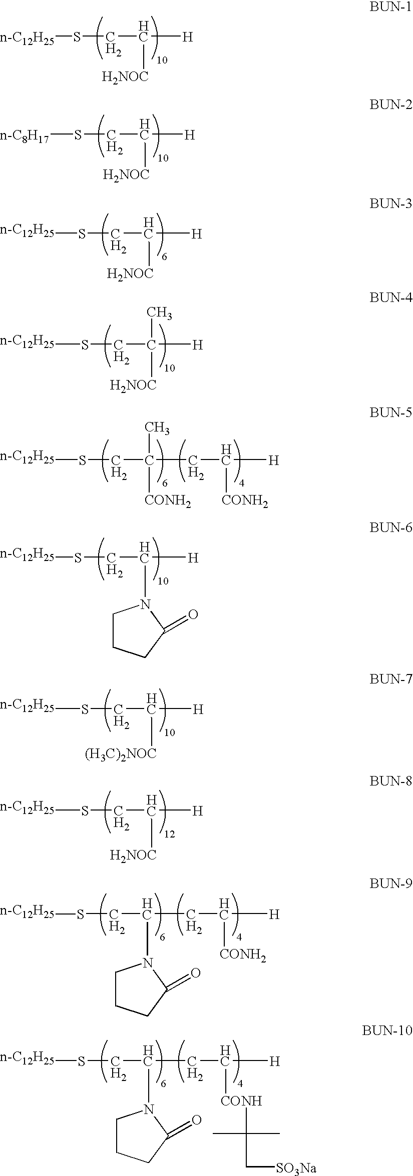

The compound represented by formula (W1) or (W2) which is obtained from a vinyl polymer having the said amide group is an oligomer surfactant. The oligomer surfactant can be produced by a well-known method or by simply modifying a well-known method in the technical art. One example of the synthesis method is described hereinafter. An aqueous nano-particle dispersion of silver carboxylate can be prepared by a media grinding method comprising the following steps;

(A) preparing a silver carboxylate dispersion containing silver carboxylate, water as a carrier of carboxylate, and the above-described oligomer surfactant as a surface modifing agent,

(B) mixing the obtained silver carboxylate dispersion and hard media for grinding having a mean particle diameter of 500 μm or less,

(C) adding the mixture of step (B) into a high speed mill,

(D) grinding the mixture of step (C) until reaching the particle size distribution of silver carboxylate in which 90% by weight of the silver carboxylate particles has a particle diameter of less than 1 □m, and

(E) separating the media for grinding from the mixture obtained by grinding in step (D).

When a photosensitive silver salt is present together during dispersion of the organic silver salt, fog increases and sensitivity becomes remarkably lower, so that it is more preferred that the photosensitive silver salt is not substantially contained during dispersion. In the invention, the amount of the photosensitive silver salt to be disposed in the aqueous dispersion is preferably 1 mol % or less, more preferably 0.1 mol % or less, per 1 mol of the organic silver salt in the solution and, even more preferably, positive addition of the photosensitive silver salt is not conducted.

In the invention, the photothermographic material can be prepared by mixing an aqueous dispersion of an organic silver salt and an aqueous dispersion of a photosensitive silver salt and the mixing ratio between the organic silver salt and the photosensitive silver salt can be selected depending on the purpose. The ratio of photosensitive silver salt relative to organic silver salt is preferably in a range of from 1 mol % to 30 mol %, more preferably, from 2 mol % to 20 mol % and, particularly preferably, 3 mol % to 15 mol %. A method of mixing two or more kinds of aqueous dispersions of organic silver salts and two or more kinds of aqueous dispersions of photosensitive silver salts upon mixing is used preferably for controlling the photographic properties.

4) Addition Amount

While an organic silver salt in the invention can be used in a desired amount, a total amount of coated silver including silver halide is preferably in a range of from 0.1 g/m² to 5.0 g/m², more preferably from 0.3 g/m² to 3.0 g/m², and even more preferably from 0.5 g/m² to 2.0 g/m². Particularly, in order to improve image storability, the total amount of coated silver is preferably 1.8 mg/m² or less, more preferably 1.6 mg/m² or less. In the case where a preferable reducing agent in the invention is used, it is possible to obtain a sufficient image density by even such a low amount of silver.

(Means for Nucleation)

The means for nucleation usable in the present invention is the means which can induce a new development in the neighborhood of the initial developing part as a result of initial development. As the means for nucleation which can be used in the present invention, the compound conventionally known as a nucleator and an infectious reducing agent can be used, however the compound having the function described above can be used in the present invention without limitation of these.

1) Nucleator

The nucleator used in the present invention is explained below.

The photothermographic material of the present invention preferably contains a nucleator.

The nucleator according to the present invention is a compound, which can form a compound that can newly induce a development by the reaction with a developing product in consequence of an initial development. It was conventionally known to use a nucleator for the ultra-high gradation photosensitive materials suitable for the use in graphic arts. The ultra-high gradation photosensitive materials had an average gradient of 10 or more and were unsuitable for conventional photographic materials, and especially unsuitable for the medical use where high diagnostic ability was required. And because the ultra-high gradation photosensitive material had rough granularity and did not have enough sharpness, there was no potential for medical diagnostic use. The nucleator in the present invention completely differs from the nucleator in the conventional ultra-high gradation photosensitive material as regards the effect. The nucleator in the present invention does not make a hard gradation. The nucleator in the present invention is the compound that can cause development sufficiently, even if the number of photosensitive silver halide grains with respect to non-photosensitive silver salt of an organic acid is extremely low. Although that mechanism is not clear, when thermal development is performed using the nucleator according to the present invention, it becomes clear that a large number of developed silver grains exists than the number of photosensitive silver halide grains in the maximum density part, and it is presumed that the nucleator according to the present invention forms the new development points (development nuclei) in those portions where silver halide grains do not exist.

As the nucleator, hydrazine derivative compounds represented by the following formula (V), vinyl compounds represented by the following formula (VI), and quaternary onium compounds represented by the following formula (P) are preferable. In particular, among the vinyl compounds, cyclic olefin compounds represented by formulae (A), (B), or (C) are preferable.

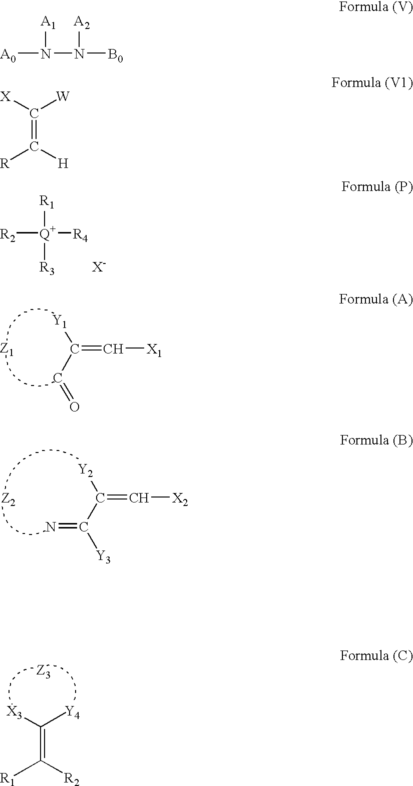

In formula (V), A₀ represents one selected from an aliphatic group, an aromatic group, a heterocyclic group, or a -G₀-D₀ group, each of which may have a substituent. B₀ represents a blocking group. A₁ and A₂ both represent a hydrogen atom, or one represents a hydrogen atom and the other represents one of an acyl group, a sulfonyl group, and an oxalyl group. Wherein G₀ represents one selected from a —CO— group, a —COCO— group, a —CS— group, a —C(═NG₁D₁) group, an —SO— group, an —SO₂— group, or a —P(O)(G₁D₁)- group. G₁ represents one selected from a mere bonding hand, an —O— group, an —S— group, or an —N(D₁)- group, and D₁ represents one selected from an aliphatic group, an aromatic group, a heterocyclic group, or a hydrogen atom. In the case where plural D₁s exist in a molecule, they may be the same or different. D₀ represents one selected from a hydrogen atom, an aliphatic group, an aromatic group, a heterocyclic group, an amino group, an alkoxy group, an aryloxy group, an alkylthio group, or an arylthio group. As preferable D₀, a hydrogen atom, an alkyl group, an alkoxy group, an amino group, and the like can be described.

In formula (V), the aliphatic group represented by A₀ preferably has 1 to 30 carbon atoms, and particularly preferably is a normal, blanched or cyclic alkyl group having 1 to 20 carbon atoms. For example, a methyl group, an ethyl group, a t-butyl group, an octyl group, a cyclohexyl group, and a benzyl group are described. These may be further substituted by a suitable substituent (e.g., an aryl group, an alkoxy group, an aryloxy group, an alkylthio group, an arylthio group, a sulfoxy group, a sulfonamide group, a sulfamoyl group, an acylamino group, a ureido group, or the like).

In formula (V), the aromatic group represented by A₀ is preferably an aryl group of a single or condensed ring. For example, a benzene ring or a naphthalene ring is described. As a heterocycle represented by A₀, the heterocycle of a single or condensed ring containing at least one heteroatom selected from a nitrogen atom, a sulfur atom, or an oxygen atom is preferable. For example, a pyrrolidine ring, an imidazole ring, a tetrahydrofuran ring, a morpholine ring, a pyridine ring, a pyrimidine ring, a quinoline ring, a thiazole ring, a benzothiazole ring, a thiophene ring and a furan ring are described. The arotamic group, heterocyclic group or -G₀-D₀ group, as A₀, may have a substituent. As A₀, an aryl group or a -G₀-D₀ group is particularly preferable.

And, in formula (V), A₀ preferably contains at least one of a diffusion-resistant group or an adsorptive group to silver halide. As a diffusion-resistance group, a ballast group usually used as non-moving photographic additive is preferable. As a ballast group, a photochemically inactive alkyl group, alkenyl group, alkynyl group, alkoxy group, phenyl group, phenoxy group, alkylphenoxy group and the like are described and it is preferred that the substituent part has 8 or more carbon atoms in total.

In formula (V), as an adsorption promoting group to silver halide, thiourea, a thiourethane group, a mercapto group, a thioether group, a thione group, a heterocyclic group, a thioamido heterocyclic group, a mercapto heterocyclic group, and an adsorptive group described in JP-A No. 64-90439 are described.

In formula (V), B₀ represents a blocking group and preferably a -G₀-D₀ group. G₀ represents one selected from a —CO— group, a —COCO— group, a —CS— group, a —C(═NG₁D₁) group, an —SO— group, an —SO₂— group, or a —P(O)(G₁D₁)— group. As preferable G₀, a —CO— group and a —COCO— group are described. G₁ represents one selected from a mere bonding hand, an —O-group, an —S— group, or an —N(D₁)- group, and D₁ represents one selected from an aliphatic group, an aromatic group, a heterocyclic group, or a hydrogen atom. In the case where plural D₁s exist in a molecule, they may be the same or different. D₀ represents one selected from a hydrogen atom, an aliphatic group, an aromatic group, a heterocyclic group, an amino group, an alkoxy group, an aryloxy group, an alkylthio group, or an arylthio group. As preferable D₀, a hydrogen atom, an alkyl group, an alkoxy group, an amino group and the like are described. A₁ and A₂ both represent a hydrogen atom, or one of A₁ and A₂ represents a hydrogen atom and the other represents one selected from an acyl group (an acetyl group, a trifluoroacetyl group, a benzoyl group or the like), a sulfonyl group (a methanesulfonyl group, a toluenesulfonyl group or the like), or an oxalyl group (an ethoxalyl group or the like).

As specific examples of the compound represented by formula (V), the compound H-1 to H-35 of chemical formula Nos. 12 to 18 and the compound H-1-1 to H-4-5 of chemical formula Nos. 20 to 26 in JP-A No. 2002-131864 are described, however specific examples are not limited in these.

The compounds represented by formula (V) can be easily synthesized by known methods. For example, these can be synthesized by referring to U.S. Pat. Nos. 5,464,738 and 5,496,695.

In addition, hydrazine derivatives preferably used are the compound H-1 to H-29 described in U.S. Pat. No. 5,545,505, columns 11 to 20 and the compounds 1 to 12 described in U.S. Pat. No. 5,464,738, columns 9 to 11. These hydrazine derivatives can be synthesized by known methods.

Next, formula (VI) is explained. In formula (VI), although X and R are displayed in a cis form, a trans form for X and R is also included in formula (Vi). This is also similar to the structure display of specific compounds.

In formula (VI), X represents an electron-attracting group, and W represents one selected from a hydrogen atom, an alkyl group, an alkenyl group, an alkynyl group, an aryl group, a heterocyclic group, a halogen atom, an acyl group, a thioacyl group, an oxalyl group, an oxyoxalyl group, a thiooxalyl group, an oxamoyl group, an oxycarbonyl group, a thiocarbonyl group, a carbamoyl group, a thiocarbamoyl group, a sulfonyl group, a sulfinyl group, an oxysulfinyl group, a thiosulfinyl group, a sulfamoyl group, an oxysulfinyl group, a thiosulfinyl group, a sulfinamoyl group, a phosphoryl group, a nitro group, an imino group, a N-carbonylimino group, a N-sulfonylimino group, a dicyanoethylene group, an ammonium group, a sulfonium group, a phosphonium group, a pyrylium group, or an immonium group.

R represents one selected from a halogen atom, a hydroxy group, an alkoxy group, an aryloxy group, a heterocyclic oxy group, an alkenyloxy group, an acyloxy group, an alkoxycarbonyloxy group, an aminocarbonyloxy group, a mercapto group, an alkylthio group, an arylthio group, a heterocyclic thio group, an alkenylthio group, an acylthio group, an alkoxycarbonylthio group, an aminocarbonylthio group, an organic or inorganic salt of hydroxy group or mercapto group (e.g., a sodium salt, a potassium salt, a silver salt, or the like), an amino group, an alkylamino group, a cyclic amino group (e.g., a pyrrolidino group), an acylamino group, an oxycarbonylamino group, a heterocyclic group (a 5 or 6-membered nitrogen-containing heterocycle, e.g., a benztriazolyl group, an imidazolyl group, a triazolyl group, a tetrazolyl group, or the like), a ureido group, or a sulfonamide group. X and W, and X and R may bond to each other to form a cyclic structure. As the ring formed by X and W, for example, pyrazolone, pyrazolidinone, cyclopentanedione, β-ketolactone, β-ketolactam, and the like are described.

Explaining formula (VI) further, the electron-attracting group represented by X is a substituent which can have a positive value of substituent constant σp. Specifically, a substituted alkyl group (halogen substituted alkyl and the like), a substituted alkenyl group (cyanovinyl and the like), a substituted or unsubstituted alkynyl group (trifluoromethylacetylenyl, cyanoacetylenyl and the like), a substituted aryl group (cyanophenyl and the like), a substituted or unsubstituted heterocyclic group (pyridyl, triazinyl, benzooxazolyl and the like), a halogen atom, a cyano group, an acyl group (acetyl, trifluoroacetyl, formyl and the like), a thioacetyl group (thioacetyl, thioformyl and the like), an oxalyl group (methyloxalyl and the like), an oxyoxalyl group (ethoxalyl and the like), a thiooxalyl group (ethylthiooxalyl and the like), an oxamoyl group (methyloxamoyl and the like), an oxycarbonyl group (ethoxycarbonyl and the like), a carboxyl group, a thiocarbonyl group (ethylthiocarbonyl and the like), a carbamoyl group, a thiocarbamoyl group, a sulfonyl group, a sulfinyl group, an oxysulfonyl group (ethoxysulfonyl and the like), a thiosulfonyl group (ethylthiosulfonyl and the like), a sulfamoyl group, an oxysulfinyl group (methoxysulfinyl and the like), a thiosulfinyl group (methylthiosulfinyl and the like), a sulfinamoyl group, a phosphoryl group, a nitro group, an imino group, a N-carbonylimino group (N-acetylimino and the like), a N-sulfonylimino group (N-methanesulfonylimino and the like), a dicyanoethylene group, an ammonium group, a sulfonium group, a phosphonium group, a pyrylium group, an immonium group and the like are described, and a heterocyclic one formed by an ammonium group, a sulfonium group, a phosphonium group, an immonium group or the like is also included. The substituent having σp value of 0.30 or more is particularly preferable.

As an alkyl group represented by W, methyl, ethyl, trifluoromethyl and the like are described. As an alkenyl group as W, vinyl, halogen-substituted vinyl, cyanovinyl and the like are described. As an alkynyl group as W, acetylenyl, cyanoacetylenyl and the like are described. As an aryl group as W, nitrophenyl, cyanophenyl, pentafluorophenyl and the like are described, and as a heterocyclic group as W, pyridyl, pyrimidyl, triazinyl, succinimide, tetrazolyl, triazolyl, imidazolyl, benzooxazolyl and the like are described. As W, the electron-attracting group having a positive σp value is preferable, and that value is more preferably 0.30 or more.

Among the substituents of R described above, a hydroxy group, a mercapto group, an alkoxy group, an alkylthio group, a halogen atom, an organic or inorganic salt of hydroxy group or mercapto group, and a heterocyclic group are preferably described. More preferably, a hydroxy group, an alkoxy group, an organic or inorganic salt of hydroxy group or mercapto group and a heterocyclic group are described, and particularly preferably, a hydroxy group and an organic or inorganic salt of hydroxy group or mercapto group are described.

And among the substituents of X and W described above, the group having a thioether bond in the substituent is preferable.

As specific examples of the compound represented by formula (VI), compound 1-1 to 92-7 of chemical formula Nos. 27 to 50 described in JP-A No. 2002-131864 are described, however specific examples are not limited in these.

In formula (P), Q represents a nitrogen atom or a phosphorus atom. R₁, R₂, R₃, and R₄ each independently represent a hydrogen atom or a substituent, and X⁻ represents an anion. In addition, R₁ to R₄ may bond to each other to form a cyclic structure.

As the substituent represented by R₁ to R₄, an alkyl group (a methyl group, an ethyl group, a propyl group, a butyl group, a hexyl group, a cyclohexyl group and the like), an alkenyl group (an allyl group, a butenyl group and the like), an alkynyl group (a propargyl group, a butynyl group and the like), an aryl group (a phenyl group, a naphthyl group and the like), a heterocyclic group (a piperidinyl group, a piperazinyl group, a morpholinyl group, a pyridyl group, a furyl group, a thienyl group, a tetrahydrofuryl group, a tetrahydrothienyl group, a sulforanyl group and the like), an amino group, and the like are described.

As the ring formed by linking R₁ to R₄ each other, a piperidine ring, a morpholine ring, a piperazine ring, a quinuclidine ring, a pyridine ring, a pyrrole ring, an imidazole ring, a triazole ring, a tetrazole ring, and the like are described.

The group represented by R₁ to R₄ may have a substituent such as a hydroxy group, an alkoxy group, an aryloxy group, a carboxyl group, a sulfo group, an alkyl group, an aryl group, and the like. As R₁, R₂, R₃, and R₄, a hydrogen atom and an alkyl group are preferable.

As the anion represented by X⁻, an organic or inorganic anion such as a halogen ion, a sulfate ion, a nitrate ion, an acetate ion, a p-toluenesulfonate ion, and the like are described.

As a structure of formula (P), the structure described in paragraph Nos. 0153 to 0163 in JP-A No. 2002-131864 is still more preferable.

As the specific compounds of formula (P), P-1 to P-52 and T-1 to T-18 of chemical formula Nos. 53 to 62 in JP-A No. 2002-131864 can be described, however the specific compound is not limited in these.

The quaternary onium compound described above can be synthesized by referring to known methods. For example, the tetrazolium compound described above can be synthesized by referring to the method described in Chemical Reviews, vol. 55, pages 335 to 483.

Next, the compounds represented by formulae (A) or (B) are explained in detail. In formula (A), Z₁ represents a nonmetallic atomic group capable to form a 5 to 7-membered cyclic structure with —Y₁—C(═CH—X₁)—C(═O)—. Z₁ is preferably an atomic group selected from a carbon atom, an oxygen atom, a sulfur atom, a nitrogen atom, or a hydrogen atom, and several atoms selected from these are bound each other by single bond or double bond to form a 5 to 7-membered cyclic structure with —Y₁—C(═CH—X₁)—C(═O)—. Z₁ may have a substituent, and Z₁ itself may be an aromatic or a non-aromatic carbon ring, or Z₁ may be a part of an aromatic or a non-aromatic heterocycle, and in this case, a 5 to 7-membered cyclic structure formed by Z₁ with —Y₁—C(═CH—X₁)—C(═O)— forms a condensed cyclic structure.

In formula (B), Z₂ represents a nonmetallic atomic group capable to form a 5 to 7-membered cyclic structure with —Y₂—C(═CH—X₂)—C(Y₃)═N—. Z₂ is preferably an atomic group selected from a carbon atom, an oxygen atom, a sulfur atom, a nitrogen atom, or a hydrogen atom, and several atoms selected from these are linked each other by single bond or double bond to form a 5 to 7-membered cyclic structure with —Y₂—C(═CH—X₂)—C(Y₃)═N—. Z₂ may have a substituent, and Z₂ itself may be an aromatic or a non-aromatic carbon ring, or Z₂ may be a part of an aromatic or a non-aromatic heterocycle and in this case, a 5 to 7-membered cyclic structure formed by Z₂ with —Y₂—C(═CH—X₂)—C(Y₃)═N— forms a condensed cyclic structure.

In the case where Z₁ and Z₂ have a substituent, examples of substituent are selected from the compounds listed below. Namely, as typical substituent, for example, a halogen atom (fluorine atom, chlorine atom, bromine atom or iodine atom), an alkyl group (includes an aralkyl group, a cycloalkyl group and an active methine group), an alkenyl group, an alkynyl group, an aryl group, a heterocyclic group, a heterocyclic group containing a quaternary nitrogen (e.g., a pyridinio group), an acyl group, an alkoxycarbonyl group, an aryloxycarbonyl group, a carbamoyl group, a carboxyl group or a salt thereof, a sulfonylcarbamoyl group, an acylcarbamoyl groyp, a sulfamoylcarbamoyl group, a carbazoyl group, an oxalyl group, an oxamoyl group, a cyano group, a thiocarbamoyl group, a hydroxy group, an alkoxy group (including the group in which ethylene oxy group units or propylene oxy group units are repeated), an aryloxy group, a heterocyclic oxy group, an acyloxy group, an alkoxy carbonyloxy group, an aryloxy carbonyloxy group, a carbamoyloxy group, a sulfonyloxy group, an amino group, an alkylamino group, an arylamino group, a heterocyclic amino group, a N-substituted nitrogen-containing heterocyclic group, an acylamino group, a sulfonamide group, a ureido group, a thioureido group, an imide group, an alkoxycarbonylamino group, an aryloxycarbonylamino group, a sulfamoylamino group, a semicarbazide group, a thiosemicarbazide group, a hydrazino group, a quaternary ammonio group, an oxamoylamino group, an alkylsulfonylureido group, an arylsulfonylureido group, an acylureido group, an acylsulfamoylamino group, a nitro group, a mercapto group, an alkylthio group, an arylthio group, a heterocyclic thio group, an alkylsulfonyl group, an arylsulfonyl group, a sulfo group or a salt thereof, a sulfamoyl group, an acylsulfamoyl group, a sulfonylsulfamoyl group or a salt thereof, a group containing phosphoric amide or phosphoric ester structure, a silyl group, a stannyl group, and the like are described. These substituents may be further substituted by these substituents.

Next, Y₃ is explained. In formula (B), Y₃ represents a hydrogen atom or a substituent, and when Y₃ represents a substituent, following group is specifically described as that substituent. Namely, an alkyl group, an aryl group, a heterocyclic group, a cyano group, an acyl group, an alkoxycarbonyl group, an aryloxycarbonyl group, a carbamoyl group, an amino group, an alkylamino group, an arylamino group, a heterocyclic amino group, an acylamino group, a sulfonamide group, a ureido group, a thioureido group, an imide group, an alkoxy group, an aryloxy group, an alkylthio group, an arylthio group, a heterocyclic thio group, and the like are described. These substituents may be substituted by any substituents, and specifically, examples of the substituents which Z₁ or Z₂ may have, are described.

In formulae (A) and (B), X₁ and X₂ each independently represent one selected from a hydroxy group (or a salt thereof), an alkoxy group (e.g., a methoxy group, an ethoxy group, a propoxy group, an isopropoxy group, an octyloxy group, a dodecyloxy group, a cetyloxy group, a t-butoxy group, or the like), an aryloxy group (e.g., a phenoxy group, a p-t-pentylphenoxy group, a p-t-octylphenoxy group, or the like), a heterocyclic oxy group (e.g., a benzotriazolyl-5-oxy group, a pyridinyl-3-oxy group, or the like), a mercapto group (or a salt thereof), an alkylthio group (e.g., methylthio group, an ethlythio group, a butylthio group, a dodecylthio group, or the like), an arylthio group (e.g., a phenylthio group, a p-dodecylphenylthio group, or the like), a heterocyclic thio group (e.g., a 1-phenyltetrazoyl-5-thio group, a 2-methyl-1-phenyltriazolyl-5-thio group, a mercaptothiadiazolylthio group, or the like), an amino group, an alkylamino group (e.g., a methylamino group, a propylamino group, an octylamino group, a dimethylamino group, or the like), an arylamino group (e.g., an anilino group, a naphthylamino group, an o-methoxyanilino group, or the like), a heterocyclic amino group (e.g., a pyridylamino group, a benzotriazole-5-ylamino group, or the like), an acylamino group (e.g., an acetamide group, an octanoylamino group, a benzoylamino group, or the like), a sulfonamide group (e.g., a methanesulfonamide group, a benzenesulfonamide group a dodecylsulfonamide group, or the like), or a heterocyclic group.

Herein, a heterocyclic group is an aromatic or non-aromatic, a saturated or unsaturated, a single ring or condensed ring, or a substituted or unsubstituted heterocyclic group. For example, a N-methylhydantoyl group, a N-phenylhydantoyl group, a succinimide group, a phthalimide group, a N,N′-dimethylurazolyl group, an imidazolyl group, a benzotriazolyl group, an indazolyl group, a morpholino group, a 4,4-dimethyl-2,5-dioxo-oxazolyl group, and the like are described.

And herein, a salt represents a salt of an alkali metal (sodium, potassium, or lithium), a salt of an alkali earth metal (magnesium or calcium), a silver salt, a quaternary ammonium salt (a tetraethylammonium salt, a dimethylcetylbenzylammonium salt, or the like), a quaternary phosphonium salt, or the like. In formulae (A) and (B), Y₁ and Y₂ represent —C(═O)— or —SO₂—.

The preferable range of the compounds represented by formulae (A) or (B) is described in JP-A No. 11-231459, paragraph Nos. 0027 to 0043. As specific examples of the compound represented by formulae (A) or (B), compound 1 to 110 of Table 1 to Table 8 in JP-A No. 11-231459 are described, however the invention is not limited in these.

Next, the compound represented by formula (C) is explained in detail. In formula (C), X₃ represents one selected from an oxygen atom, a sulfur atom, or a nitrogen atom. In the case where X₃ is a nitrogen atom, the bond of X₃ and Z₃ may be either a single bond or a double bond, and in the case of a single bond, a nitrogen atom may have a hydrogen atom or any substituent. As this substituent, for example, an alkyl group (includes an aralkyl group, a cycloalkyl group, an active methine group, and the like), an alkenyl group, an alkynyl group, an aryl group, a heterocyclic group, an acyl group, an alkoxycarbonyl group, an aryloxycarbonyl group, a carbamoyl group, an alkylsulfonyl group, an arylsulfonyl group, a heterocyclic sulfonyl group, and the like are described.

Y₄ represents a group represented by one selected from —C(═O)—, —C(═S)—, —SO—, —SO₂—, —C(═NR₃)—, or —(R₄)C═N—. Z₃ represents a nonmetallic atomic group capable to form a 5 to 7-membered ring containing X₃ and Y₄. The atomic group to form that ring is an atomic group which consists of 2 to 4 atoms that are other than metal atoms, and these atoms may be combined by single bond or double bond, and these may have a hydrogen atom or any subsituent (e.g., an alkyl group, an aryl group, a heterocyclic group, an alkoxy group, an alkylthio group, an acyl group, an amino group, or an alkenyl group). When Z₃ forms a 5 to 7-membered ring containing X₃ and Y₄, the ring is a saturated or unsaturated heterocycle, and may be a single ring or may have a condensed ring. When Y₄ is the group represented by C(═NR₃), (R₄)C═N, the condensed ring of this case may be formed by bonding R₃ or R₄ with the substituent of Z₃.

In formula (C), R₁, R₂, R₃, and R₄ each independently represent a hydrogen atom or a substituent. However, R₁ and R₂ never bond to each other to form a cyclic structure.

When R₁ and R₂ represent a monovalent substituent, the following groups are described as a monovalent substituent.

For example, a halogen atom (fluorine atom, chlorine atom, bromine atom, or iodine atom), an alkyl group (including an aralkyl group, a cycloalkyl group, an active methine group, and the like), an alkenyl group, an alkynyl group, an aryl group, a heterocyclic group, a heterocyclic group containing a quaternary nitrogen atom (e.g., a pyridinio group), an acyl group, an alkoxycarbonyl group, an aryloxycarbonyl group, a carbamoyl group, a carboxyl group and a salt thereof, a sulfonylcarbamoyl group, an acylcarbamoyl group, a sulfamoylcarbamoyl group, a carbazoyl group, an oxalyl group, an oxamoyl group, a cyano group, a thiocarbamoyl group, a hydroxy group and a salt thereof, an alkoxy group (including the group in which ethylene oxy group units or propylene oxy group units are repeated), an aryloxy group, a heterocyclic oxy group, an acyloxy group, an alkoxycarbonyloxy group, an aryloxycarbonyloxy group, a carbamoyloxy group, a sulfonyloxy group, an amino group, an alkylamino group, an arylamino group, an heterocyclic amino group, a N-substituted nitrogen-containing heterocyclic group, an acylamino group, a sulfonamide group, a ureido group, a thioureido group, an imide group, an alkoxycarbonylamino group, an aryloxycarbonylamino group, a sulfamoylamino group, a semicarbazide group, a thiosemicarbazide group, a hydrazino group, a quaternary ammonio group, an oxamoylamino group, an alkylsulfonylureido group, an arylsulfonylureido group, an acylureido group, an acylsulfamoylamino group, a nitro group, a mercapto group and a salt thereof, an alkylthio group, an arylthio group, an heterocyclic thio group, an alkylsulfonyl group, an arylsulfonyl group, an alkylsulfinyl group, an arylsulfinyl group, a sulfo group and a salt thereof, a sulfamoyl group, an acylsulfamoyl group, a sulfonylsulfamoyl group and a salt thereof, a phosphoryl group, a group containing phosphoric amide or phosphoric ester structure, a silyl group, a stannyl group, and the like are described. These substituents may be further substituted by these monovalent substituents.

When R₃ and R₄ represent a substituent, the same substituent as what R₁ and R₂ may have except the halogen atom can be described as the substituent. Furthermore, R₃ and R₄ may further link to Z₃ to form a condensed ring.

Next, among the compounds represented by formula (C), preferable compounds are described. In formula (C), Z₃ is preferably an atomic group which forms a 5 to 7-membered ring with X₃ and Y₄, and consists of the atoms selected from 2 to 4 carbon atoms, a nitrogen atom, a sulfur atom, or an oxygen atom. A heterocycle, which is formed by Z₃ with X₃ and Y₄, preferably contains 3 to 40 carbon atoms in total, more preferably 3 to 25 carbon atoms in total, and most preferably 3 to 20 carbon atoms in total. Z₃ preferably comprises at least one carbon atom.

In formula (C), Y₄ is preferably —C(═O)—, —C(═S)—, —SO₂—, or —(R₄)C═N—, particularly preferably, —C(═O)—, —C(═S)—, or —SO₂—, and most preferably, —C(═O)—.

In formula (C), in the case where R₁ and R₂ represent a monovalent substituent, the monovalent substituent represented by R₁ and R₂ is preferably one of the following groups having 0 to 25 carbon atoms in total, namely, those are an alkyl group, an aryl group, a heterocyclic group, an alkoxy group, an aryloxy group, a heterocyclic oxy group, an alkylthio group, an arylthio group, a heterocyclic thio group, an amino group, an alkylamino group, an arylamino group, a heterocyclic amino group, a ureido group, an imide group, an acylamino group, a hydroxy group and a salt thereof, a mercapto group and a salt thereof, and an electron-attracting group. Herein, an electron-attracting group means the substituent capable to have a positive value of Hammett substituent constant σp, and specifically a cyano group, a sulfamoyl group, an alkylsulfonyl group, an arylsulfonyl group, a sulfonamide group, an imino group, a nitro group, a halogen atom, an acyl group, a formyl group, a phosphoryl group, a carboxyl group (or a salt thereof), a sulfo group (or a salt thereof), a saturated or unsaturated heterocyclic group, an alkenyl group, an alkynyl group, an acyloxy group, an acylthio group, a sulfonyloxy group, and an aryl group substituted by these electron-attracting group are described. These substituents may have any substituents.

In formula (C), when R₁ and R₂ represent a monovalent substituent, more preferable are an alkoxy group, an aryloxy group, a heterocyclic oxy group, an alkylthio group, an arylthio group, a heterocyclic thio group, an amino group, an alkylamino group, an arylamino group, a heterocyclic amino group, a ureido group, an imide group, an acylamino group, a sulfonamide group, a heterocyclic group, a hydroxy group or a salt thereof, a mercapto group or a salt thereof, and the like. In formula (C), R₁ and R₂ particularly preferably are a hydrogen atom, an alkoxy group, an aryloxy group, an alkylthio group, an arylthio group, a heterocyclic group, a hydroxy group or a salt thereof, a mercapto group or a salt thereof, or the like. In formula (C), most preferably, one of R₁ and R₂ is a hydrogen atom and another is an alkoxy group, an aryloxy group, an alkylthio group, an arylthio group, a heterocyclic group, a hydroxy group or a salt thereof, or a mercapto group or a salt thereof.

In formula (C), when R₃ represents a substituent, R₃ is preferably an alkyl group having 1 to 25 carbon atoms in total (including an aralkyl group, a cycloalkyl group, an active methine group and the like), an alkenyl group, aryl group, a heterocyclic group, a heterocyclic group containing a quaternary nitrogen (e.g., a pyridinio group), an acyl group, an alkoxycarbonyl group, an aryloxycarbonyl group, a carbamoyl group, an alkylsulfonyl group, an arylsulfonyl group, an alkylsulfinyl group, an arylsulfinyl group, a sulfosulfamoyl group, an alkoxy group, an aryloxy group, a heterocyclic oxy group, an alkylthio group, an arylthio group, a heterocyclic thio group, an amino group, or the like. An alkyl group and an aryl group are particularly preferable.

In formula (C), when R₄ represents a substituent, R₄ is preferably an alkyl group (including an aralkyl group, a cycloalkyl group, an active methine group, and the like) having 1 to 25 carbon atoms in total, an aryl group, a heterocyclic group, a heterocyclic group containing a quaternary nitrogen atom (e.g., a pyridinio group), an acyl group, an alkoxycarbonyl group, an aryloxycarbonyl group, a carbamoyl group, an alkylsulfonyl group, an arylsulfonyl group, an alkylsulfinyl group, an arylsulfinyl group, a sulfosulfamoyl group, an alkoxy group, an aryloxy group, a heterocyclic oxy group, an alkylthio group, an arylthio group, a heterocyclic thio group, or the like. Particularly preferably, an alkyl group, an aryl group, an alkoxy group, an aryloxy group, a heterocyclic oxy group, an alkylthio group, an arylthio group, a heterocyclic thio group, and the like are described.

Specific compounds represented by formula (C) are represented by A-1 to A-230 of chemical formula Nos. 6 to 18 described in JP-A No. 11-133546, however the invention is not limited in these.

The addition amount of the above nucleator is in a range of from 10⁻⁵ mol to 1 mol per 1 mol of organic silver salt, and preferably, in a range of from 10⁻⁴ mol to 5×10⁻¹ mol.

The nucleator described above may be incorporated into a photothermographic material by being added into the coating solution, such as in the form of a solution, an emulsion dispersion, a solid fine particle dispersion, or the like.

As well known emulsion dispersing method, there can be mentioned a method comprising dissolving the nucleator in an oil such as dibutylphthalate, tricresylphosphate, dioctylsebacate, tri(2-ethylhexyl)phosphate, or the like, using an auxiliary solvent such as ethyl acetate, cyclohexanone, or the like, and then adding a surfactant such as sodium dodecylbenzenesulfonate, sodium oleoil-N-methyltaurinate, sodium di(2-ethylhexyl)sulfosuccinate or the like; from which an emulsion dispersion is mechanically produced. During the process, for the purpose of controlling viscosity of oil droplet and refractive index, the addition of polymer such as α-methylstyrene oligomer, poly(t-butylacrylamide), or the like is preferable.

As solid particle dispersing method, there can be mentioned a method comprising dispersing the powder of the nucleator in a proper solvent such as water or the like, by means of ball mill, colloid mill, vibrating ball mill, sand mill, jet mill, roller mill, or ultrasonics, thereby obtaining solid dispersion. In this case, there may also be used a protective colloid (such as poly(vinyl alcohol)), or a surfactant (for instance, an anionic surfactant such as sodium triisopropylnaphthalenesulfonate (a mixture of compounds having the three isopropyl groups in different substitution sites)). In the mills enumerated above, generally used as the dispersion media are beads made of zirconia or the like, and Zr or the like eluting from the beads may be incorporated in the dispersion. Although depending on the dispersing conditions, the amount of Zr or the like generally incorporated in the dispersion is in a range of from 1 ppm to 1000 ppm. It is practically acceptable as far as Zr is incorporated in an amount of 0.5 mg or less per 1 g of silver.

Preferably, an antiseptic (for instance, benzisothiazolinone sodium salt) is added in an aqueous dispersion.

The nucleator is particularly preferably used as solid particle dispersion, and is added in the form of fine particles having average particle size of from 0.01 μm to 10 μm, preferably from 0.05 μm to 5 μm and, more preferably from 0.1 μm to 2 μm. In the invention, other solid dispersions are preferably used with this particle size range.

In the photothermographic material which is subjected to a rapid development where time period for development is 20 seconds or less, the compound represented by formulae (V) or (P) is used preferably, and the compound represented by formula (V) is used particularly preferably, among the nucleators described above.

In the photothermographic material where low fog is required, the compound represented by formula (VI) is used preferably, the compound represented by formulae (A), (B), or (C) is used more preferably, and the compound represented by formulae (A) or (B) is particularly preferably used. Moreover, in the photothermographic materials having a few change of photographic property against environmental conditions when used on various environmental conditions (temperature and humidity), the compound represented by formula (C) is preferably used.

Although preferred specific compounds among the above-mentioned nucleators are shown below, the invention is not limited in these.

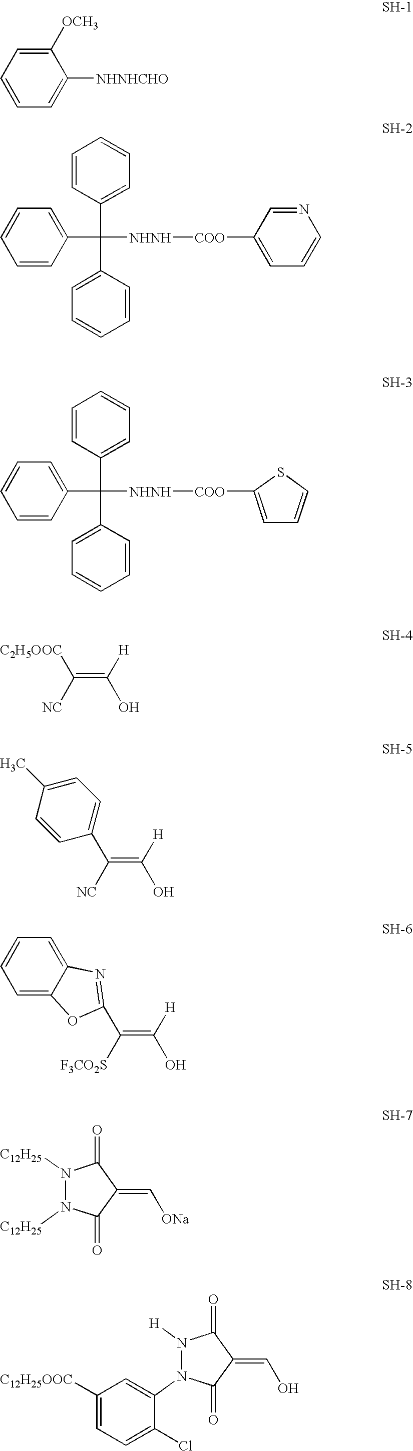

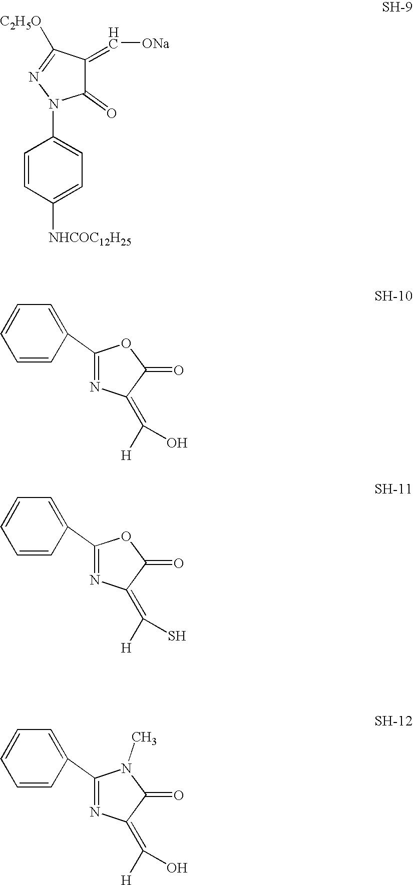

The nucleator of the present invention can be added to the image forming layer or the layer adjacent to the image forming layer, however, it is preferably added to the image forming layer. The addition amount of the nucleator is in a range of from 10⁻⁵ mol to 1 mol per 1 mol of organic silver salt, and preferably, from 10⁻⁴ mol to 5×10⁻¹ mol. The nucleator may be added either only one kind or, two or more kinds in combination.

The photothermographic material of the present invention may have two or more image forming layers containing a photosensitive silver halide. In the case where two or more image forming layer are present, any of these image forming layers may contain the nucleator. It is preferred that the photothermographic material comprises at least two image forming layers, in which an image forming layer containing the nucleator and another image forming layer not containing the nucleator are included.

2) Infectious Development Reducing Agent

An infectious developing reducing agent is explained. “Infectious development” is a development mechanism generally known for wet development system, for example, is explained in “KAITEI SYASHIN KOUGAKU NO KISO-GINEN SYASHIN HEN” (NIPPON SYASHIN GAKKAI, edit, 1998, CORONA Co.), pages 339 to 341. “Infectious development” is a phenomenon which a more powerful reducing product is generated by the oxidation product of reducing agent generated by early development and accelerates a development.

The present inventors found out that in the thermal development of photothermographic material comprising, on at least one side of a support, at least a photosensitive silver halide, a non-photosensitive organic silver salt, a reducing agent for silver ions, and a binder, the photothermographic material having high sensitivity and high image quality, in which the gradation of photographic characteristic curve of the image is from 2 to 4, can be obtained by using infectious development reducing agent.

Furthermore, it is found out that the photothermographic material of the present invention having a value obtained by dividing a total amount of coated silver contained in the non-photosensitive organic silver salt and the photosensitive silver halide per unit of area by a number of the photosensitive silver halide grains per unit of area, is 5×10⁻¹⁴ g/grain or more can achieve high sensitivity and high image quality.

Furthermore, as a result of that an amount of coated silver of 2.0 g/m² or less and a maximum density of 2.5 or higher can be obtained, it is found out that higher sensitivity and higher image quality can be obtained.

As the infectious development reducing agent used in the present invention, any reducing agent may be used as far as it has the ability of infectious development.

Preferable infectious development reducing agent used in the present invention is the compound represented by the following formula (R1).

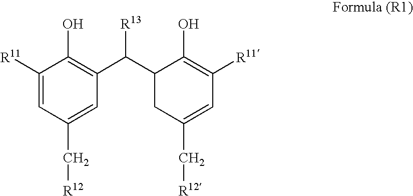

In formula (R1) described above, R¹¹ and R^{11′} each independently represent a secondary or tertiary alkyl group having 3 to 20 carbon atoms. R¹² and R^{12′} each independently represent a hydrogen atom or a group which links through a nitrogen, an oxygen, a phosphor, or a sulfur atom. R¹³ represents a hydrogen atom or an alkyl group having 1 to 20 carbon atoms.

Formula (R1) described above is explained in detail. As R¹¹ and R^{11′} described above, a secondary or tertiary alkyl group having 3 to 12 carbon atoms is preferable. Specifically, an isopropyl group, a tert-butyl group, a tert-amyl group, a 1,1-dimethylpropyl group, a 1,1-dimethylbutyl group, a 1,1-dimethylhexyl group, a 1,3-tetramethylbutyl group, a 1,1-dimethyldecyl group, a 1-methylcyclohexyl group, a tert-octyl group, a 1-methylcyclopropyl group and the like are preferable, and a tert-butyl group, a tert-amyl group, a tert-octyl group and a 1-methylcyclohexyl group are more preferable, and a tert-butyl group is most preferable.

In the case where R¹² and R^{12′} are an aryloxy group, an arylthio grpoup, an anilino group, a heterocyclic group, or a heterocyclic thio group, each of which may have a substituent. As the said substituent, although any group may be possible as far as it is capable of substituting for a hydrogen atom on a benzene ring and a heterocycle, and, an alkyl group, an aryl group, a heterocyclic group, a halogen atom, an alkoxy group, a hydroxy group, an aryloxy group, an alkylthio group, an arylthio group, an amino group, an acyl group, an acyloxy group, an acylamino group, an alkoxycarbonyl group, a carbamoyl group, a sulfonyl group, a sulfonamide group, a sulfonyloxy group, a sulfamoyl group, a sulfoxido group, a ureido group or a urethane group or the like are described. In the case where R¹² and R^{12′} are an alkoxy group, a carbonyloxy group, an acyloxy group, an alkylthio group, an amino group, an acylamino group, a ureido group or a urethane group, these groups may further have a substituent and as examples of the said substituent, an alkoxy group, an alkoxycarbonyl group, an acyloxy group, an sulfonyl group, a carbonyl group, an alkylthio group, an aryloxy group, an arylthio group, a sulfonamide group, an acylamino group, and the like are described. As R¹² and R^{12′} described above, a hydrogen atom, a hydroxy group, an amino group, and an anilino group are more preferable, and further, a hydrogen atom, a methoxy group, and a benzyloxy group are most preferable.

As R¹³ described above, a hydrogen atom and an alkyl group having 1 to 15 carbon atoms are preferable, and an alkyl group having 1 to 8 carbon atoms is more preferable. As the said alkyl group, a methyl group, an ethyl group, a propyl group, an isopropyl group, and a 2,4,4-trimethylpenthyl group are preferable. As R¹³ described above, a hydrogen atom, a methyl group, an ethyl group, a propyl group, and an isopropyl group are particularly preferable.

Typical examples of the reducing agent represented by formula (R1) of the present invention are shown below, however the present invention is not limited in these.

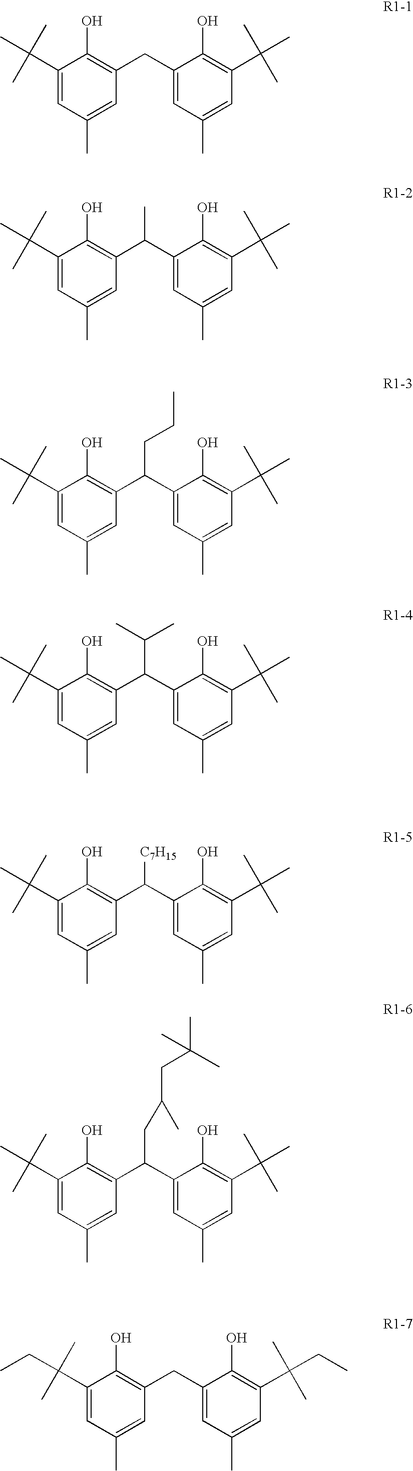

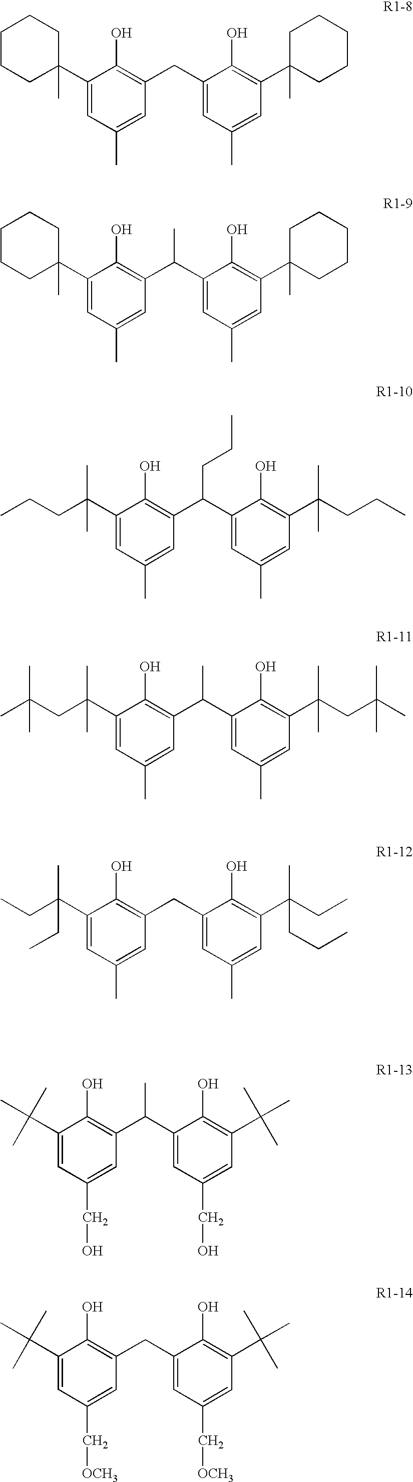

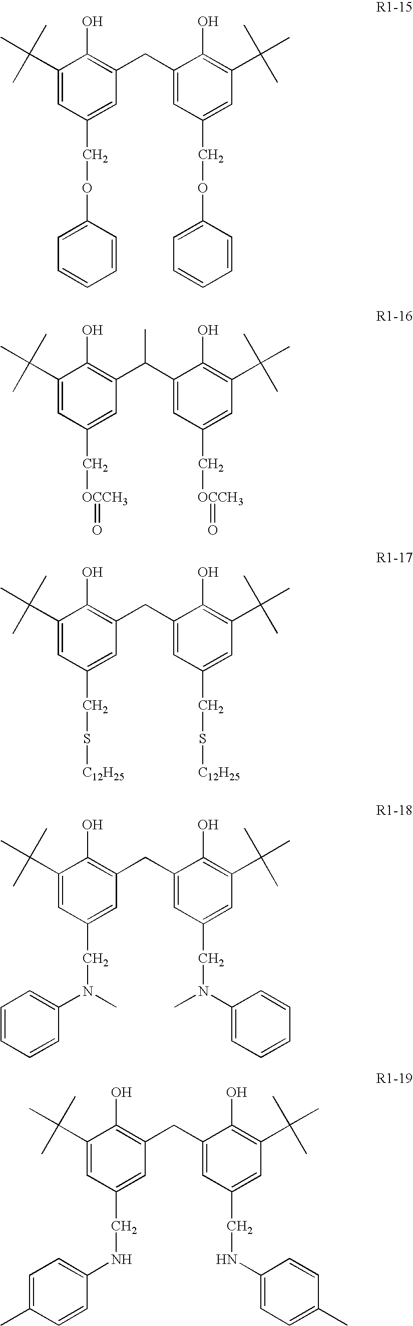

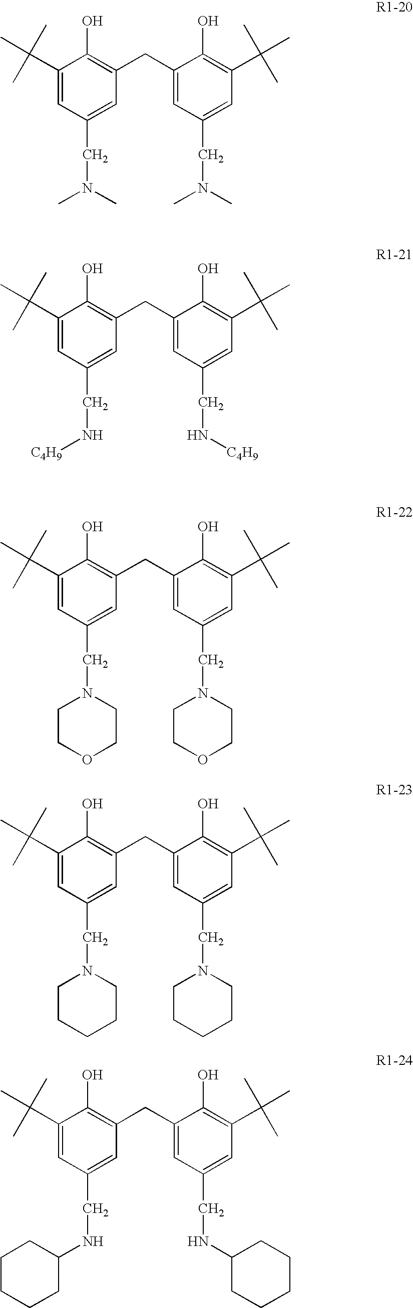

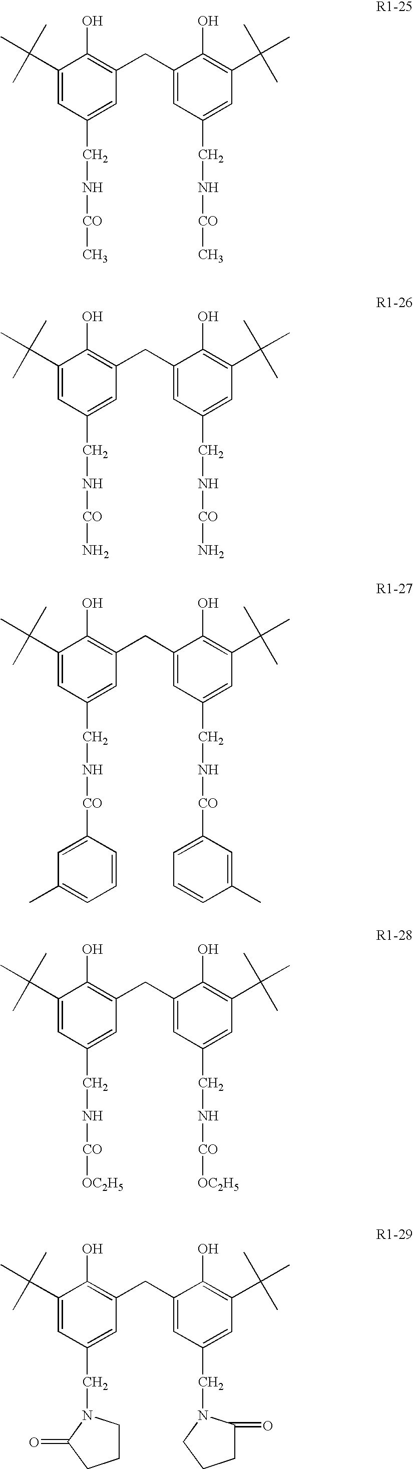

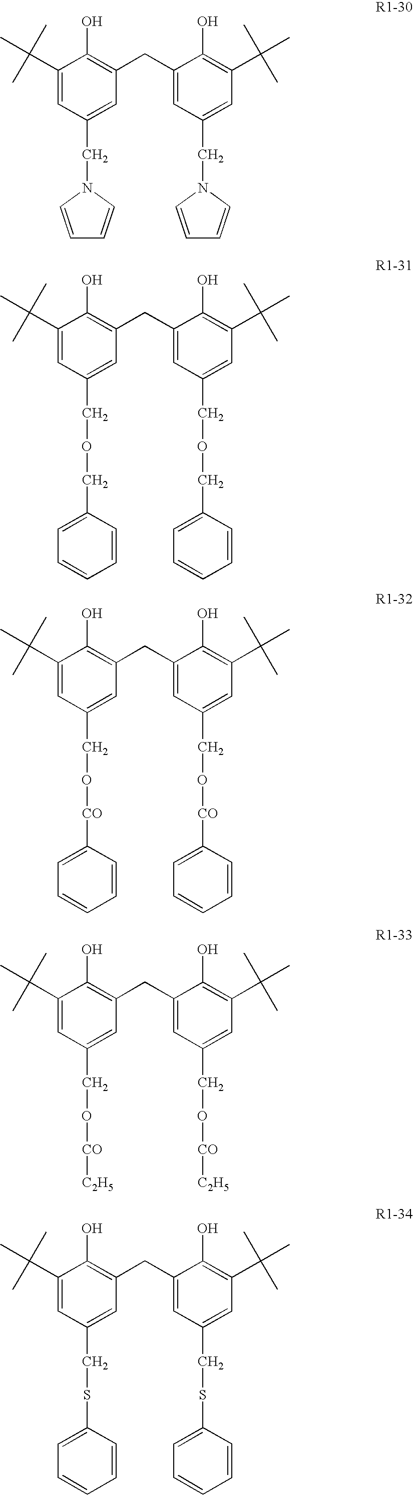

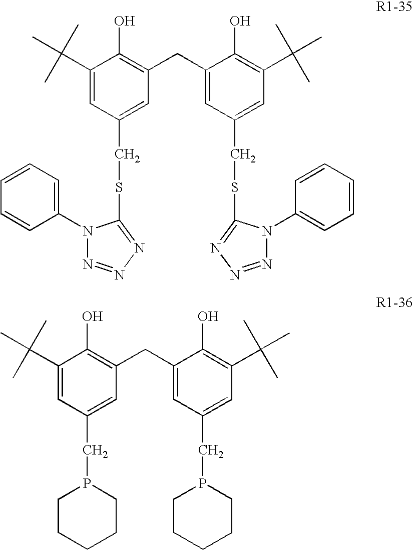

The addition amount of the reducing agent represented by the above-described formula (R1) is preferably from 0.01 g/m² to 5.0 g/m², and more preferably from 0.1 g/m² to 3.0 g/m². It is preferably contained in a range of from 5 mol % to 50 mol %, and more preferably from 10 mol % to 40 mol %, per 1 mol of silver in the image forming layer. Further, the reducing agent represented by the above-described formula (R1) is preferably contained in the image forming layer.

In the invention, other reducing agents may be used in combination with the reducing agent represented by formula (R1). The reducing agent, which can be used in combination, can be any substance (preferably, organic substance) capable of reducing silver ions into metallic silver. Examples of the reducing agent are described in JP-A No. 11-65021 (column Nos. 0043 to 0045) and EP No. 0803764 (p. 7, line 34 to p. 18, line 12).

In the invention, the reducing agent, which can be used in combination, is preferably a so-called hindered phenolic reducing agent or a bisphenol agent having a substituent at the ortho-position to the phenolic hydroxy group.

In the case where plural reducing agents are used in combination, the ratio of combination by mole is from 1/99 to 99/1, and preferably from 5/95 to 95/5.

The reducing agent of the invention can be added in the image forming layer which comprises an organic silver salt and a photosensitive silver halide, or in the layer adjacent to the image forming layer, but it is preferably contained in the image forming layer.

The reducing agent of the invention may be incorporated into photothermographic material by being added into the coating solution, such as in the form of solution, emulsion dispersion, solid fine particle dispersion, or the like.

Well known emulsion dispersing methods include a method comprising dissolving the reducing agent in an oil such as dibutylphthalate, tricresylphosphate, glyceryl triacetate, diethylphthalate, or the like, using an auxiliary solvent such as ethyl acetate, cyclohexanone, or the like, followed by mechanically forming an emulsified dispersion.

As solid fine particle dispersing method, there can be mentioned a method comprising dispersing the reducing agent in a proper solvent such as water or the like, by means of ball mill, colloid mill, vibrating ball mill, sand mill, jet mill, roller mill, or ultrasonics, thereby obtaining solid dispersion. Preferred is a method using a sand mill. In this case, there may also be used a protective colloid (such as poly(vinyl alcohol)), or a surfactant (for instance, an anionic surfactant such as sodium triisopropylnaphthalenesulfonate (a mixture of compounds having the isopropyl groups in different substitution sites)). An antiseptic (for instance, benzisothiazolinone sodium salt) can be added in an aqueous dispersion.

The reducing agent is particularly preferably used as a solid particle dispersion, and the reducing agent is added in the form of fine particles having mean particle size from 0.01 μm to 10 μm, and more preferably, from 0.05 μm to 5 μm, and even more preferably, from 0.1 μm to 1 μm.

Specific examples of the reducing agent which can be used in combination in the present invention are shown below, however the present invention is not limited in these.

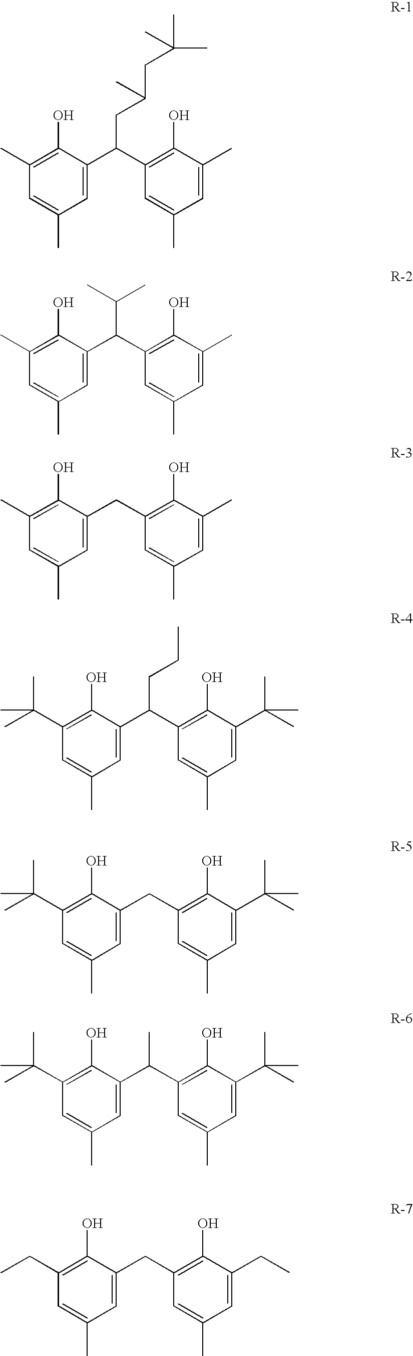

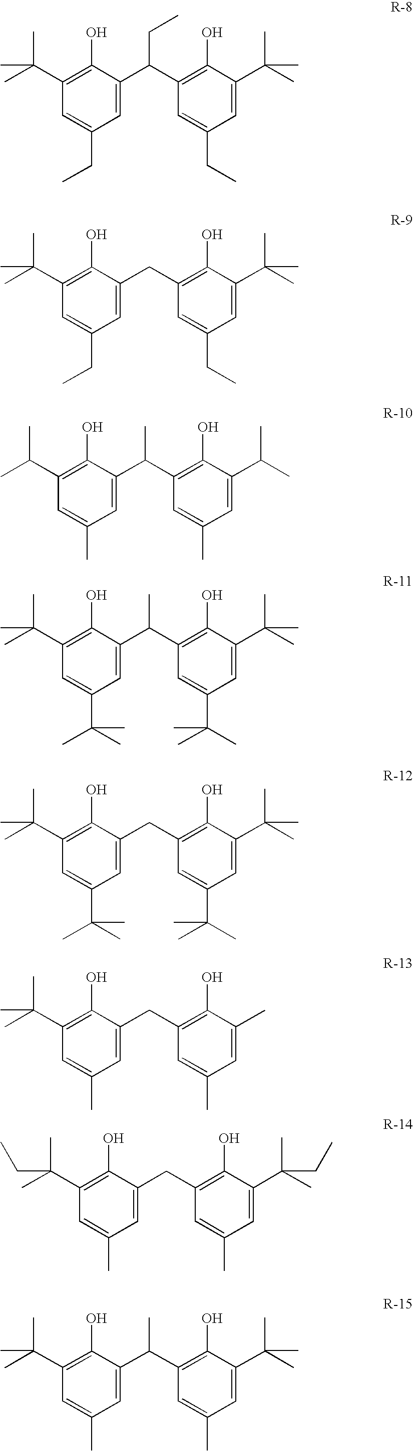

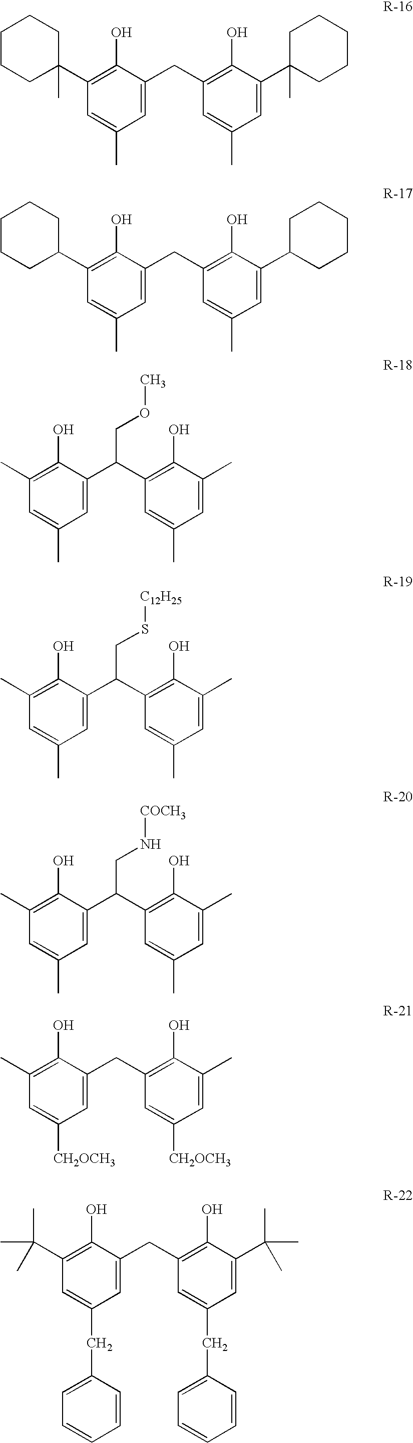

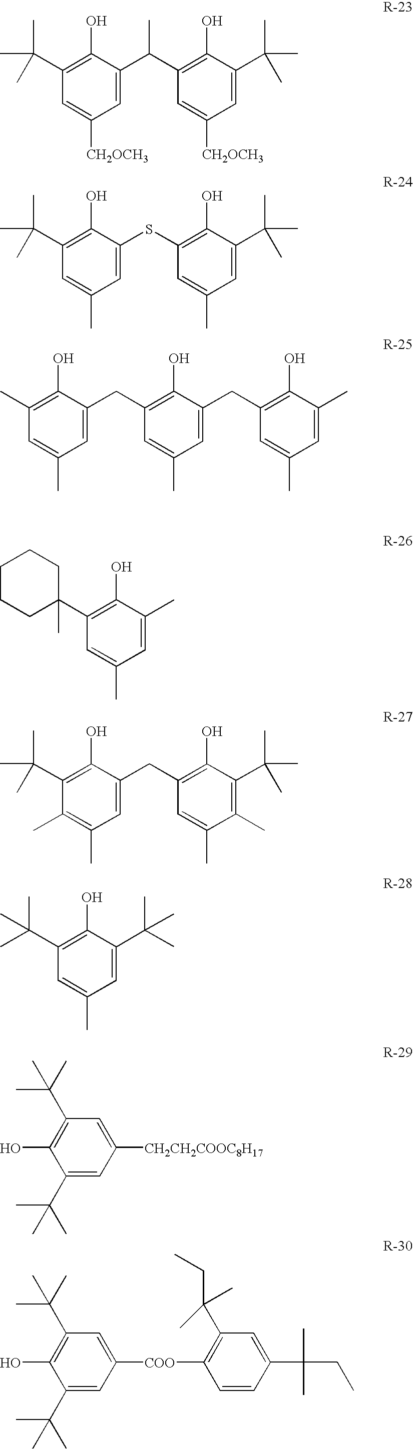

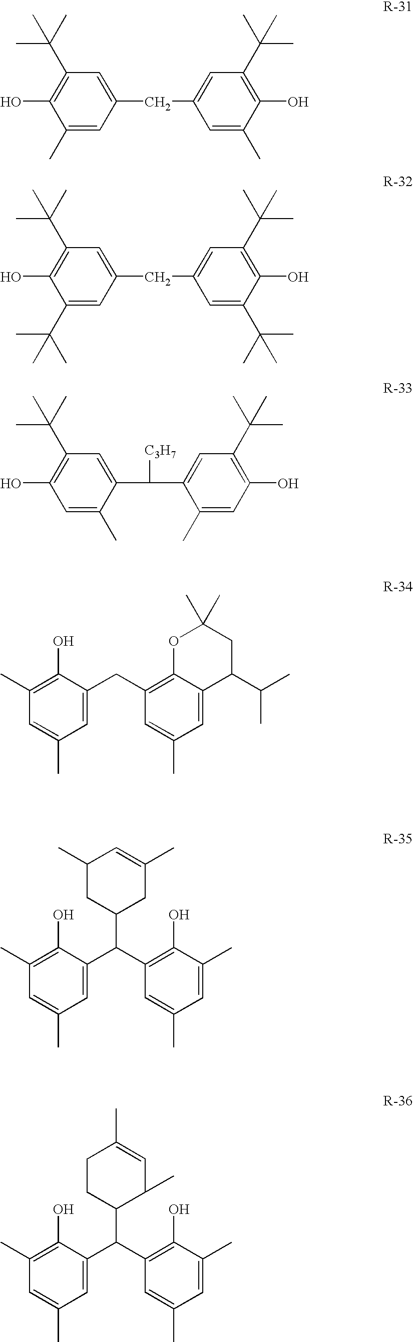

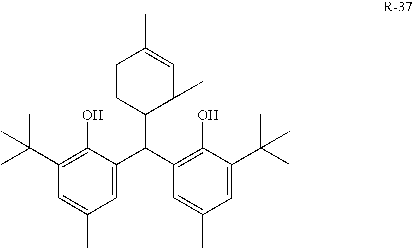

The addition amount of the reducing agent is preferably from 0.01 g/m² to 5.0 g/m², and preferably from 0.1 g/m² to 3.0 g/m². It is preferably contained in a range of from 5 mol % to 50 mol %, and more preferably from 10 mol % to 40 mol %, per 1 mol of silver in the image forming layer.

The reducing agent can be added in the image forming layer which comprises an organic silver salt and a photosensitive silver halide, or in the layer adjacent to the image forming layer, but it is preferably contained in the image forming layer.

The reducing agent of the invention may be incorporated into photothermographic material by being added into the coating solution, such as in the form of solution, emulsion dispersion, solid fine particle dispersion, or the like, similar to the case of the infectious developing reducing agent described above. Preferred adding method and addition layer are also similar.

(Development Accelerator)

In the photothermographic material of the invention, sulfonamide phenolic compounds described in the specification of JP-A No. 2000-267222, and represented by formula (A) described in the specification of JP-A No. 2000-330234; hindered phenolic compounds represented by formula (II) described in JP-A No. 2001-92075; hydrazine compounds described in the specification of JP-A No. 10-62895, represented by formula (I) described in the specification of JP-A No. 11-15116, represented by formula (D) described in the specification of JP-A No. 2002-156727, and represented by formula (I) described in the specification of JP-A No. 2002-278017; and phenolic or naphthalic compounds represented by formula (2) described in the specification of JP-A No. 2001-264929 are used preferably as a development accelerator. Further, phenolic compounds described in JP-A Nos. 2002-311533 and 2002-341484 are also preferable. Naphthalic compounds described in JP-A No. 2003-66558 are particularly preferable. The development accelerator described above is used in a range of from 0.1 mol % to 20 mol %, preferably, in a range of from 0.5 mol % to 10 mol % and, more preferably in a range of from 1 mol % to 5 mol %, with respect to the reducing agent. The introducing methods to the photothermographic material can include similar methods as those for the reducing agent and, it is particularly preferred to add as a solid dispersion or an emulsion dispersion. In the case of adding as an emulsion dispersion, it is preferred to add as an emulsion dispersion dispersed by using a high boiling solvent which is solid at a normal temperature and an auxiliary solvent at a low boiling point, or to add as a so-called oilless emulsion dispersion not using the high boiling solvent.

In the present invention, among the development accelerators described above, it is more preferred to use hydrazine compounds described in the specification of JP-A Nos. 2002-156727 and 2002-278017, and naphtholic compounds described in the specification of JP-A No. 2003-66558.

Particularly preferred development accelerators of the invention are compounds represented by the following formulae (A-1) or (A-2).
Q₁-NHNH-Q₂ Formula (A-1)

wherein Q₁ represents an aromatic group or a heterocyclic group which bonds to —NHNH-Q₂ at a carbon atom, and Q₂ represents one selected from a carbamoyl group, an acyl group, an alkoxycarbonyl group, an aryloxycarbonyl group, a sulfonyl group, or a sulfamoyl group.

In formula (A-1), the aromatic group or the heterocyclic group represented by Q₁ is preferably a 5 to 7-membered unsaturated ring. Preferred examples include a benzene ring, a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isooxazole ring, a thiophene ring, and the like. Condensed rings in which the rings described above are condensed to each other are also preferred.

The rings described above may have substituents and in a case where they have two or more substituents, the substituents may be identical or different from each other. Examples of the substituents can include a halogen atom, an alkyl group, an aryl group, a carbonamide group, an alkylsulfonamide group, an arylsulfonamide group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group, and an acyl group. In the case where the substituents are groups capable of substitution, they may have further substituents and examples of preferred substituents can include a halogen atom, an alkyl group, an aryl group, a carbonamide group, an alkylsulfonamide group, an arylsulfonamide group, an alkoxy group, an aryloxy group, an alkylthio group, an arylthio group, an acyl group, an alkoxycarbonyl group, an aryloxycarbonyl group, a carbamoyl group, a cyano group, a sulfamoyl group, an alkylsulfonyl group, an arylsulfonyl group, and an acyloxy group.

The carbamoyl group represented by Q₂ is a carbamoyl group preferably having 1 to 50 carbon atoms and, more preferably having 6 to 40 carbon atoms, and examples can include unsubstituted carbamoyl, methyl carbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-naphthylcarbamoyl, N-3-pyridylcarbamoyl, and N-benzylcarbamoyl.

The acyl group represented by Q₂ is an acyl group, preferably having 1 to 50 carbon atoms and, more preferably having 6 to 40 carbon atoms, and can include, for example, formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, and 2-hydroxymethylbenzoyl. The alkoxycarbonyl group represented by Q₂ is an alkoxycarbonyl group, preferably having 2 to 50 carbon atoms and, more preferably having 6 to 40 carbon atoms, and can include, for example, methoxycarbonyl, ethoxycarbonyl, isobutyloxycarbonyl, cyclohexyloxycarbonyl, dodecyloxycarbonyl, and benzyloxycarbonyl.

The aryloxy carbonyl group represented by Q₂ is an aryloxycarbonyl group, preferably having 7 to 50 carbon atoms and, more preferably having 7 to 40 carbon atoms, and can include, for example, phenoxycarbonyl, 4-octyloxyphenoxycarbonyl, 2-hydroxymethylphenoxycarbonyl, and 4-dodecyloxyphenoxycarbonyl. The sulfonyl group represented by Q₂ is a sulfonyl group, preferably having 1 to 50 carbon atoms and, more preferably, having 6 to 40 carbon atoms and can include, for example, methylsulfonyl, butylsulfonyl, octylsulfonyl, 2-hexadecylsulfonyl, 3-dodecyloxypropylsulfonyl, 2-octyloxy-5-tert-octylphenyl sulfonyl, and 4-dodecyloxyphenyl sulfonyl.

The sulfamoyl group represented by Q₂ is a sulfamoyl group, preferably having 0 to 50 carbon atoms, more preferably having 6 to 40 carbon atoms, and can include, for example, unsubstituted sulfamoyl, N-ethylsulfamoyl group, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl, and N-(2-tetradecyloxyphenyl)sulfamoyl. The group represented by Q₂ may further have a group mentioned as the example of the substituent of 5 to 7-membered unsaturated ring represented by Q₁ at the position capable of substitution. In a case where the group has two or more substituents, such substituents may be identical or different from each other.

Next, preferred range for the compound represented by formula (A-1) is to be described. A 5 or 6-membered unsaturated ring is preferred for Q₁, and a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thioazole ring, an oxazole ring, an isothiazole ring, an isooxazole ring, and a ring in which the ring described above is condensed with a benzene ring or unsaturated hetero ring are more preferred. Further, Q₂ is preferably a carbamoyl group and, particularly, a carbamoyl group having a hydrogen atom on the nitrogen atom is particularly preferred.

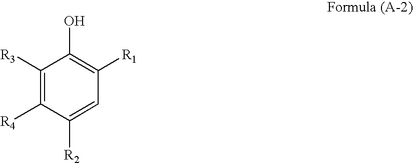

In formula (A-2), R₁ represents one selected from an alkyl group, an acyl group, an acylamino group, a sulfonamide group, an alkoxycarbonyl group, or a carbamoyl group. R₂ represents one selected from a hydrogen atom, a halogen atom, an alkyl group, an alkoxy group, an aryloxy group, an alkylthio group, an arylthio group, an acyloxy group, or a carbonate ester group. R₃ and R₄ each independently represent a group capable of substituting for a hydrogen atom on a benzene ring which is mentioned as the example of the substituent for formula (A-1). R₃ and R₄ may link together to form a condensed ring.

R₁ is preferably an alkyl group having 1 to 20 carbon atoms (for example, a methyl group, an ethyl group, an isopropyl group, a butyl group, a tert-octyl group, a cyclohexyl group, or the like), an acylamino group (for example, an acetylamino group, a benzoylamino group, a methylureido group, a 4-cyanophenylureido group, or the like), or a carbamoyl group (for example, a n-butylcarbamoyl group, an N,N-diethylcarbamoyl group, a phenylcarbamoyl group, a 2-chlorophenylcarbamoyl group, a 2,4-dichlorophenylcarbamoyl group, or the like). An acylamino group (including a ureido group and a urethane group) is more preferred. R₂ is preferably a halogen atom (more preferably, a chlorine atom or a bromine atom), an alkoxy group (for example, a methoxy group, a butoxy group, an n-hexyloxy group, an n-decyloxy group, a cyclohexyloxy group, a benzyloxy group, or the like), or an aryloxy group (for example, a phenoxy group, a naphthoxy group, or the like).

R₃ is preferably a hydrogen atom, a halogen atom, or an alkyl group having 1 to 20 carbon atoms, and most preferably a halogen atom. R₄ is preferably a hydrogen atom, an alkyl group, or an acylamino group, and more preferably an alkyl group or an acylamino group. Examples of the preferred substituent thereof are similar to those for R₁. In the case where R₄ is an acylamino group, R₄ may preferably link with R₃ to form a carbostyryl ring.

In the case where R₃ and R₄ in formula (A-2) link together to form a condensed ring, a naphthalene ring is particularly preferred as the condensed ring. The same substituent as the example of the substituent referred to for formula (A-1) may bond to the naphthalene ring. In the case where formula (A-2) is a naphtholic compound, R₁ is preferably a carbamoyl group. Among them, a benzoyl group is particularly preferred. R₂ is preferably an alkoxy group or an aryloxy group and, particularly preferably an alkoxy group.

Preferred specific examples for the development accelerator of the invention are to be described below. The invention is not restricted to them.

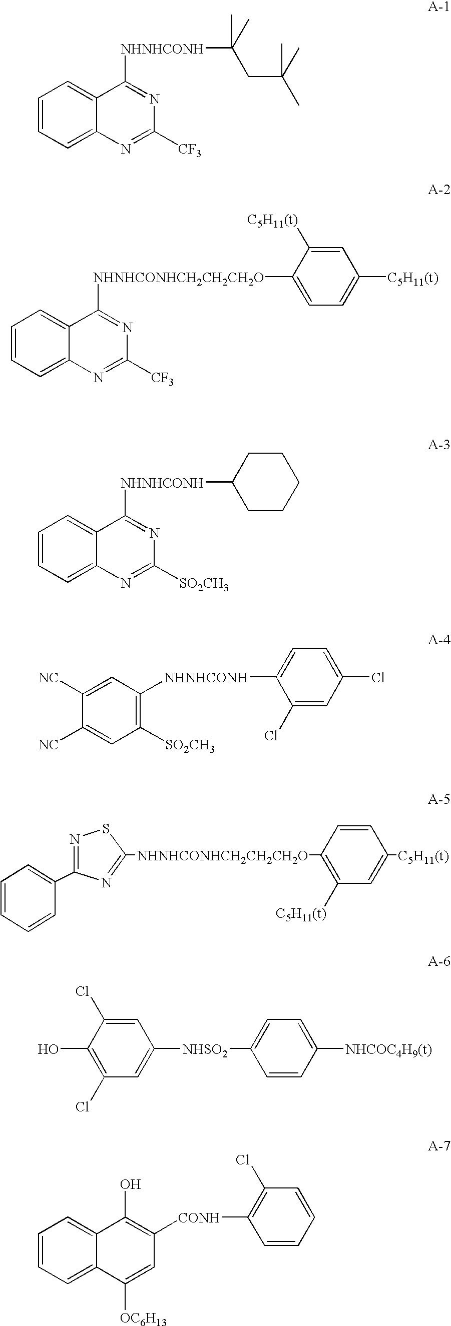

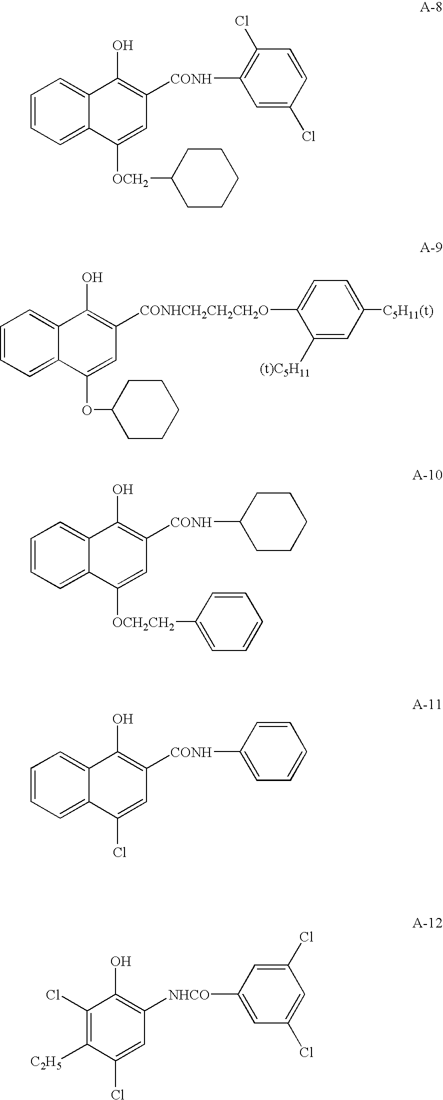

(Hydrogen Bonding Compound)

In the invention, in the case where the reducing agent has an aromatic hydroxy group (—OH) or an amino group (—NHR, R represents a hydrogen atom or an alkyl group), particularly in the case where the reducing agent is a bisphenol described above, it is preferred to use in combination, a non-reducing compound having a group capable of reacting with these groups of the reducing agent, and that is also capable of forming a hydrogen bond therewith.

As a group forming a hydrogen bond with a hydroxyl group or an amino group, there can be mentioned a phosphoryl group, a sulfoxide group, a sulfonyl group, a carbonyl group, an amide group, an ester group, a urethane group, a ureido group, a tertiary amino group, a nitrogen-containing aromatic group, and the like. Particularly preferred among them is a phosphoryl group, a sulfoxide group, an amide group (not having >N—H moiety but being blocked in the form of >N—Ra (where, Ra represents a substituent other than H)), a urethane group (not having >N—H moiety but being blocked in the form of >N—Ra (where, Ra represents a substituent other than H)), and a ureido group (not having >N—H moiety but being blocked in the form of >N—Ra (where, Ra represents a substituent other than H)).

In the invention, particularly preferable as the hydrogen bonding compound is the compound expressed by formula (D) shown below.

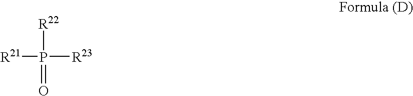

In formula (D), R²¹ to R²³ each independently represent one selected from an alkyl group, an aryl group, an alkoxy group, an aryloxy group, an amino group, or a heterocyclic group, which may be substituted or unsubstituted.

In the case where R₂₁ to R₂₃ contain a substituent, examples of the substituent include a halogen atom, an alkyl group, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group, a phosphoryl group, and the like, in which preferred as the substituents are an alkyl group or an aryl group, e.g., a methyl group, an ethyl group, an isopropyl group, a t-butyl group, a t-octyl group, a phenyl group, a 4-alkoxyphenyl group, a 4-acyloxyphenyl group, and the like.

Specific examples of an alkyl group expressed by R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenetyl group, a 2-phenoxypropyl group, and the like.

As an aryl group, there can be mentioned a phenyl group, a cresyl group, a xylyl group, a naphthyl group, a 4-t-butylphenyl group, a 4-t-octylphenyl group, a 4-anisidyl group, a 3,5-dichlorophenyl group, and the like.

As an alkoxyl group, there can be mentioned a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, a benzyloxy group, and the like.

As an aryloxy group, there can be mentioned a phenoxy group, a cresyloxy group, an isopropylphenoxy group, a 4-t-butylphenoxy group, a naphthoxy group, a biphenyloxy group, and the like.

As an amino group, there can be mentioned are a dimethylamino group, a diethylamino group, a dibutylamino group, a dioctylamino group, an N-methyl-N-hexylamino group, a dicyclohexylamino group, a diphenylamino group, an N-methyl-N-phenylamino group, and the like.

Preferred as R²¹ to R²³ is an alkyl group, an aryl group, an alkoxy group, or an aryloxy group. From the point of the effect of the invention, it is preferred that at least one or more of R²¹ to R²³ are an alkyl group or an aryl group, and more preferably, two or more of them are an alkyl group or an aryl group. From the viewpoint of low cost availability, it is preferred that R²¹ to R²³ are of the same group.

Specific examples of hydrogen bonding compounds represented by formula (D) of the invention and others are shown below, but it should be understood that the invention is not limited thereto.

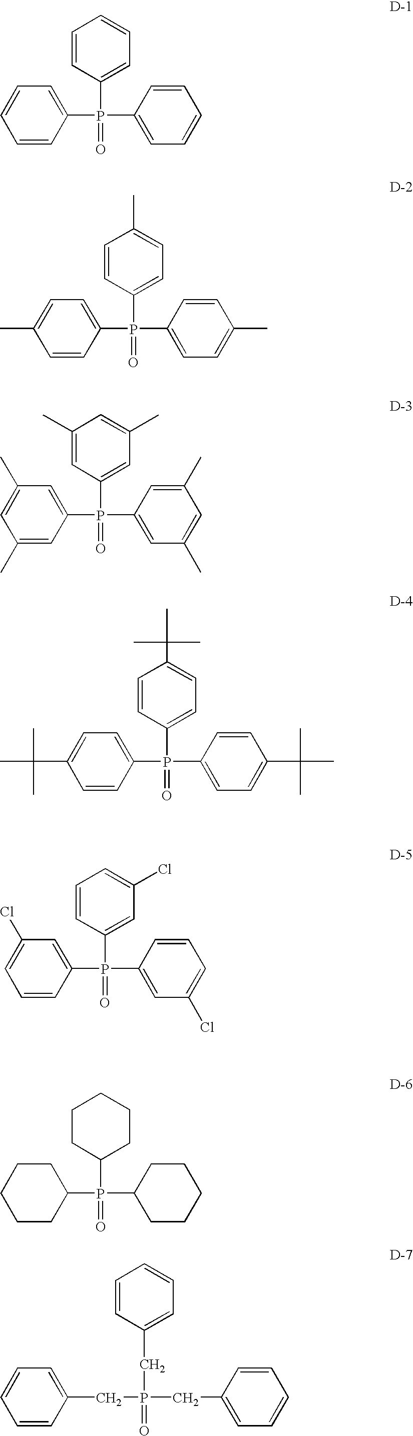

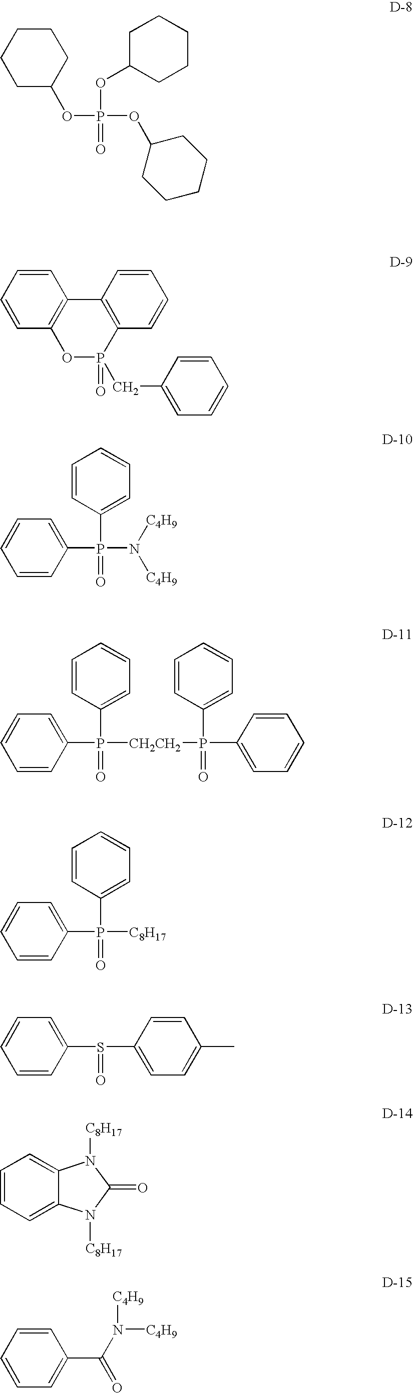

Specific examples of hydrogen bonding compounds other than those enumerated above can be found in those described in EP No. 1,096,310 and in JP-A Nos. 2002-156727 and 2002-318431.

The compound expressed by formula (D) used in the invention can be used in the photothermographic material by being incorporated into the coating solution in the form of solution, emulsion dispersion, or solid fine particle dispersion, similar to the case of reducing agent. However, it is preferably used in the form of solid dispersion. In the solution, the compound expressed by formula (D) forms a hydrogen-bonded complex with a compound having a phenolic hydroxyl group or an amino group, and can be isolated as a complex in crystalline state depending on the combination of the reducing agent and the compound expressed by formula (D).

It is particularly preferred to use the crystal powder thus isolated in the form of solid fine particle dispersion, because it provides stable performance. Further, it is also preferred to use a method of leading to form complex during dispersion by mixing the reducing agent and the compound expressed by formula (D) in the form of powders and dispersing them with a proper dispersion agent using sand grinder mill or the like.

The compound expressed by formula (D) is preferably used in a range from 1 mol % to 200 mol %, more preferably from 10 mol % to 150 mol %, and even more preferably, from 20 mol % to 100 mol %, with respect to the reducing agent.

(Photosensitive Silver Halide)

Concerning the photosensitive silver halide according to the present invention, 50% or more of a total projected area of the photosensitive silver halide grains is occupied by tabular grains having a projected area equivalent diameter of 0.3 μm to 10 μm and an aspect ratio of 2 or more.

1) Halogen Composition

For the photosensitive silver halide used in the invention, there is no particular restriction on the halogen composition and silver chloride, silver bromochloride, silver bromide, silver iodobromide, silver iodochlorobromide, and silver iodide can be used. Among them, silver bromide, silver iodobromide, and silver iodide are preferred.

One of the preferable photosensitive silver halide used in the invention has an average silver bromide content of 60 mol % or higher, and more preferably 80 mol % or higher.

Another preferable photosensitive silver halide used in the invention is a high silver iodide content-silver halide having an average silver iodide content of 40 mol % or higher. More preferably, the average silver iodide content is 80 mol % or higher and, even more preferably, 90 mol % or higher.

Other components are not particularly limited and can be selected from silver chloride, silver chlorobromide, silver bromide, silver iodobromide, silver iodochlorobromide, silver iodide, and the like.

The distribution of the halogen composition in a grain may be uniform or the halogen composition may be changed stepwise, or it may be changed successively. Further, a silver halide grain having a core/shell structure can be used preferably. Preferred structure is a twofold to fivefold structure and, more preferably, core/shell grain having a twofold to fourfold structure can be used. A core-high-silver iodide-structure which has a high content of silver iodide in the core part, and a shell-high-silver iodide-structure which has a high content of silver iodide in the shell part can also be preferably used. Further, a technique of localizing silver bromide or silver iodide on the surface of a grain as form epitaxial parts can also be preferably used.

The silver halide having a high silver iodide content of the invention can assume any content of β phase or γ phase. The term “β phase” described above means a high silver iodide structure having a wurtzite structure of a hexagonal system and the term “γ phase” means a high silver iodide structure having a zinc blende structure of a cubic crystal system. A content of γ phase in the present invention is determined by a method presented by C. R. Berry. In the method, a content of γ phase is calculated from the peak ratio of the intensity owing to γ phase (111) to that owing to β phases (100), (101), and (002) in powder X ray diffraction method. Detail description, for example, is described in Physical Review, volume 161, No. 3, p. 848 to 851 (1967).

2) Grain Size

Concerning the photosensitive silver halide grains used in the present invention, any grain size enough to reach the required high sensitivity can be selected. In the present invention, a mean equivalent spherical diameter of the tabular silver halide is from 0.3 μm to 10.0 μm, preferably from 0.35 μm to 7.0 μm, and more preferably from 0.4 μm to 5.0 μm. The term “equivalent spherical diameter” used here means a diameter of a sphere having the same volume as the volume of one silver halide grain. As for a measuring method, the volume of a grain is calculated from projected area and thickness of individual grains by observation through an electron microscope, and thereafter the equivalent spherical diameter is determined by converting the volume to a sphere having a volume equivalent to the obtained volume.

3) Coating Amount

Conventionally, the photothermographic materials used for photographing need the use of large grain size of silver halide to attain high sensitivity required thereby and also so much coating amounts of the silver halide as 0.5 g/m² or more, based on a silver amout, to raise the image density. In case of the present invention, the use of a means for nucleation is found to be effective for raising the image density, so that the coating amount of silver halide can be reduced. In the practice of the present invention, a total coating amount of the silver halide on both sides of the support is preferably in a range of from 0.01 g/m² to 0.45 g/m⁻², and more preferably from 0.05 g/m² to 0.3 g/m², based on a silver amount.

In the practice of the present invention, the coating amount of the silver halide is preferably from 0.5 mol % to 100 mol % per 1 mol of silver contained in the non-photosensitive organic silver salt, and more preferably from 5 mol % to 50 mol %.

4) Method of Grain Formation

The method of forming photosensitive silver halide is well-known in the relevant art and, for example, methods described in Research Disclosure No. 10729, June 1978 and U.S. Pat. No. 3,700,458 can be used. Specifically, a method of preparing a photosensitive silver halide by adding a silver-supplying compound and a halogen-supplying compound in a gelatin or other polymer solution and then mixing them with an organic silver salt is used. Further, a method described in JP-A No. 11-119374 (paragraph Nos. 0217 to 0224) and methods described in JP-A Nos. 11-352627 and 2000-347335 are also preferred.

According to the method of forming tabular silver iodide grains, preferably used are those described in JP-A Nos. 59-119350 and 59-119344.

5) Grain Shape

The form of the tabular photosensitive silver halide in the invention can be expressed by an aspect ratio which is well-known in the art.

The aspect ratio of the tabular photosensitive silver halide in the invention is from 2 to 100, preferably from 5 to 90, and more preferably from 8 to 80.

A thickness of the tabular photosensitive silver halide in the invention is preferably 0.3 μm or less, preferably 0.2 μm or less, and even more preferably 0.15 μm or less.

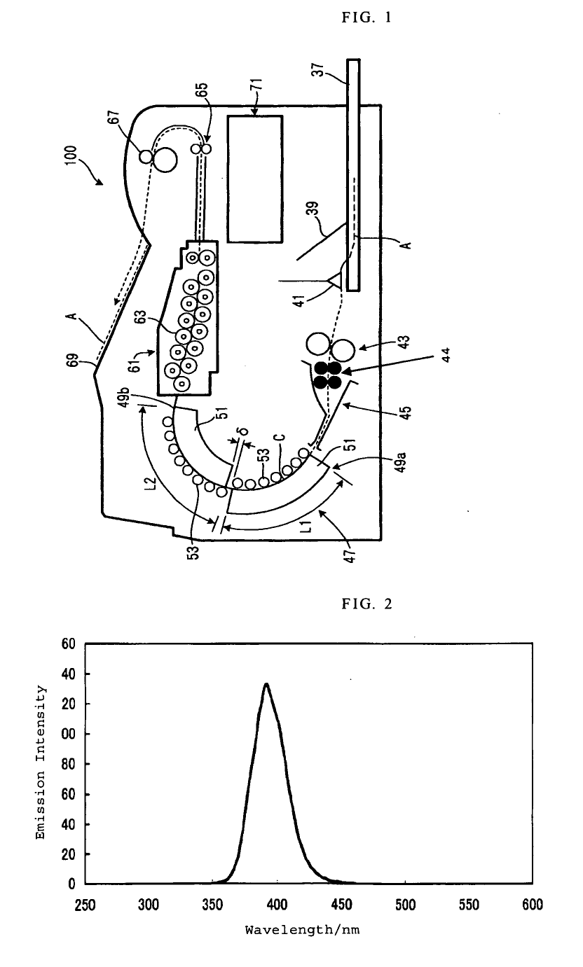

The silver halide having high silver iodide content of the invention can take a complicated form, and as the preferable form, there are listed, for example, connecting grains as shown in R. L. JENKINS et al., J. of Phot. Sci., vol. 28 (1980), p164, FIG. 1. Tabular grains as shown in FIG. 1 of the same literature can also be preferably used. Silver halide grains which are rounded at corners can also be used preferably. The surface indices (Miller indices) of the outer surface of a photosensitive silver halide grain is not particularly restricted, and it is preferable that the ratio occupied by the [100] face is large, because of showing high spectral sensitization efficiency when a spectral sensitizing dye is adsorbed. The ratio is preferably 50% or more, more preferably 65% or more and, further preferably 80% or more. The ratio of the [100] face, Miller index, can be determined by a method described in T. Tani; J. Imaging Sci., vol. 29, page 165, (1985) utilizing adsorption dependency of the [111] face and [100] face in adsorption of a sensitizing dye.

6) Heavy Metal

The photosensitive silver halide grain of the invention can contain metals or complexes of metals belonging to groups 3 to 14 of the periodic table (showing groups 1 to 18). Preferred are metals or complexes of metals belonging to groups 6 to 10. The metal or the center metal of the metal complex from groups 6 to 10 of the periodic table is preferably ferrum, rhodium, ruthenium, or iridium. The metal complex may be used alone, or two or more kinds of complexes comprising identical or different species of metals may be used together. A preferred content is in a range from 1×10⁻⁹ mol to 1×10⁻³ mol per 1 mol of silver. The heavy metals, metal complexes and the adding method thereof are described in JP-A No. 7-225449, in paragraph Nos. 0018 to 0024 of JP-A No. 11-65021 and in paragraph Nos. 0227 to 0240 of JP-A No. 11-119374.

In the present invention, a silver halide grain having a hexacyano metal complex present on the outermost surface of the grain is preferred. The hexacyano metal complex includes, for example, [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻.

In the invention, hexacyano Fe complex is preferred.

Since the hexacyano complex exists in ionic form in an aqueous solution, paired cation is not important and alkali metal ion such as sodium ion, potassium ion, rubidium ion, cesium ion and lithium ion, ammonium ion, alkyl ammonium ion (for example, tetramethyl ammonium ion, tetraethyl ammonium ion, tetrapropyl ammonium ion, and tetra(n-butyl) ammonium ion), which are easily miscible with water and suitable to precipitation operation of a silver halide emulsion are preferably used.

The hexacyano metal complex can be added while being mixed with water, as well as a mixed solvent of water and an appropriate organic solvent miscible with water (for example, alcohols, ethers, glycols, ketones, esters, amides, or the like) or gelatin.

The addition amount of the hexacyano metal complex is preferably from 1×10⁻⁵ mol to 1×10⁻² mol and, more preferably, from 1×10⁻⁴ mol to 1×10⁻³ mol, per 1 mol of silver in each case.

In order to allow the hexacyano metal complex to be present on the outermost surface of a silver halide grain, the hexacyano metal complex is directly added in any stage of: after completion of addition of an aqueous solution of silver nitrate used for grain formation, before completion of an emulsion formation step prior to a chemical sensitization step, of conducting chalcogen sensitization such as sulfur sensitization, selenium sensitization and tellurium sensitization or noble metal sensitization such as gold sensitization, during a washing step, during a dispersion step and before a chemical sensitization step. In order not to grow fine silver halide grains, the hexacyano metal complex is rapidly added preferably after the grain is formed, and it is preferably added before completion of the emulsion formation step.

Addition of the hexacyano complex may be started after addition of 96% by weight of an entire amount of silver nitrate to be added for grain formation, more preferably started after addition of 98% by weight and, particularly preferably, started after addition of 99% by weight.

When any of the hexacyano metal complex is added after addition of an aqueous silver nitrate just before completion of grain formation, it can be adsorbed to the outermost surface of the silver halide grain and most of them form an insoluble salt with silver ions on the surface of the grain. Since the hexacyano iron (II) silver salt is a less soluble salt than AgI, re-dissolution with fine grains can be prevented and fine silver halide grains with smaller grain size can be prepared.

Metal atoms that can be contained in the silver halide grain used in the invention (for example, [Fe(CN)₆]⁴⁻), desalting method of a silver halide emulsion and chemical sensitizing method are described in paragraph Nos. 0046 to 0050 of JP-A No. 11-84574, in paragraph Nos. 0025 to 0031 of JP-A No. 11-65021, and paragraph Nos. 0242 to 0250 of JP-A No. 11-119374.

7) Gelatin

As the gelatin contained the photosensitive silver halide emulsion used in the invention, various kinds of gelatins can be used. It is necessary to maintain an excellent dispersion state of a photosensitive silver halide emulsion in an organic silver salt containing coating solution, and low molecular weight gelatin having a molecular weight of 500 to 60,000 is preferably used. These low molecular weight gelatins may be used at grain formation or at the time of dispersion after desalting treatment and it is preferably used at the time of dispersion after desalting treatment.

8) Chemical Sensitization

The photosensitive silver halide in the present invention can be used without chemical sensitization, but is preferably chemically sensitized by at least one of a chalcogen sensitizing method, gold sensitizing method, and reduction sensitizing method. The chalcogen sensitizing method includes sulfur sensitizing method, selenium sensitizing method and tellurium sensitizing method.

In sulfur sensitization, unstable sulfur compounds can be used. Such unstable sulfur compounds are described in Chimie et Pysique Photographique, written by P. Grafkides, (Paul Momtel, 5th ed., 1987) and Research Disclosure (vol. 307, Item 307105), and the like. As typical examples of sulfur sensitizer, known sulfur compounds such as thiosulfates (e.g., hypo), thioureas (e.g., diphenylthiourea, triethylthiourea, N-ethyl-N′-(4-methyl-2-thiazolyl)thiourea, or carboxymethyltrimethylthiourea), thioamides (e.g., thioacetamide), rhodanines (e.g., diethylrhodanine or 5-benzylydene-N-ethylrhodanine), phosphinesulfides (e.g., trimethylphosphinesulfide), thiohydantoins, 4-oxo-oxazolidin-2-thiones, disulfides or polysulfides (e.g., dimorphorinedisulfide, cystine, or lenthionine (1,2,3,5,6-pentathiepane)), polythionates, and sulfur element, and active gelatin can be used. Specifically, thiosulfates, thioureas, and rhodanines are preferred.

In selenium sensitization, unstable selenium compounds can be used. These unstable selenium compounds are described in Japanese Patent Application Publication (JP-B) Nos. 43-13489 and 44-15748, JP-A Nos. 4-25832, 4-109340, 4-271341, 5-40324, 5-11385, 6-51415, 6-175258, 6-180478, 6-208186, 6-208184, 6-317867, 7-92599, 7-98483, and 7-140579, and the like.

As typical examples of selenium sensitizer, colloidal metal selenide, selenoureas (e.g., N,N-dimethylselenourea, trifluoromethylcarbonyl-trimethylselenourea, or acetyltrimethylselemourea), selenoamides (e.g., selenoamide or N,N-diethylphenylselenoamide), phosphineselenides (e.g., triphenylphosphineselenide or pentafluorophenyl-triphenylphosphineselenide), selenophosphates (e.g., tri-p-tolylselenophosphate or tri-n-butylselenophosphate), selenoketones (e.g., selenobenzophenone), isoselenocyanates, selenocarbonic acids, selenoesters, diacylselenides, or the like may be used.

Furthermore, non-unstable selenium compounds such as selenius acid, salts of selenocyanic acid, selenazoles, and selenides described in JP-B Nos. 46-4553 and 52-34492, and the like can also be used. Specifically, phosphineselenides, selenoureas, and salts of selenocyanic acids are preferred.

In tellurium sensitization, unstable tellurium compounds are used. Unstable tellurium compounds described in JP-A Nos. 4-224595, 4-271341, 4-333043, 5-303157, 6-27573, 6-175258, 6-180478, 6-208186, 6-208184, 6-317867, 7-140579, 7-301879, 7-301880 and the like, can be used as a tellurium sensitizer.

As typical examples of a tellurium sensitizer, phosphinetellurides (e.g., butyl-diisopropylphosphinetelluride, tributylphosphinetelluride, tributoxyphosphinetelluride, or ethoxy-diphenylphosphinetellride), diacyl(di)tellurides (e.g., bis(diphenylcarbamoyl)ditelluride, bis(N-phenyl-N-methylcarbamoyl)ditelluride, bis(N-phenyl-N-methylcarbamoyl)ditelluride, bis(N-phenyl-N-benzylcarbamoyl)telluride, or bis(ethoxycarmonyl)telluride), telluroureas (e.g., N,N′-dimethylethylenetellurourea or N,N′-diphenylethylenetellurourea), telluramides, or telluroesters may be used. Specifically, diacyl(di)tellurides and phosphinetellurides are preferred. Especially, the compounds described in paragraph No. 0030 of JP-A No. 11-65021 and compounds represented by formulae (II), (III), or (IV) in JP-A No. 5-313284 are preferred.

Specifically, as for the chalcogen sensitization of the invention, selenium sensitization and tellurium sensitization are preferred, and tellurium sensitization is particularly preferred.

In gold sensitization, gold sensitizer described in Chimie et Physique Photographique, written by P. Grafkides, (Paul Momtel, 5th ed., 1987) and Research Disclosure (vol. 307, Item 307105) can be used. More specifically, chloroauric acid, potassium chloroaurate, potassium aurithiocyanate, gold sulfide, gold selenide, or the like can be used. In addition to these, the gold compounds described in U.S. Pat. Nos. 2,642,361, 5,049,484, 5,049,485, 5,169,751, and 5,252,455, Belg. Patent No. 691857, and the like can also be used. Noble metal salts other than gold such as platinum, palladium, iridium and the like, which are described in Chimie et Pysique Photographique, written by P. Grafkides, (Paul Momtel, 5th ed., 1987) and Research Disclosure (vol. 307, Item 307105), can also be used.

The gold sensitization can be used independently, but it is preferably used in combination with the above chalcogen sensitization. Specifically, these sensitizations are gold-sulfur sensitization (gold-plus-sulfur sensitization), gold-selenium sensitization, gold-tellurium sensitization, gold-sulfur-selenium sensitization, gold-sulfur-tellurium sensitization, gold-selenium-tellurium sensitization and gold-sulfur-selenium-tellurium sensitization.

In the invention, chemical sensitization can be applied at any time so long as it is after grain formation and before coating and it can be applied, after desalting, (1) before spectral sensitization, (2) simultaneously with spectral sensitization, (3) after spectral sensitization, (4) just before coating, or the like.

The addition amount of chalcogen sensitizer used in the invention may vary depending on the silver halide grain used, the chemical ripening condition, and the like, and it is from 10⁻⁸ mol to 10⁻¹ mol, and preferably from about 10⁻⁷ mol to about 10⁻² mol, per 1 mol of silver halide.

Similarly, the addition amount of the gold sensitizer used in the invention may vary depending on various conditions and it is generally from 10⁻⁷ mol to 10⁻² mol and, more preferably, from 10⁻⁶ mol to 5×10⁻³ mol, per 1 mol of silver halide. There is no particular restriction on the condition for the chemical sensitization and, appropriately, the pAg is 8 or lower, preferably, 7.0 or lower, more preferably, 6.5 or lower and, particularly preferably, 6.0 or lower, and the pAg is 1.5 or higher, preferably, 2.0 or higher and, particularly preferably, 2.5 or higher; the pH is from 3 to 10, preferably, from 4 to 9; and the temperature is at from 20° C. to 95° C., preferably, from 25° C. to 80° C.

In the invention, reduction sensitization can also be used in combination with the chalcogen sensitization or the gold sensitization. It is specifically preferred to use in combination with the chalcogen sensitization.

As the specific compound for the reduction sensitization, ascorbic acid, thiourea dioxide, or dimethylamine borane is preferred, as well as use of stannous chloride, aminoimino methane sulfonic acid, hydrazine derivatives, borane compounds, silane compounds, polyamine compounds, and the like are preferred. The reduction sensitizer may be added at any stage in the photosensitive emulsion production process from crystal growth to the preparation step just before coating. Further, it is preferred to apply reduction sensitization by ripening while keeping the pH to 8 or higher and the pAg to 4 or lower for the emulsion, and it is also preferred to apply reduction sensitization by introducing a single addition portion of silver ions during grain formation.

The addition amount of the reduction sensitizer may also vary depending on various conditions and it is generally from 10⁻⁷ mol to 10⁻¹ mol and, more preferably, from 10⁻⁶ mol to 5×10⁻² mol per 1 mol of silver halide.

In the silver halide emulsion used in the invention, a thiosulfonate compound may be added by the method shown in EP-A No. 293917.

The photosensitive silver halide grain in the invention is preferably chemically sensitized by at least one method of gold sensitizing method and chalcogen sensitizing method for the purpose of designing a high-sensitivity photothermographic material.

8) Sensitizing Dye

As the sensitizing dye applicable in the invention, those capable of spectrally sensitizing silver halide grains in a desired wavelength region upon adsorption to silver halide grains having spectral sensitivity suitable to the spectral characteristic of an exposure light source can be advantageously selected. The sensitizing dyes and the adding method are disclosed, for example, JP-A No. 11-65021 (paragraph Nos. 0103 to 0109), as a compound represented by the formula (II) in JP-A No. 10-186572, dyes represented by the formula (I) in JP-A No. 11-119374 (paragraph No. 0106), dyes described in U.S. Pat. Nos. 5,510,236 and 3,871,887 (Example 5), dyes disclosed in JP-A Nos. 2-96131 and 59-48753, as well as in page 19, line 38 to page 20, line 35 of EP No. 0803764A1, and in JP-A Nos. 2001-272747, 2001-290238 and 2002-23306. The sensitizing dyes described above may be used alone or two or more kinds of them may be used in combination. In the invention, sensitizing dye is preferably added after a desalting step and before coating, and more preferably after a desalting step and before the completion of chemical ripening.

In the invention, the sensitizing dye may be added at any amount according to the property of sensitivity and fogging, but it is preferably added from 10⁻⁶ mol to 1 mol, and more preferably from 10⁻⁴ mol to 10⁻¹ mol, per 1 mol of silver halide in the image forming layer.

The photothermographic material of the invention may also contain super sensitizers in order to improve the spectral sensitizing effect. The super sensitizers usable in the invention can include those compounds described in EP-A No. 587338, U.S. Pat. Nos. 3,877,943 and 4,873,184, JP-A Nos. 5-341432, 11-109547, and 10-111543, and the like.

10) Combined Use of a Plurality of Silver Halides

The photosensitive silver halide emulsion in the photothermographic material used in the invention may be used alone, or two or more kinds of them (for example, those of different average particle sizes, different halogen compositions, of different crystal habits and of different conditions for chemical sensitization) may be used together. Gradation can be controlled by using plural kinds of photosensitive silver halides of different sensitivity. The relevant techniques can include those described, for example, in JP-A Nos. 57-119341, 53-106125, 47-3929, 48-55730, 46-5187, 50-73627, and 57-150841. It is preferred to provide a sensitivity difference of 0.2 or more in terms of log E between each of the emulsions.

11) Mixing Photosensitive Silver Halide and Organic Silver Salt

The method of mixing the photosensitive silver halide and the organic silver salt can include a method of mixing separately prepared silver halide grains and organic silver salt by a high speed stirrer, ball mill, sand mill, colloid mill, vibration mill, or homogenizer, or a method of mixing a photosensitive silver halide completed for preparation at any timing in the preparation of an organic silver salt and preparing the organic silver salt. The effect of the invention can be obtained preferably by any of the methods described above. Further, a method of mixing two or more kinds of aqueous dispersions of organic silver salts and two or more kinds of aqueous dispersions of photosensitive silver salts upon mixing is used preferably for controlling the photographic properties.

12) Mixing Silver Halide into Coating Solution

In the invention, the time of adding silver halide to the coating solution for the image forming layer is preferably in a range of from 180 minutes before to just prior to the coating, more preferably, 60 minutes before to 10 seconds before coating. But there is no restriction for mixing method and mixing condition as long as the effect of the invention is sufficient. As an embodiment of a mixing method, there is a method of mixing in a tank and controlling an average residence time. The average residence time herein is calculated from addition flux and the amount of solution transferred to the coater. And another embodiment of mixing method is a method using a static mixer, which is described in 8th edition of “Ekitai Kongo Gijutu” by N. Harnby and M. F. Edwards, translated by Koji Takahashi (Nikkan Kogyo Shinbunsha, 1989).

(Compound which Substantially Reduces Haze by Photosensitive Silver Halide after Thermal Development)

In the present invention, it is preferred that the photothermographic material contains a compound which substantially reduces haze by photosensitive silver halide after thermal development relative to before thermal development.

In the present invention, it is particularly preferred that a silver iodide complex-forming agent is used as the compound which substantially reduces haze by photosensitive silver halide after thermal development.

<Silver Iodide Complex-Forming Agent>

Concerning the silver iodide complex-forming agent according to the present invention, at least one of a nitrogen atom or a sulfur atom in the compound can contribute to a Lewis acid-base reaction which gives an electron to a silver ion, as a ligand atom (electron donor: Lewis base). The stability of the complex is defined by successive stability constant or total stability constant, but it depends on the combination of silver ion, iodo ion and the silver complex forming agent. As a general guide, it is possible to obtain a large stability constant by a chelate effect from intramolecular chelate ring formation, by means of increasing the acid-base dissociation constant, or the like.

In the present invention, the haze of the photosensitive silver halide can be measured by a commercially available tubidimeter or a haze measuring apparatus. When the absorption derived from other compounds added to the photothermographic material overlaps with the absorption of photosensitive silver halide, the haze of photosensitive silver halide can be observed by using, independently or in combination, the means of difference spectrum or removal of other compounds by solvent, or the like.

As a silver iodide complex-forming agent according to the present invention, a 5 to 7-membered heterocyclic compound containing at least one nitrogen atom is preferable. In the case where the compound does not have a mercapto group, a sulfide group, or a thione group as a substituent, the said nitrogen containing 5 to 7-membered heterocycle may be saturated or unsaturated, and may have another substituent. The substituent on a heterocycle may bond to each other to form a ring.

As preferable examples of 5 to 7-membered heterocyclic compounds, pyrrole, pyridine, oxazole, isoxazole, thiazole, isothiazole, imidazole, pyrazole, pyrazine, pyrimidine, pyridazine, indole, isoindole, indolizine, quinoline, isoquinoline, benzimidazole, 1H-imidazole, quinoxaline, quinazoline, cinnoline, phthalazine, naphthylizine, purine, pterizine, carbazole, acridine, phenanthoridine, phenanthroline, phenazine, phenoxazine, phenothiazine, benzothiazole, benzoxazole, 1,2,4-triazine, 1,3,5-triazine, pyrrolidine, imidazolidine, pyrazolidine, piperidine, piperazine, morpholine, indoline, isoindoline, and the like can be described. More preferably, pyridine, imidazole, pyrazole, pyrazine, pyrimidine, pyridazine, indole, isoindole, indolizine, quinoline, isoquinoline, benzimidazole, 1H-imidazole, quinoxaline, quinazoline, cinnoline, phthalazine, 1,8-naphthylizine, 1,10-phenanthroline, benzotriazole, 1,2,4-triazine, 1,3,5-triazine, and the like can be described. Particularly preferably, pyridine, imidazole, pyrazine, pyrimidine, pyridazine, phthalazine, triazine, 1,8-naphthylizine, 1,10-phenanthroline, and the like can be described.

These rings may have a substituent and any substituent can be used as far as it does not negatively impact the photographic property. As preferable examples, a halogen atom (fluorine atom, chlorine atom, bromine atom, or iodine atom), an alkyl group (a straight, a branched, a cyclic alkyl group containing a bicycloalkyl group and an active methine group), an alkenyl group, an alkynyl group, an aryl group, a heterocyclic group (substituted position is not asked), an acyl group, an alkoxycarbonyl group, an aryloxycarbonyl group, a heterocyclic oxycarbonyl group, a carbamoyl group, an N-acylcarbamoyl group, an N-sulfonylcarbamoyl group, an N-carbamoylcarbamoyl group, an N-sulfamoylcarbamoyl group, a carbazoyl group, a carboxyl group and a salt thereof, an oxalyl group, an oxamoyl group, a cyano group, a carbonimidoyl group, a formyl group, a hydroxy group, an alkoxy group (including the group in which ethylene oxy group units or propylene oxy group units are repeated), an aryloxy group, a heterocyclic oxy group, an acyloxy group, an alkoxycarbonyloxy group, an aryloxycarbonyloxy group, a carbamoyloxy group, a sulfonyloxy group, an amino group, an alkylamino group, an arylamino group, a heterocyclic amino group, an acylamino group, a sulfonamide group, a ureido group, a thioureido group, an imide group, an alkoxycarbonylamino group, an aryloxycarbonylamino group, a sulfamoylamino group, a semicarbazide group, an ammonio group, an oxamoylamino group, an N-alkylsulfonylureido group, an N-arylsulfonylureido group, an N-acylureido group, an N-acylsulfamoylamino group, a nitro group, a heterocyclic group containing a quaternary nitrogen atom (e.g., a pyridinio group, an imidazolio group, a quinolinio group, or an isoquinolinio group), an isocyano group, an imino group, an alkylsulfonyl group, an arylsulfonyl group, an alkylsulfinyl group, an arylsulfinyl group, a sulfo group and a salt thereof, a sulfamoyl group, an N-acylsulfamoyl group, an N-sulfonylsulfamoyl group and a salt thereof, a phosphino group, a phosphinyl group, a phosphinyloxy group, a phosphinylamino group, a silyl group, and the like are described. Here, an active methine group means a methine group substituted by two electron-attracting groups, wherein the electron-attracting group means an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group, a carbonimidoyl group. Herein, two electron-attracting groups may bond to each other to form a cyclic structure. And, the salt means a salt formed with positive ion such as an alkaline metal, an alkaline earth metal, a heavy metal, or the like, or organic positive ion such as an ammonium ion, a phosphonium ion, or the like. These substituents may be further substituted by these substituents.

These heterocycles may be further condensed by another ring. In the case where the substituent is an anion group (e.g., —CO₂⁻, —SO₃⁻, —S⁻, or the like), the heterocycle containing nitrogen atom of the invention may become a positive ion (e.g., pyridinium, 1,2,4-triazolium, or the like) and may form an intramolecular salt.

In the case where a heterocyclic compound is pyridine, pyrazine, pyrimidine, pyridazine, phthalazine, triazine, naththilizine, or phenanthroline derivative, the acid dissociation constant (pKa) of a conjugated acid of nitrogen containing heterocyclic part in acid dissociation equilibrium of the said compound is preferably from 3 to 8 in the mixture solution of tetrahydrofuran/water (3/2) at 25° C., and more preferably, the pKa is from 4 to 7.

As the heterocyclic compound, pyridine, pyridazine, and a phthalazine derivative are preferable, and particularly preferable are pyridine and a phthalazine derivative.

In the case where these heterocyclic compounds have a mercapto group, a sulfide group or a thione group as the substituent, pyridine, thiazole, isothiazole, oxazole, isoxazole, imidazole, pyrazole, pyrazine, pyrimidine, pyridazine, triazine, triazole, thiadiazole, and oxadiazole derivatives are preferable, and thiazole, imidazole, pyrazole, pyrazine, pyrimidine, pyridazine, triazine, and triazole derivatives are particularly preferable.

For example, as the said silver iodide complex-forming agent, the compound represented by the following formula (I) or (2) can be used.

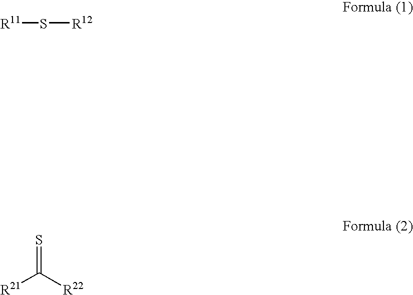

In formula (I), R¹¹ and R¹² each independently represent a hydrogen atom or a substituent. In formula (2), R²¹ and R²² each independently represent a hydrogen atom or a substituent. However, both of R¹¹ and R¹² are not hydrogen atoms together and both of R²¹ and R²² are not hydrogen atoms together. As the substituent herein, the substituent explained as the substituent of a 5 to 7-membered nitrogen containing heterocyclic type silver iodide complex-forming agent mentioned above can be described.

Further, the compound represented by formula (3) described below can also be used preferably.

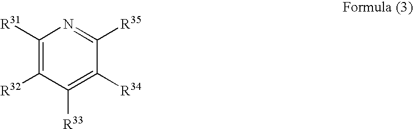

In formula (3), R³¹ to R³⁵ each independently represent a hydrogen atom or a substituent. As the substituent represented by R³¹ to R³⁵, the substituent of a 5 to 7-membered nitrogen containing heterocyclic type silver iodide complex-forming agent mentioned above can be used. In the case where the compound represented by formula (3) has a substituent, preferred substituting position is R³² to R³⁴. R³¹ to R³⁵ may bond to each other to form a saturated or an unsaturated ring. A preferred substituent is a halogen atom, an alkyl group, an aryl group, a carbamoyl group, a hydroxy group, an alkoxy group, an aryloxy group, a carbamoyloxy group, an amino group, an acylamino group, a ureido group, an alkoxycarbonylamino group, an aryloxycarbonylamino group, or the like.

In the compound represented by formula (3), the acid dissociation constant (pKa) of conjugated acid of pyridine ring part is preferably from 3 to 8 in the mixed solution of tetrahydrofuran/water (3/2) at 25° C., and particularly preferably, from 4 to 7.

Furthermore, the compound represented by formula (4) is also preferable.

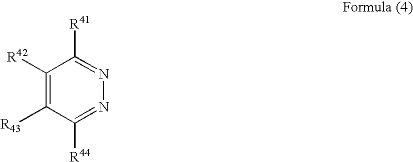

In formula (4), R⁴¹ to R⁴⁴ each independently represent a hydrogen atom or a substituent. R⁴¹ to R⁴⁴ may bond to each other to form a saturated or an unsaturated ring. As the substituent represented by R⁴¹ to R⁴⁴, the substituent of a 5 to 7-membered nitrogen containing heterocyclic type silver iodide complex-forming agent mentioned above can be described. As preferred group, an alkyl group, an alkenyl group, an alkynyl group, an aryl group, a hydroxy group, an alkoxy group, an aryloxy group a heterocyclic oxy group, and a group which forms a phthalazine ring by benzo-condensation are described. In the case where a hydroxy group exists at the carbon atom adjacent to nitrogen atom of the compound represented by formula (4), there exists equilibrium between pyridazinone.

The compound represented by formula (4) more preferably forms a phthalazine ring represented by the following formula (5), and furthermore, this phthalazine ring particularly preferably has at least one subsutituent. As examples of R⁵¹ to R⁵⁶ in formula (5), the substituent of a 5 to 7-membered nitrogen containing heterocyclic type silver iodide complex-forming agent mentioned above can be described. And as more preferable examples of the substituent, an alkyl group, an alkenyl group, an alkynyl group, an aryl group, a hydroxy group, an alkoxy group, an aryloxy group, and the like are described. An alkyl group, an alkenyl group, an aryl group, an alkoxy group, and an aryloxy group are preferable and an alkyl group, an alkoxy group, and an aryloxy group are more preferable.

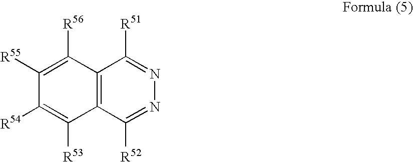

Further, the compound represented by formula (6) described below is also a preferable embodiment.

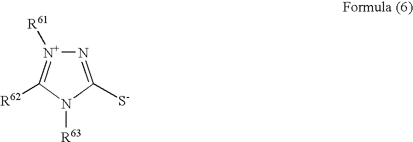

In formula (6), R⁶¹ to R⁶³ each independently represent a hydrogen atom or a substituent. As examples of the substituent, the substituent of a 5 to 7-membered nitrogen containing heterocyclic type silver iodide complex-forming agent mentioned above can be described.

As the compound preferably used, the compound represented by the following formula (7) is described.

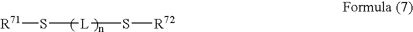

In formula (7), R⁷¹ and R⁷² each independently represent a hydrogen atom or a substituent. L represents a divalent linking group. n represents 0 or 1. As the substituent represented by R⁷¹ and R⁷², an alkyl group (containing a cycloalkyl group), an alkenyl group (containing a cycloalkenyl group), an alkynyl group, an aryl group, a heterocyclic group, an acyl group, an aryloxycarbonyl group, an alkoxycarbonyl group, a carbamoyl group, an imide group, and a complex substituent containing these groups are described as examples. A divalent linking group represented by L preferably has the length of from 1 to 6 atoms and more preferably has the length of from 1 to 3 atoms, and furthermore, may have a substituent.

One more of the compounds preferably used is a compound represented by formula (8).

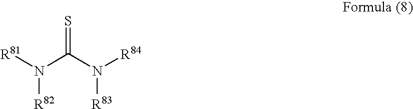

In formula (8), R⁸¹ to R⁸⁴ each independently represent a hydrogen atom or a substituent. As the substituent represented by R⁸¹ to R⁸⁴, an alkyl group (including a cycloalkyl group), an alkenyl group (including a cycloalkenyl group), an alkynyl group, an aryl group, a heterocyclic group, an acyl group, an aryloxycarbonyl group, an alkoxycarbonyl group, a carbamoyl group, an imide group, and the like are described as examples.

Among the silver iodide complex-forming agents described above, the compounds represented by formulae (3), (4), (5), (6), or (7) are more preferable and, the compounds represented by formulae (3) or (5) are particularly preferable.

Preferable examples of silver iodide complex-forming agent are described below, however the present invention is not limited in these.

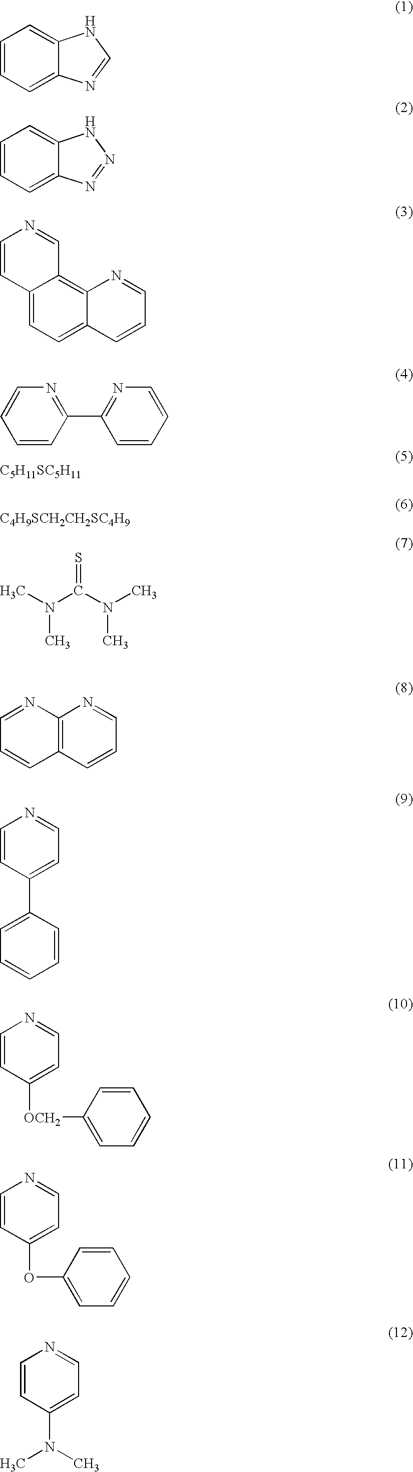

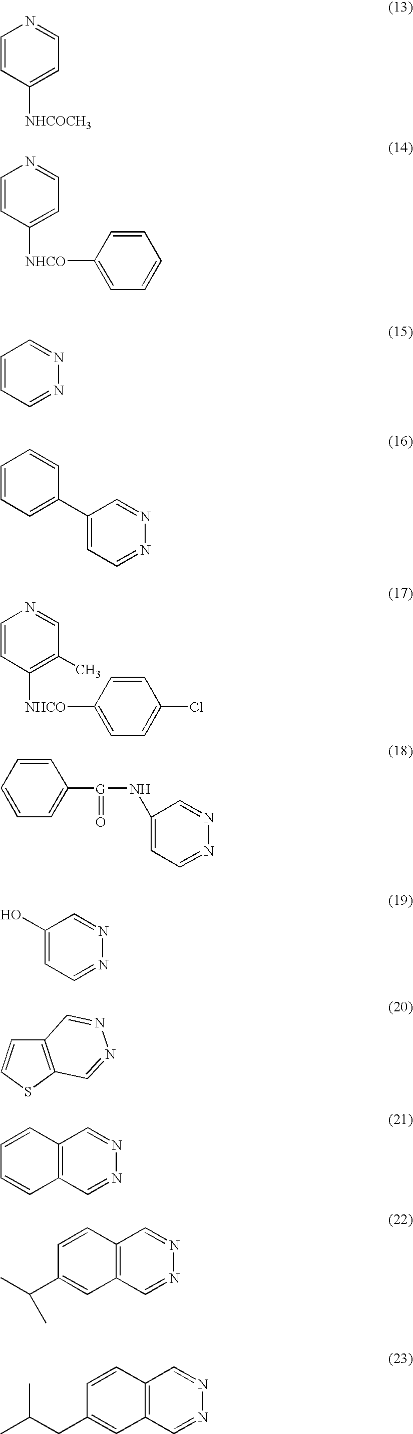

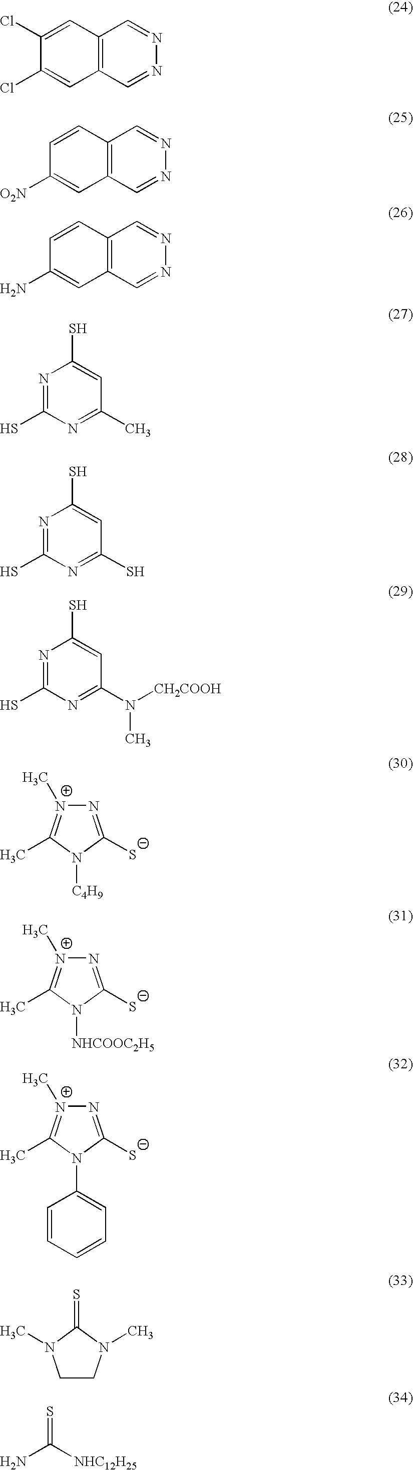

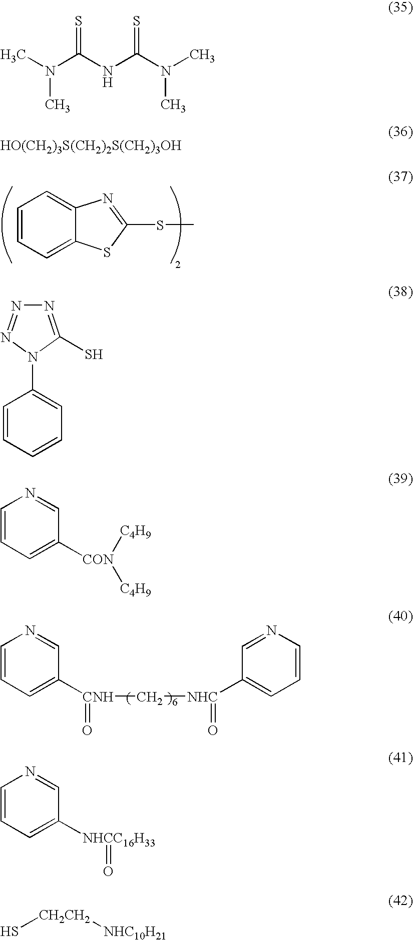

The silver iodide complex-forming agent according to the present invention can also be a compound common to a toner, in the case where the agent achieves the function of conventionally known toner. The silver iodide complex-forming agent according to the present invention can be used in combination with a toner. And, two or more kinds of the silver iodide complex-forming agents may be used in combination.

The silver iodide complex-forming agent according to the present invention preferably exists in a film under the state separated from a photosensitive silver halide, such as a solid state or the like. It is also preferably added to the layer adjacent to the image forming layer. Concerning the silver iodide complex-forming agent according to the present invention, a melting point of the compound is preferably adjusted to a suitable range so that it can be dissolved when heated at thermal developing temperature.

The silver iodide complex-forming agent according to the invention may be incorporated into a photothermographic material by being added into the coating solution, such as in the form of a solution, an emulsion dispersion, a solid fine particle dispersion, or the like.

Well known emulsion dispersing methods include a method comprising dissolving the silver iodide complex-forming agent in an oil such as dibutylphthalate, tricresylphosphate, glyceryl triacetate, diethylphthalate, or the like, using an auxiliary solvent such as ethyl acetate, cyclohexanone, or the like, followed by mechanically forming an emulsified dispersion.

Solid fine particle dispersing methods include a method comprising dispersing the powder of the silver iodide complex-forming agent according to the invention in a proper solvent such as water or the like, by means of ball mill, colloid mill, vibrating ball mill, sand mill, jet mill, roller mill, or ultrasonics, thereby obtaining a solid dispersion. In this case, there may also be used a protective colloid (such as polyvinyl alcohol), or a surfactant (for instance, an anionic surfactant such as sodium triisopropylnaphthalenesulfonate (a mixture of compounds having the three isopropyl groups in different substitution sites)). In the mills enumerated above, generally used as the dispersion media are beads made of zirconia or the like, and Zr or the like eluting from the beads may be incorporated in the dispersion. Depending on the dispersing conditions, the amount of Zr or the like incorporated in the dispersion is generally in a range of from 1 ppm to 1000 ppm. It is practically acceptable as far as Zr is incorporated in the photothermographic material in an amount of 0.5 mg or less per 1 g of silver.

Preferably, an antiseptic (for instance, benzisothiazolinone sodium salt) is added in an aqueous dispersion.

The silver iodide complex-forming agent according to the invention is preferably used in the form of a solid dispersion.

The silver iodide complex-forming agent according to the invention is preferably used in a range of from 1 mol % to 5000 mol %, more preferably, from 10 mol % to 1000 mol % and, even more preferably, from 50 mol % to 300 mol %, with respect to the photosensitive silver halide in each case.

(Phthalic Acid and Derivatives Thereof)

In the present invention, the photothermographic material preferably comprises the compound selected from phthalic acid or derivatives thereof, in combination with the silver iodide complex-forming agent. As phthalic acid and derivatives thereof used in the present invention, the compound represented by the following formula (PH) is preferable.

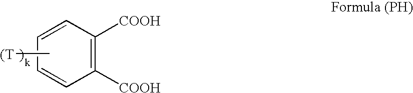

wherein T represents one selected from a halogen atom (fluorine, bromine, or iodine atom), an alkyl group, an aryl group, an alkoxy group, or a nitro group; k represents an integar of 0 to 4, and when k is 2 or more, plural ks may be the same or different from each other. k is preferably 0 to 2, and more preferably, 0 or 1.

The compound represented by formula (PH) may be used just as an acid or may be used as suitable salt from the viewpoint of easy addition to a coating solution and from the viewpoint of pH adjustment. As a salt, an alkaline metal salt, an ammonium salt, an alkaline earth metals salt, an amine salt, or the like can be used. An alkaline metal salt (Li, Na, K, or the like) and an ammonium salt are preferred.

Phthalic acid and the derivatives thereof used in the present invention are described below, however the present invention is not limited in these compounds.

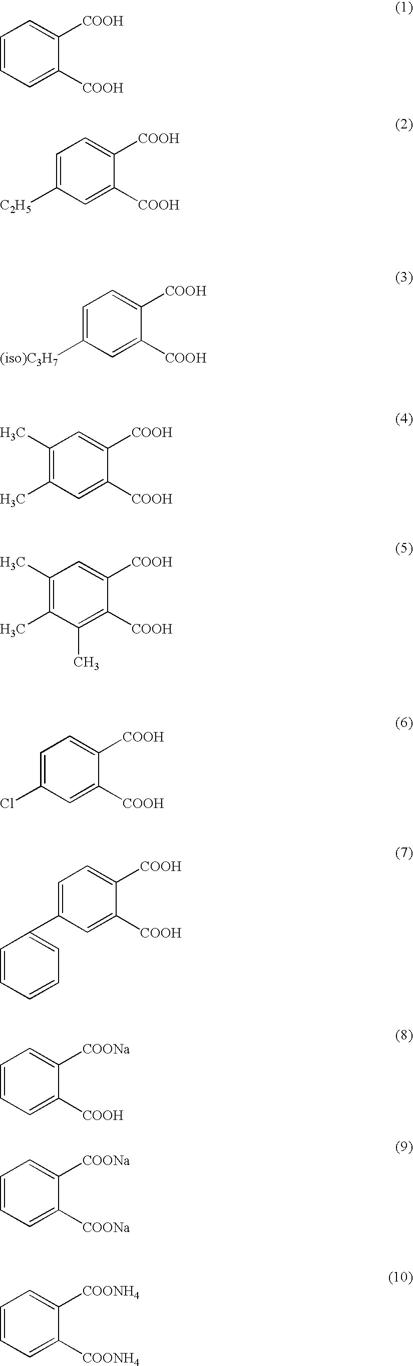

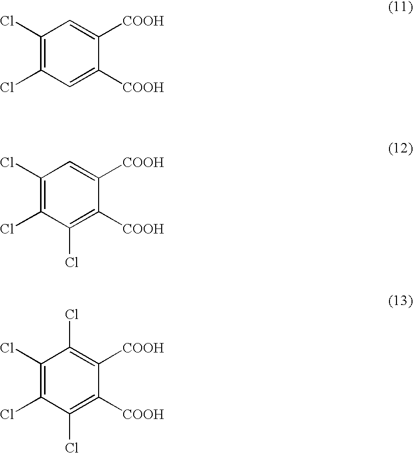

In the invention, the addition amount of phthalic acid or a derivative thereof is from 1.0×10⁻⁴ mol to 1 mol, preferably from 1.0×10⁻³ mol to 0.5 mol and, even more preferably from 2.0×10⁻³ mol to 0.2 mol, per 1 mol of coated silver.

(Binder)

Any kind of polymer may be used as the binder for the image forming layer of the present invention as far as it is a hydrophilic binder. Suitable as the binder are those that are transparent or translucent, and that are generally colorless, such as natural resin or polymer and their copolymers; synthetic resin, or polymer and their copolymer; or media forming a film; for example included are gelatins, rubbers, poly(vinyl alcohols), hydroxylethyl celluloses, cellulose acetates, poly(vinyl pyrrolidones), casein, starch, poly(acrylic acids), and poly(methyl methacrylates).

In the present invention, 50% by weight or more of the binder of the image forming layer is a hydrophilic binder, and preferably, 70% by weight or more of the binder of the image forming layer is a hydrophilic binder.

The specific examples of preferred hydrophilic binder include, but not limited to these examples, gelatin, gelatin derivatives (for example, alkali-processed gelatin, acid-processed gelatin, acetylated gelatin, oxidized gelatin, phthalated gelatin, and deionized gelatin), polysilicic acid, acrylamide/methacrylamide polymer, acrylate/methacrylate polymer, poly(vinyl pyrrolidones), poly(vinyl acetates), poly(vinyl alcohols), poly(vinyl lactams), polymer of sulfoalkyl acrylate, polymer of sulfoalkyl methacrylate, hydrolysised poly(vinyl acetate), polysaccarides (for example, dextrans, starch ethers, and the like), and the other substantially hydrophilic synthetic or natural vehicles (for example, referred to Research Disclosure, item 38957). Among them, more preferred binder are gelatin, a gelatin derivative, and a poly(vinyl alcohols), and most preferred are gelatin and a gelatin derivative.

In the invention, the image forming layer is preferably formed by first applying a coating solution containing 30% by weight or more of water in the solvent and by then drying, and particularly preferably applying a coating solution containing 50% by weight or more of water.

The aqueous solvent in which the polymer is soluble or dispersible, referred herein, signifies water or water containing mixed therein 70% by weight or less of water-miscible organic solvent. As water-miscible organic solvents, there can be used, for example, alcohols such as methyl alcohol, ethyl alcohol, propyl alcohol, or the like; cellosolves such as methyl cellosolve, ethyl cellosolve, butyl cellosolve, or the like; ethyl acetate, dimethylformamide, or the like.

As binders other than the hydrophilic binder, polymers dispersible in an aqueous solvent are preferable. Preferred embodiment of these polymers include hydrophobic polymers such as acrylic polymers, polyesters, rubbers (e.g., SBR resin), polyurethanes, poly(vinyl chlorides), poly(vinyl acetates), poly(vinylidene chlorides), polyolefins, and the like. The polymers above may be straight chain polymers, branched polymers, or crosslinked polymers. They may be the so-called homopolymers in which one kind of monomer is polymerized, or copolymers in which two or more kinds of monomers are polymerized. In the case of a copolymer, it may be a random copolymer or a block copolymer. The molecular weight of these polymers is, in number average molecular weight, in a range of from 5,000 to 1,000,000, and preferably from 10,000 to 200,000. Those having too small a molecular weight exhibit insufficient mechanical strength on forming the image forming layer, and those having too large a molecular weight are also not preferred because the resulting film-forming properties are poor. Further, crosslinking polymer latexes are particularly preferred for use.

Concerning the amount of the binder for the image forming layer according to the invention, the mass ratio of organic silver salt to total binder (organic silver salt/total binder) is preferably in a range of from 1/10 to 10/1, more preferably from 0.6 to 3.0, and even more preferably from 1.0 to 2.5.

The total amount of binder in the image forming layer of the invention is preferably in a range of from 0.2 g/m² to 30 g/m², more preferably from 1 g/m² to 15 g/m², and even more preferably from 2 g/m² to 10 g/m². Concerning the image forming layer of the invention, there may be added a crosslinking agent for crosslinking, a surfactant to improve coating properties, or the like.

(Preferable Solvent of Coating Solution)

In the invention, a solvent of a coating solution for the image forming layer in the photothermographic material of the invention (wherein a solvent and water are collectively described as a solvent for simplicity) is preferably an aqueous solvent containing water at 30% by weight or more. Examples of solvents other than water may include any of water-miscible organic solvents such as methyl alcohol, ethyl alcohol, isopropyl alcohol, methyl cellosolve, ethyl cellosolve, dimethylformamide and ethyl acetate. A water content in a solvent is more preferably 50% by weight or more, and even more preferably 70% by weight or more. Concrete examples of a preferable solvent composition, in addition to water=100, are compositions in which methyl alcohol is contained at ratios of water/methyl alcohol=90/10 and 70/30, in which dimethylformamide is further contained at a ratio of water/methyl alcohol/dimethylformamide=80/15/5, in which ethyl cellosolve is further contained at a ratio of water/methyl alcohol/ethyl cellosolve=85/10/5, and in which isopropyl alcohol is further contained at a ratio of water/methyl alcohol/isopropyl alcohol=85/10/5 (wherein the numerals presented above are values in % by weight).

(Antifoggant)

As an antifoggant, stabilizer and stabilizer precursor usable in the invention, there can be mentioned those disclosed as patents in paragraph number 0070 of JP-A No. 10-62899 and in line 57 of page 20 to line 7 of page 21 of EP-A No. 0803764A1, the compounds described in JP-A Nos. 9-281637 and 9-329864, U.S. Pat. No. 6,083,681, and EP No. 1,048,975.

1) Organic Polyhalogen Compound

Preferable organic polyhalogen compound that can be used in the invention is explained specifically below. In the invention, preferred organic polyhalogen compounds are the compounds expressed by the following formula (H).
Q-(Y)n-C(X₁)(X₂)Z Formula (H)

In formula (H), Q represents one selected from an alkyl group, an aryl group, or a heterocyclic group; Y represents a divalent linking group; n represents 0 or 1; Z represents a halogen atom; and X₁ and X₂ each represent a hydrogen atom or an electron-attracting group.

In formula (H), Q is preferably an alkyl group having 1 to 6 carbon atoms, an aryl group having 6 to 12 carbon atoms, or a heterocyclic group comprising at least one nitrogen atom (pyridine, quinoline, or the like).

In the case where Q is an aryl group in formula (H), Q preferably is a phenyl group substituted by an electron-attracting group whose Hammett substituent constant σp yields a positive value. For the details of Hammett substituent constant, reference can be made to Journal of Medicinal Chemistry, vol. 16, No. 11 (1973), pp. 1207 to 1216, and the like.

As such electron-attracting groups, examples include halogen atoms, an alkyl group substituted by an electron-attracting group, an aryl group substituted by an electron-attracting group, a heterocyclic group, an alkylsulfonyl group, an arylsulfonyl group, an acyl group, an alkoxycarbonyl group, a carbamoyl group, sulfamoyl group, and the like. Preferable as the electron-attracting group are a halogen atom, a carbamoyl group, and an arylsulfonyl group, and particularly preferred is a carbamoyl group.

At least one of X₁ and X₂ is preferably an electron-attracting group. As the electron-attracting group, preferable are a halogen atom, an aliphatic arylsulfonyl group, a heterocyclic sulfonyl group, an aliphatic arylacyl group, a heterocyclic acyl group, an aliphatic aryloxycarbonyl group, a heterocyclic oxycarbonyl group, a carbamoyl group, and a sulfamoyl group; more preferable are a halogen atom and a carbamoyl group; and particularly preferable is a bromine atom.

Z is preferably a bromine atom or an iodine atom, and more preferably, a bromine atom.

Y preferably represents —C(═O)—, —SO—, —SO₂—, —C(═O)N(R)—, or —SO₂N(R)—; more preferably, —C(═O)—, —SO₂—, or —C(═O)N(R)—; and particularly preferably, —SO₂— or —C(═O)N(R)—. Herein, R represents a hydrogen atom, an aryl group, or an alkyl group, preferably a hydrogen atom or an alkyl group, and particularly preferably a hydrogen atom.

n represents 0 or 1, and preferably represents 1.

In formula (H), in the case where Q is an alkyl group, Y is preferably —C(═O)N(R)—. And, in the case where Q is an aryl group or a heterocyclic group, Y is preferably —SO₂—.

In formula (H), the form where the residues, which are obtained by removing a hydrogen atom from the compound, bond to each other (generally called bis type, tris type, or tetrakis type) is also preferably used.

In formula (H), the form having a substituent of a dissociative group (for example, a COOH group or a salt thereof, an SO₃H group or a salt thereof, a PO₃H group or a salt thereof, or the like), a group containing a quaternary nitrogen cation (for example, an ammonium group, a pyridinium group, or the like), a polyethyleneoxy group, a hydroxy group, or the like is also preferable.

Specific examples of the compound expressed by formula (H) of the invention are shown below.

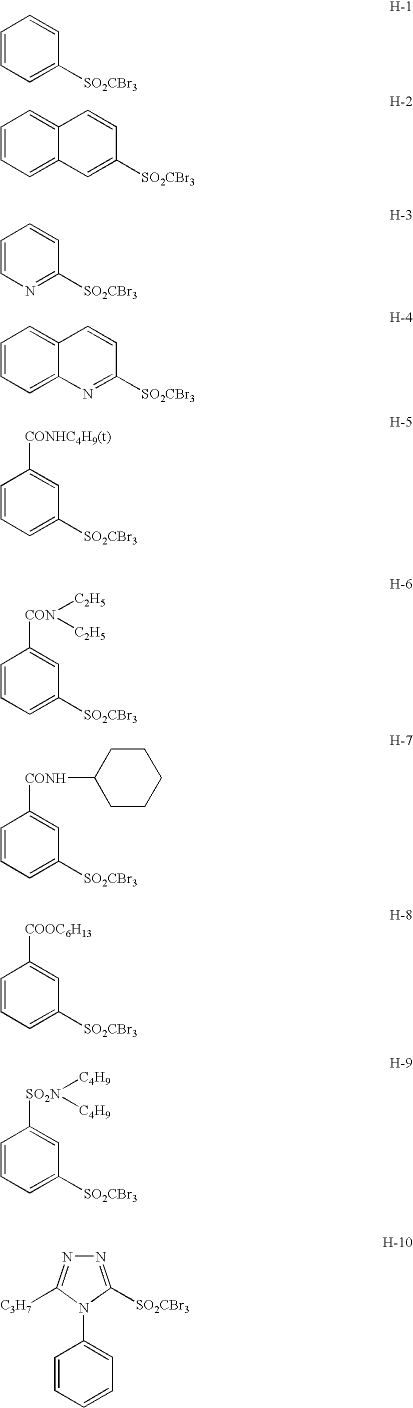

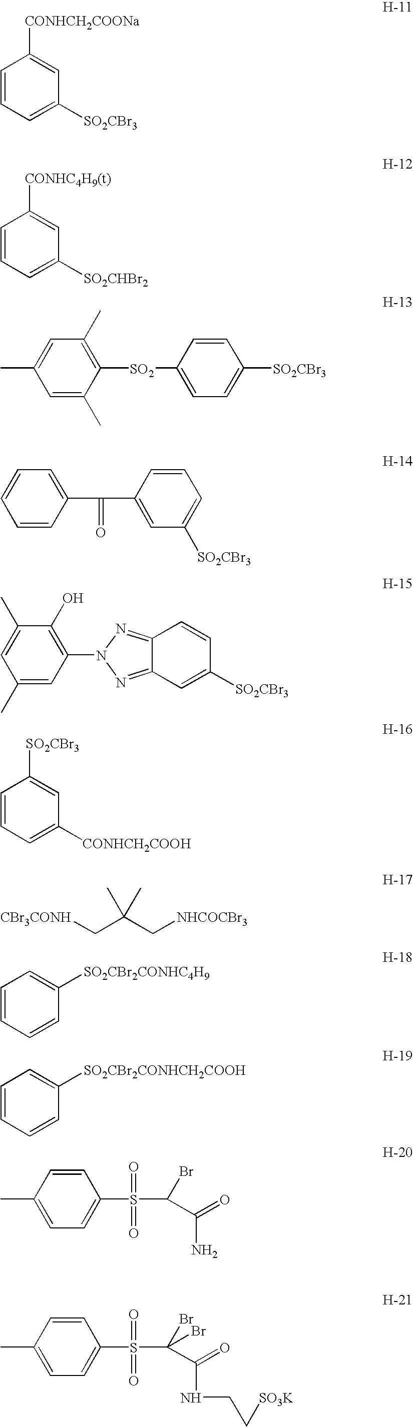

As preferred organic polyhalogen compounds of the invention other than those above, there can be mentioned compounds disclosed in U.S. Pat. Nos. 3,874,946, 4,756,999, 5340712, 5369000, 5464737, and 6506548, JP-A Nos. 50-137126, 50-89020, 50-119624, 59-57234, 7-2781, 7-5621, 9-160164, 9-244177, 9-244178, 9-160167, 9-319022, 9-258367, 9-265150, 9-319022, 10-197988, 10-197989, 11-242304, 2000-2963, 2000-112070, 2000-284410, 2000-284412, 2001-33911, 2001-31644, 2001-312027, and 2003-50441. Particularly, compounds disclosed in JP-A Nos. 7-2781, 2001-33911 and 20001-312027 are preferable.

The compounds expressed by formula (H) of the invention are preferably used in an amount from 10⁻⁴ mol to 1 mol, more preferably, from 10⁻³ mol to 0.5 mol, and even more preferably, from 1×10⁻² mol to 0.2 mol, per 1 mol of non-photosensitive silver salt incorporated in the image forming layer.

In the invention, usable methods for incorporating the antifoggant into the photothermographic material are those described above in the method for incorporating the reducing agent, and also for the organic polyhalogen compound, it is preferably added in the form of a solid fine particle dispersion.

2) Other Antifoggants

As other antifoggants, there can be mentioned a mercury (II) salt described in paragraph number 0113 of JP-A No. 11-65021, benzoic acids described in paragraph number 0114 of the same literature, a salicylic acid derivative described in JP-A No. 2000-206642, a formaline scavenger compound expressed by formula (S) in JP-A No. 2000-221634, a triazine compound related to claim 9 of JP-A No. 11-352624, a compound expressed by formula (III), 4-hydroxy-6-methyl-1,3,3a,7-tetrazaindene and the like, described in JP-A No. 6-11791.

The photothermographic material of the invention may further contain an azolium salt in order to prevent fogging. Azolium salts useful in the present invention include a compound expressed by formula (XI) described in JP-A No. 59-193447, a compound described in Japanese Patent Application Publication (JP-B) No. 55-12581, and a compound expressed by formula (II) in JP-A No. 60-153039. The azolium salt may be added to any part of the photothermographic material, but as an additional layer, it is preferred to select a layer on the side having thereon the image forming layer, and more preferred is to select the image forming layer itself. The azolium salt may be added at any time of the process of preparing the coating solution; in the case where the azolium salt is added into the image forming layer, any time of the process may be selected, from the preparation of the organic silver salt to the preparation of the coating solution, but preferred is to add the salt after preparing the organic silver salt and just before coating. As the method for adding the azolium salt, any method using a powder, a solution, a fine-particle dispersion, and the like, may be used. Furthermore, it may be added as a solution having mixed therein other additives such as sensitizing agents, reducing agents, toners, and the like. In the invention, the azolium salt may be added at any amount, but preferably, it is added in a range from 1×10⁻⁶ mol to 2 mol, and more preferably, from 1×10⁻³ mol to 0.5 mol, per 1 mol of silver.

(Compound of Formula (I) or (II))

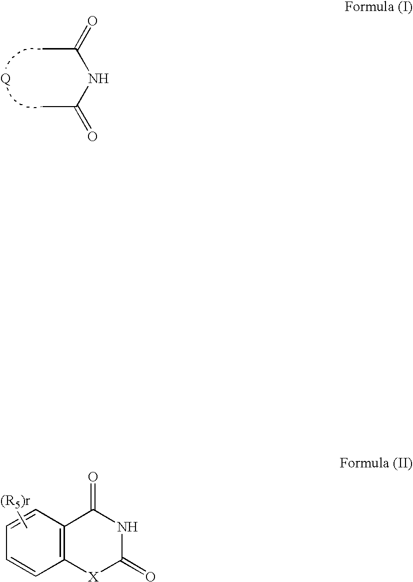

In formula (I), Q represents an atomic group necessary for forming a 5 or 6-membered imide ring. In formula (II), R₅ independently represents one or more hydrogen atoms, an alkyl group, a cycloalkyl group, an alkoxy group, an alkylthio group, an arylthio group, a hydroxy group, a halogen atom, or an N(R₈R₉) group. Two R₅'s may link together to form an aromatic, heteroaromatic, alicyclic, or heterocyclic condensed ring. Herein, R₈ and R₉ each independently represent a hydrogen atom, an alkyl group, an aryl group, a cycloalkyl group, an alkenyl group, or a heterocyclic group, or R₈ and R₉ can link together and represent an atomic group necessary for forming a substituted or unsubstituted 5 to 7-membered heterocycle. X represents O, S, Se or N(R₆) and R₆ represents a hydrogen atom, an alkyl group, an aryl group, a cycloalkyl group, or a heterocyclic group. r represents 0, 1, or 2.

1) Formula (I)

The nitrogen atom and the carbon atom which composes Q may bind with a hydrogen atom, an amino group, an alkyl group having 1 to 4 carbon atoms, a halogen atom, a keto-formed oxygen atom, an aryl group, or the like as a branch. As the specific example of the compound having an imide ring represented by formula (I), uracil, 5-bromouracil, 4-methyluracil, 5-methyluracil, 4-carboxyuracil, 4,5-dimethyluracil, 5-aminouracil, dihydrouracil, 1-ethyl-6-methyluracil, 5-carboxymethylaminouracil, barbituric acid, 5-phenylbarbituric acid, cyanuric acid, urazole, hydantoin, 5,5-dimethylhydantoin, gultarimide, glutaconimide, citrazic acid, succinimide, 3,4-dimethylsuccinimide, maleimide, phthalimide, naphthalimide, and the like are described, but the examples are not limited in these. In the present invention, among the compounds having an imide ring represented by formula (I), succinimide, phthalimide, naphthalimide, and 3,4-dimethylsuccinimide are preferred, and succinimide is particularly preferred.

2) Formula (II)

In formula (II), R₅ independently represents one or more hydrogen atoms, an alkyl group, a cycloalkyl group, an alkoxy group, an alkylthio group, an arylthio group, a hydroxy group, a halogen atom, or an N(R₈R₉) group.

Furthermore, two R₅'s may link together to form an aromatic, heteroaromatic, alicyclic, or heterocyclic condensed ring. In the case where R₅ represents an amino group [(R₈R₉)], R₈ and R₉ each independently represent a hydrogen atom, an alkyl group, an aryl group, a cycloalkyl group, an alkenyl group, or a heterocyclic group.

Furthermore, R₈ and R₉ can link together and represent an atomic group necessary for forming a substituted or unsubstituted 5 to 7-membered heterocycle. In formula (II), X represents O, S, Se, or N(R₆) and R₆ represents a hydrogen atom, an alkyl group, an aryl group, a cycloalkyl group, an alkenyl group, or a heterocyclic group. r represents 0, 1, or 2.

Useful alkyl group as R₅, R₆, R₈, or R₉ is linear, branched, or cyclic one and can have 1 to 20 carbon atoms, and has preferaby 1 to 5 carbon atoms. The alkyl group having 1 to 4 carbon atoms (e.g., methyl, ethyl, iso-propyl, n-butyl, t-butyl, or sec-butyl) is particularly preferable.

Useful aryl group as R₅, R₆, R₈, or R₉ can have 6 to 14 carbon atoms in an aromatic ring (one or plural). Preferred aryl group are a phenyl group and a substituted phenyl group.

Useful cycloalkyl group as R₅, R₆, R₈, or R₉ can have 5 to 14 carbon atoms in a center ring system. Preferred cycloalkyl group are cyclopentyl and cyclohexyl.

Useful alkenyl and alkynyl group can be branched or linear and have 2 to 20 carbon atoms. Preferred alkenyl group is allyl.

Useful heterocyclic group as R₅, R₆, R₈, or R₉ can have 5 to 10 carbon atoms, an oxygen atom, a sulfur atom, or a nitrogen atom in a center ring system and may have a condensed ring.

These alkyl, aryl, cycloalkyl, and heterocyclic groups can be further substituted by one or more groups containing a halo group, an alkoxycarbonyl group, a hydroxyl group, an alkoxy group, a cyano group, an acyl group, an acyloxy group, a carbonyloxyester group, a sufonate ester group, an alkylthio group, a dialkylamino group, a carboxyl group, a sulfo group, a phosphono group, or other group which the art can easily understand, however substituents are not limited in these.

Useful alkoxy group, alkylthio group, or arylthio group as R₅ has the above-mentioned alkyl group or arly group. Preferred halogen atom are chlorine and bromine atom. Representative compounds of formula (II) are the following compound II-1 to II-10. Compound II-1 is most preferable.

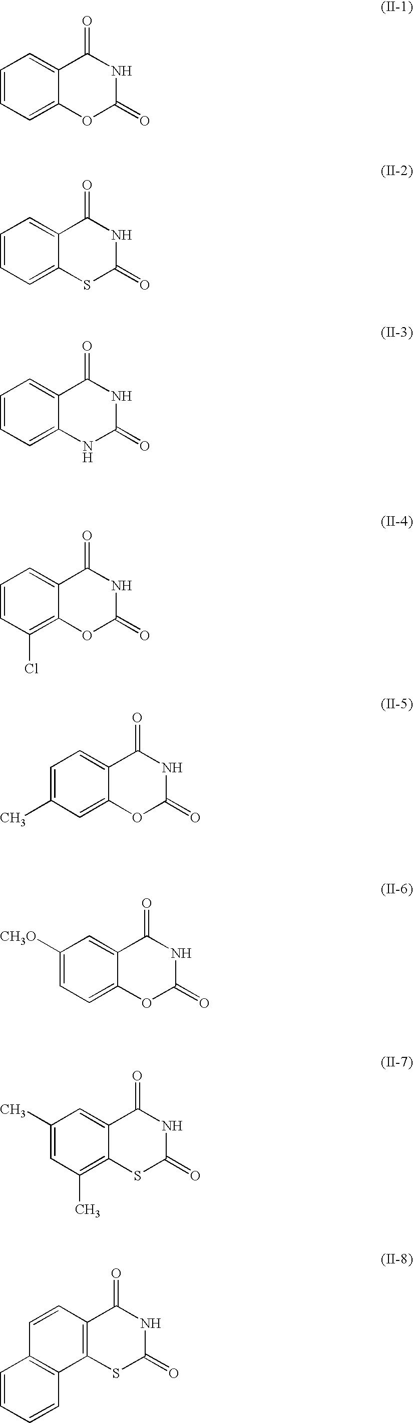

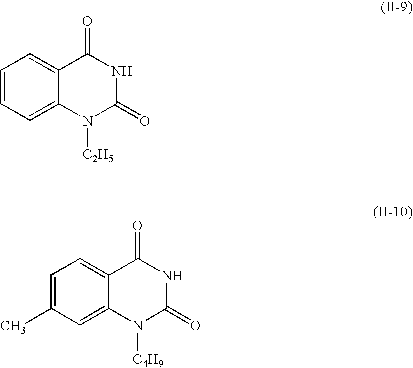

Other useful substituted benzoxazinediones are described in the specification of U.S. Pat. No. 3,951,660. These compounds of formula (I) or (II) are preferred to use as a toner. As a toner used in combination with compound of formula (I) or (II), phthalazinone, a phthalazinone derivative, or a metal salt of the derivative (e.g., 4-(1-naphthyl)phthalazinone, 6-chlorophthalazinone, 5,7-dimethoxyphthalazinone, or 2,3-dihydro-1,4-phthalazinedione); phthalazine or a phthalazine derivative (e.g., 5-isopropylphthalazine) or a phthalic acid derivative (e.g., phthalic acid, 4-methylphthalic acid, 4-nitrophthalic acid, or tetrachlorophthalic acid) may be used as a combination.

(Plasticizer and Lubricant)

In the invention, well-known plasticizer and lubricant can be used to improve physical properties of film. Particularly, to improve handling facility during manufacturing process or scratch resistance during thermal development, it is preferred to use a lubricant such as a liquid paraffin, a long chain fatty acid, an amide of fatty acid, an ester of fatty acid, or the like. Paticularly preferred are a liquid paraffin obtained by removing components having low boiling point and an ester of fatty acid having a branch structure and a molecular weight of 1000 or more.

Concerning the plasticizers and lubricants usable in the image forming layer and in the non-photosensitive layer, compounds described in paragraph No. 0117 of JP-A No. 11-65021 and in JP-A Nos. 2000-5137, 2004-219794, 2004-219802, and 2004-334077 are preferable.

(Dyes and Pigments)

From the viewpoint of improving color tone, of preventing the generation of interference fringes and of preventing irradiation on laser exposure, various types of dyes and pigments (for instance, C.I. Pigment Blue 60, C.I. Pigment Blue 64, and C.I. Pigment Blue 15:6) can be used in combination with the aforementioned phthalocyanine compound in the image forming layer of the invention. Detailed description can be found in WO No. 98/36322, JP-A Nos. 10-268465 and 11-338098, and the like.

(Nucleation Accelerator)

Concerning the photothermographic material of the invention, it is preferred to add a nucleation accelerator into the image forming layer. Details on the nucleation accelerators, method for their addition and addition amount can be found in paragraph No. 0102 of JP-A No. 11-65021, and in paragraph Nos. 0194 and 0195 of JP-A No. 11-223898.

In the case of using a nucleator in the photothermographic material of the invention, it is preferred to use an acid resulting from hydration of diphosphorus pentaoxide, or a salt thereof in combination. Acids resulting from the hydration of diphosphorus pentaoxide or salts thereof include metaphosphoric acid (salt), pyrophosphoric acid (salt), orthophosphoric acid (salt), triphosphoric acid (salt), tetraphosphoric acid (salt), hexametaphosphoric acid (salt), and the like. Particularly preferred acids obtainable by the hydration of diphosphorus pentaoxide or salts thereof include orthophosphoric acid (salt) and hexametaphosphoric acid (salt). Specifically mentioned as the salts are sodium orthophosphate, sodium dihydrogen orthophosphate, sodium hexametaphosphate, ammonium hexametaphosphate, and the like.

The addition amount of the acid obtained by hydration of diphoshorus pentaoxide or the salt thereof (i.e., the coating amount per 1 m² of the photothermographic material) may be set as desired depending on sensitivity and fogging, but preferred is an amount of from 0.1 mg/m² to 500 mg/m², and more preferably, from 0.5 mg/m² to 100 mg/m².

(Preparation of Coating Solution and Coating)

The temperature for preparing the coating solution for the image forming layer of the invention is preferably from 30° C. to 65° C., more preferably, 35° C. or more and less than 60° C., and even more preferably, from 35° C. to 55° C. Furthermore, the temperature of the coating solution for the image forming layer immediately after adding the polymer latex is preferably maintained in the temperature range from 30° C. to 65° C.

(Layer Constitution and Other Constituting Components)

The photothermographic material of the invention has one or more image forming layers constructed on a support. In the case of constituting the image forming layer from one layer, the image forming layer comprises an organic silver salt, a photosensitive silver halide, a reducing agent, and a binder, and may further comprise additional materials as desired and necessary, such as an antifoggant, a toner, a film-forming promoting agent, and other auxiliary agents. In the case of constituting the image forming layer from two or more layers, the first image forming layer (in general, a layer placed nearer to the support) contains an organic silver salt and a photosensitive silver halide. Some of the other components are incorporated in the second image forming layer or in both of the layers. The constitution of a multicolor photothermographic material may include combinations of two layers for those for each of the colors, or may contain all the components in a single layer as described in U.S. Pat. No. 4,708,928. In the case of multicolor photothermographic material, each of the image forming layers is maintained distinguished from each other by incorporating functional or non-functional barrier layer between each of the image forming layers as described in U.S. Pat. No. 4,460,681.

The photothermographic material according to the invention has a non-photosensitive layer in addition to the image forming layer. The non-photosensitive layers can be classified depending on the layer arrangement into (a) a surface protective layer provided on the image forming layer (on the side farther from the support), (b) an intermediate layer provided among plural image forming layers or between the image forming layer and the protective layer, (c) an undercoat layer provided between the image forming layer and the support, and (d) a back layer which is provided on the side opposite from the image forming layer.

Furthermore, a layer that functions as an optical filter may be provided as (a) or (b) above. An antihalation layer may be provided as (c) or (d) to the photothermographic material.

1) Surface Protective Layer

The photothermographic material of the invention may further comprise a surface protective layer with an object to prevent adhesion of the image forming layer. The surface protective layer may be a single layer, or plural layers.

Description on the surface protective layer may be found in paragraph Nos. 0119 to 0120 of JP-A No. 11-65021 and in JP-A No. 2000-171936.

Preferred as the binder of the surface protective layer of the invention is gelatin, but poly(vinyl alcohol) (PVA) may be used preferably instead, or in combination. As gelatin, there can be used an inert gelatin (e.g., Nitta gelatin 750), a phthalated gelatin (e.g., Nitta gelatin 801), and the like. Usable as PVA are those described in paragraph Nos. 0009 to 0020 of JP-A No. 2000-171936, and preferred are the completely saponified product PVA-105, the partially saponified PVA-205, and PVA-335, as well as modified poly(vinyl alcohol) MP-203 (all trade name of products from Kuraray Ltd.). The amount of coated poly(vinyl alcohol) (per 1 m² of support) in the surface protective layer (per one layer) is preferably in a range from 0.3 g/m² to 4.0 g/m², and more preferably, from 0.3 g/m² to 2.0 g/m².

The total amount of the coated binder (including water-soluble polymer and latex polymer) (per 1 m² of support) in the surface protective layer (per one layer) is preferably in a range from 0.3 g/m² to 5.0 g/m², and more preferably, from 0.3 g/m² to 2.0 g/m².

Further, it is preferred to use a lubricant such as a liquid paraffin and an ester of fatty acid in the surface protective layer. The addition amount of the lubricant is in a range of from 1 mg/m² to 200 mg/m², preferably 10 mg/m² to 150 mg/m² and, more preferably 20 mg/m² to 100 mg/m².

2) Antihalation Layer

The photothermographic material of the present invention can comprise an antihalation layer provided to the side farther from the light source with respect to the image forming layer.

Descriptions on the antihalation layer can be found in paragraph Nos. 0123 to 0124 of JP-A No. 11-65021, in JP-A Nos. 11-223898, 9-230531, 10-36695, 10-104779, 11-231457, 11-352625, 11-352626, and the like.

The antihalation layer contains an antihalation dye having its absorption at the wavelength of the exposure light. In the case where the exposure wavelength is in the infrared region, an infrared-absorbing dye may be used, and in such a case, preferred are dyes having no absorption in the visible region.

In the case of preventing halation from occurring by using a dye having absorption in the visible region, it is preferred that the color of the dye would not substantially reside after image formation, and is preferred to employ a means for bleaching color by the heat of thermal development; in particular, it is preferred to add a thermal bleaching dye and a base precursor to the non-photosensitive layer to impart function as an antihalation layer. Those techniques are described in JP-A No. 11-231457 and the like.

The addition amount of the thermal bleaching dye is determined depending on the usage of the dye. In general, it is used at an amount as such that the optical density (absorbance) exceeds 0.1 when measured at the desired wavelength. The optical density is preferably in a range of from 0.15 to 2, and more preferably from 0.2 to 1. The addition amount of dyes to obtain optical density in the above range is generally from 0.001 g/m² to 1 g/m².

By decoloring the dye in such a manner, the optical density after thermal development can be lowered to 0.1 or lower. Two or more types of thermal bleaching dyes may be used in combination in a photothermographic material. Similarly, two or more types of base precursors may be used in combination.

In the case of thermal decolorization by the combined use of a decoloring dye and a base precursor, it is advantageous from the viewpoint of thermal decoloring efficiency to further use a substance capable of lowering the melting point by at least 3° C. when mixed with the base precursor (e.g., diphenylsulfone, 4-chlorophenyl(phenyl)sulfone, 2-naphthylbenzoate, or the like) as disclosed in JP-A No. 11-352626.

3) Back Layer

Back layers usable in the invention are described in paragraph Nos. 0128 to 0130 of JP-A No. 11-65021.

In the invention, coloring matters having maximum absorption in the wavelength range from 300 nm to 450 nm can be added in order to improve color tone of developed silver images and a deterioration of the images during aging. Such coloring matters are described in, for example, JP-A Nos. 62-210458, 63-104046, 63-103235, 63-208846, 63-306436, 63-314535, 01-61745, 2001-100363, and the like.

Such coloring matters are generally added in a range of from 0.1 mg/m² to 1 g/m², preferably to the back layer which is provided on the side opposite from the image forming layer.

Further, in order to control the basic color tone, it is preferred to use a dye having an absorption peak in a wavelength range from 580 nm to 680 nm. As a dye satisfying this purpose, preferred are oil-soluble azomethine dyes described in JP-A Nos. 4-359967 and 4-359968, or water-soluble phthalocyanine dyes described in JP-A No. 2003-295388, which have low absorption intensity on the short wavelength side. The dyes for this purpose may be added to any of the layers, but more preferred is to add them in the non-photosensitive layer on the image forming layer side, or in the back layer side.

The photothermographic material of the invention is preferably a so-called single-sided photosensitive material, which comprises at least one layer of a image forming layer containing silver halide emulsion on one side of the support, and a back layer on the other side. Further, the photothermographic material of the invention is preferably not used in the form of a roll, but in the form of a cut sheet.

4) Matting Agent

A matting agent is preferably added to the photothermographic material of the invention in order to improve transportability. Description on the matting agent can be found in paragraphs Nos. 0126 to 0127 of JP-A No. 11-65021. The addition amount of the matting agent is preferably in a range from 1 mg/m² to 400 mg/m², and more preferably, from 5 mg/m² to 300 mg/m², with respect to the coating amount per 1 m² of the photothermographic material.

The shape of the matting agent usable in the invention may fixed form or non-fixed form. Preferred is to use those having fixed form and globular shape.

Volume weighted mean equivalent spherical diameter of the matting agent used in the image forming layer surface is preferably in a range from 0.3 μm to 10 μm, and more preferably, from 0.5 μm to 7 μm. Further, the particle distribution of the matting agent is preferably set as such that the variation coefficient may become from 5% to 80%, and more preferably, from 20% to 80%. The variation coefficient, herein, is defined by (the standard deviation of particle diameter)/(mean diameter of the particle)×100. Furthermore, two or more kinds of matting agents having different mean particle size can be used in the image forming layer surface. In this case, it is preferred that the difference between the mean particle size of the biggest matting agent and the mean particle size of the smallest matting agent is from 2 μm to 8 μm, and more preferred, from 2 μm to 6 μm.

Volume weighted mean equivalent spherical diameter of the matting agent used in the back surface is preferably in a range from 1 μm to 15 μm, and more preferably, from 3 μm to 10 μm. Further, the particle distribution of the matting agent is preferably set as such that the variation coefficient may become from 3% to 50%, and more preferably, from 5% to 30%. Furthermore, two or more kinds of matting agents having different mean particle size can be used in the back surface. In this case, it is preferred that the difference between the mean particle size of the biggest matting agent and the mean particle size of the smallest matting agent is from 2 μm to 14 μm, and more preferred, from 2 μm to 9 μm.

The level of matting on the image forming layer surface is not restricted as far as star-dust trouble occurs, but the level of matting of 30 seconds to 2000 seconds is preferred, particularly preferred, 40 seconds to 1500 seconds as Beck's smoothness. Beck's smoothness can be calculated easily, using Japan Industrial Standared (JIS) P8119 “The method of testing Beck's smoothness for papers and sheets using Beck's test apparatus”, or TAPPI standard method T479.

The level of matting of the back layer in the invention is preferably in a range of 1200 seconds or less and 10 seconds or more; more preferably, 800 seconds or less and 20 seconds or more; and even more preferably, 500 seconds or less and 40 seconds or more when expressed by Beck's smoothness.

In the present invention, a matting agent is preferably contained in an outermost layer, in a layer which can function as an outermost layer, or in a layer nearer to outer surface, and also preferably is contained in a layer which can function as a so-called protective layer.

5) Polymer Latex

A polymer latex is preferably used in the surface protective layer and the back layer of the photothermographic material in the present invention. As such polymer latex, descriptions can be found in “Gosei Jushi Emulsion (Synthetic resin emulsion)” (Taira Okuda and Hiroshi Inagaki, Eds., published by Kobunshi Kankokai (1978)), “Gosei Latex no Oyo (Application of synthetic latex)” (Takaaki Sugimura, Yasuo Kataoka, Soichi Suzuki, and Keiji Kasahara, Eds., published by Kobunshi Kankokai (1993)), and “Gosei Latex no Kagaku (Chemistry of synthetic latex)” (Soichi Muroi, published by Kobunshi Kankokai (1970)). More specifically, there can be mentioned a latex of methyl methacrylate (33.5% by weight)/ethyl acrylate (50% by weight)/methacrylic acid (16.5% by weight) copolymer, a latex of methyl methacrylate (47.5% by weight)/butadiene (47.5% by weight)/itaconic acid (5% by weight) copolymer, a latex of ethyl acrylate/methacrylic acid copolymer, a latex of methyl methacrylate (58.9% by weight)/2-ethylhexyl acrylate (25.4% by weight)/styrene (8.6% by weight)/2-hydroethyl methacrylate (5.1% by weight)/acrylic acid (2.0% by weight) copolymer, a latex of methyl methacrylate (64.0% by weight)/styrene (9.0% by weight)/butyl acrylate (20.0% by weight)/2-hydroxyethyl methacrylate (5.0% by weight)/acrylic acid (2.0% by weight) copolymer, and the like. Furthermore, as the binder for the surface protective layer, there can be applied the technology described in paragraph Nos. 0021 to 0025 of the specification of JP-A No. 2000-267226, and the technology described in paragraph Nos. 0023 to 0041 of the specification of JP-A No. 2000-19678. The polymer latex in the surface protective layer is preferably contained in an amount of from 10% by weight to 90% by weight, particularly preferably, from 20% by weight to 80% by weight of the total weight of binder.

6) Surface pH

The surface pH of the photothermographic material according to the invention preferably yields a pH of 7.0 or lower, and more preferably, 6.6 or lower, before thermal developing process. Although there is no particular restriction concerning the lower limit, the lower limit of pH value is about 3. The most preferred surface pH range is from 4 to 6.2. From the viewpoint of reducing the surface pH, it is preferred to use an organic acid such as phthalic acid derivative or a non-volatile acid such as sulfuric acid, or a volatile base such as ammonia for the adjustment of the surface pH. In particular, ammonia can be used favorably for the achievement of low surface pH, because it can easily vaporize to remove it before the coating step or before applying thermal development.

It is also preferred to use a non-volatile base such as sodium hydroxide, potassium hydroxide, lithium hydroxide, and the like, in combination with ammonia. The method of measuring surface pH value is described in paragraph No. 0123 of the specification of JP-A No. 2000-284399.

7) Hardener

A hardener may be used in each of image forming layer, protective layer, back layer, and the like of the invention. As examples of the hardener, descriptions of various methods can be found in pages 77 to 87 of T. H. James, “THE THEORY OF THE PHOTOGRAPHIC PROCESS, FOURTH EDITION” (Macmillan Publishing Co., Inc., 1977). Preferably used are, in addition to chromium alum, sodium salt of 2,4-dichloro-6-hydroxy-s-triazine, N,N-ethylene bis(vinylsulfonacetamide), and N,N-propylene bis(vinylsulfonacetamide), polyvalent metal ions described in page 78 of the above literature and the like, polyisocyanates described in U.S. Pat. No. 4,281,060, JP-A No. 6-208193, and the like, epoxy compounds of U.S. Pat. No. 4,791,042 and the like, and vinyl sulfone compounds of JP-A No. 62-89048.

The hardener is added as a solution, and the solution is added to a coating solution 180 minutes before coating to just before coating, preferably 60 minutes before to 10 seconds before coating. However, as far as the effect of the invention is sufficiently exhibited, there is no particular restriction concerning the mixing method and the conditions of mixing. As specific mixing methods, there can be mentioned a method of mixing in the tank, in which the average stay time calculated from the flow rate of addition and the feed rate to the coater is controlled to yield a desired time, or a method using static mixer as described in Chapter 8 of N. Harnby, M. F. Edwards, A. W. Nienow (translated by Koji Takahashi) “Ekitai Kongo Gijutu (Liquid Mixing Technology)” (Nikkan Kogyo Shinbunsha, 1989), and the like.

8) Surfactant

Concerning the surfactant, the solvent, the support, antistatic agent and the electrically conductive layer, and the method for obtaining color images applicable in the invention, there can be used those disclosed in paragraph numbers 0132, 0133, 0134, 0135, and 0136, respectively, of JP-A No. 11-65021. Concerning lubricants, there can be used those disclosed in paragraph numbers 0061 to 0064 of JP-A No. 11-84573 and in paragraph numbers 0049 to 0062 of JP-A No. 2001-83679.

In the invention, it is preferred to use a fluorocarbon surfacant. Specific examples of fluorocarbon surfacants can be found in those described in JP-A Nos. 10-197985, 2000-19680, and 2000-214554. Polymer fluorocarbon surfacants described in JP-A 9-281636 can be also used preferably. For the photothermographic material in the invention, the fluorocarbon surfacants described in JP-A Nos. 2002-82411, 2003-57780, and 2001-264110 are preferably used. Especially, the usage of the fluorocarbon surfacants described in JP-A Nos. 2003-57780 and 2001-264110 in an aqueous coating solution is preferred viewed from the standpoint of capacity in static control, stability of the coated surface state and sliding facility. The fluorocarbon surfactant described in JP-A No. 2001-264110 is mostly preferred because of high capacity in static control and that it needs small amount to use.

According to the invention, the fluorocarbon surfactant can be used on either side of image forming layer side or back layer side, but is preferred to use on the both sides. Further, it is particularly preferred to use in combination with electrically conductive layer including metal oxides described below. In this case the amount of the fluorocarbon surfactant on the side of the electrically conductive layer can be reduced or removed.

The addition amount of the fluorocarbon surfactant is preferably in a range of from 0.1 mg/m² to 100 mg/m² on each side of image forming layer and back layer, more preferably from 0.3 mg/m² to 30 mg/m², and even more preferably from 1 mg/m² to 10 mg/m². Especially, the fluorocarbon surfactant described in JP-A No. 2001-264110 is effective, and used preferably in a range of from 0.01 mg/m² to 10 mg/m², and more preferably from 0.1 mg/m² to 5 mg/m².

9) Antistatic Agent

The photothermographic material of the invention preferably contains an electrically conductive layer including metal oxides or electrically conductive polymers. The antistatic layer may serve as an undercoat layer, or a back surface protective layer, and the like, but can also be placed specially. As an electrically conductive material of the antistatic layer, metal oxides having enhanced electric conductivity by the method of introducing oxygen defects or different types of metallic atoms into the metal oxides are preferable for use. Examples of metal oxides are preferably selected from ZnO, TiO₂, or SnO₂. As the combination of different types of atoms, preferred are ZnO combined with Al, or In; SnO₂ with Sb, Nb, P, halogen atoms, or the like; TiO₂ with Nb, Ta, or the like. Particularly preferred for use is SnO₂ combined with Sb. The addition amount of different types of atoms is preferably in a range of from 0.01 mol % to 30 mol %, and more preferably, in a range of from 0.1 mol % to 10 mol %. The shape of the metal oxides can include, for example, spherical, needle-like, or tabular. The needle-like particles, with the rate of (the major axis)/(the minor axis) is 2.0 or more, and more preferably in a range of from 3.0 to 50, is preferred viewed from the standpoint of the electric conductivity effect. The metal oxides is preferably used in a range of from 1 mg/m² to 1000 mg/m², more preferably from 10 mg/m² to 500 mg/m², and even more preferably from 20 mg/m² to 200 mg/m². The antistatic layer can be disposed on either side of the image forming layer side or the back layer side, it is preferred to set between the support and the back layer. Specific examples of the antistatic layer in the invention include described in paragraph Nos. 0135 of JP-A No. 11-65021, in JP-A Nos. 56-143430, 56-143431, 58-62646, and 56-120519, and in paragraph Nos. 0040 to 0051 of JP-A No. 11-84573, in U.S. Pat. No. 5,575,957, and in paragraph Nos. 0078 to 0084 of JP-A No. 11-223898.

10) Support

As the transparent support, preferably used is polyester, particularly, polyethylene terephthalate, which is subjected to heat treatment in the temperature range of from 130° C. to 185° C. in order to relax the internal strain caused by biaxial stretching and remaining inside the film, and to remove strain ascribed to heat shrinkage generated during thermal development. In the case of a photothermographic material for medical use, the transparent support may be colored with a blue dye (for instance, dye-1 described in the Example of JP-A No. 8-240877), or may be uncolored. As to the support, it is preferred to apply undercoating technology, such as water-soluble polyester described in JP-A No. 11-84574, a styrene-butadiene copolymer described in JP-A No. 10-186565, a vinylidene chloride copolymer described in JP-A No. 2000-39684, and the like. The moisture content of the support is preferably 0.5% by weight or lower when coating for image forming layer and back layer is conducted on the support.

11) Other Additives

Furthermore, an antioxidant, stabilizing agent, plasticizer, UV absorbent, or film-forming promoting agent may be added to the photothermographic material. Each of the additives is added to either of the image forming layer or the non-photosensitive layer. Reference can be made to WO No. 98/36322, EP No. 803764A1, JP-A Nos. 10-186567 and 10-18568, and the like.

12) Coating Method

The photothermographic material of the invention may be coated by any method. Specifically, various types of coating operations including extrusion coating, slide coating, curtain coating, immersion coating, knife coating, flow coating, or an extrusion coating using the type of hopper described in U.S. Pat. No. 2,681,294 are used. Preferably used is extrusion coating or slide coating described in pages 399 to 536 of Stephen F. Kistler and Petert M. Shweizer, “LIQUID FILM COATING” (Chapman & Hall, 1997), and particularly preferably used is slide coating. Example of the shape of the slide coater for use in slide coating is shown in FIG. 11b.1, page 427, of the same literature. If desired, two or more layers can be coated simultaneously by the method described in pages 399 to 536 of the same literature, or by the method described in U.S. Pat. No. 2,761,791 and British Patent No. 837,095. Particularly preferred in the invention is the method described in JP-A Nos. 2001-194748, 2002-153808, 2002-153803, and 2002-182333.

The coating solution for the image forming layer in the invention is preferably a so-called thixotropic fluid. For the details of this technology, reference can be made to JP-A No. 11-52509. Viscosity of the coating solution for the image forming layer in the invention at a shear velocity of 0.1S⁻¹ is preferably from 400 mPa·s to 100,000 mPa·s, and more preferably, from 500 mPa·s to 20,000 mPa·s. At a shear velocity of 1000S⁻¹, the viscosity is preferably from 1 mPa·s to 200 mPa·s, and more preferably, from 5 mPa·s to 80 mPa·s.

In the case of mixing two types of liquids on preparing the coating solution of the invention, known in-line mixer and in-plant mixer can be used favorably. Preferred in-line mixer of the invention is described in JP-A No. 2002-85948, and the in-plant mixer is described in JP-A No. 2002-90940.

The coating solution of the invention is preferably subjected to defoaming treatment to maintain the coated surface in a fine state. Preferred defoaming treatment method in the invention is described in JP-A No. 2002-66431.

When applying the coating solution of the invention to the support, it is preferred to perform diselectrification in order to prevent the adhesion of dust, particulates, and the like due to charge up. Preferred example of the method of diselectrification for use in the invention is described in JP-A No. 2002-143747.

Since a non-setting coating solution is used for the image forming layer in the invention, it is important to precisely control the drying wind and the drying temperature. Preferred drying method for use in the invention is described in detail in JP-A Nos. 2001-194749 and 2002-139814.

In order to improve the film-forming properties in the photothermographic material of the invention, it is preferred to apply a heat treatment immediately after coating and drying. The temperature of the heat treatment is preferably in a range of from 60° C. to 100° C. at the film surface, and time period for heating is preferably in a range of from 1 second to 60 seconds. More preferably, heating is performed in a temperature range of from 70° C. to 90° C. at the film surface, and the time period for heating is from 2 seconds to 10 seconds. A preferred method of heat treatment for the invention is described in JP-A No. 2002-107872.

Furthermore, the producing methods described in JP-A Nos. 2002-156728 and 2002-182333 are favorably used in the invention in order to stably and successively produce the photothermographic material of the invention.

The photothermographic material is preferably of mono-sheet type (i.e., a type which can form image on the photothermographic material without using other sheets such as an image-receiving material).

13) Wrapping Material

In order to suppress fluctuation from occurring on the photographic property during a preservation of the photothermographic material of the invention before thermal development, or in order to improve curling or winding tendencies when the photothermographic material is manufactured in a roll state, it is preferred that a wrapping material having low oxygen transmittance and/or vapor transmittance is used. Preferably, oxygen transmittance is 50 mL·atm⁻² day⁻¹ or lower at 25° C., more preferably, 10 mL·atm⁻¹ m⁻² day⁻¹ or lower, and even more preferably, 1.0 mL·atm⁻¹ m⁻² day⁻¹ or lower. Preferably, vapor transmittance is 10 g·atm⁻¹ m⁻² day⁻¹ or lower, more preferably, 5 g·atm⁻¹ m⁻² day⁻¹ or lower, and even more preferably, 1 g·atm⁻¹ m⁻² day⁻¹ or lower.

As specific examples of a wrapping material having low oxygen transmittance and/or vapor transmittance, reference can be made to, for instance, the wrapping material described in JP-A Nos. 8-254793 and 2000-206653.

14) Other Applicable Techniques

Techniques which can be used for the photothermographic material of the invention also include those in EP No. 803764A1, EP No. 883022A1, WO No. 98/36322, JP-A Nos. 56-62648, and 58-62644, JP-A Nos. 09-43766, 09-281637, 09-297367, 09-304869, 09-311405, 09-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2001-200414, 2001-234635, 2002-020699, 2001-275471, 2001-275461, 2000-313204, 2001-292844, 2000-324888, 2001-293864, 2001-348546, and 2000-187298.

2. Image Forming Method

2-1. Exposure

The photothermographic material of the present invention may be either “single-sided type” having an image forming layer on one side of the support, or “double-sided type” having image forming layers on both sides of the support.

(Double-Sided Type Photothermographic Material)

The photothermographic material of the present invention is preferably applied for an image forming method to record X-ray images using a fluorescent intensifying screen.

The image forming method using the photothermographic materials described above comprises:

(a) providing an assembly for forming an image by placing the photothermographic material between a pair of the X-ray intensifying screens,

(b) putting an analyte between the assembly and the X-ray source,

(c) applying X-rays having an energy level in a range of 25 kVp to 125 kVp to the analyte;

(d) taking the photothermographic material out of the assembly; and

(e) heating the removed photothermographic material in a temperature range of 90° C. to 180° C.

The photothermographic material used for the assembly in the present invention is subjected to X-ray exposure through a step wedge tablet and thermal development. On the photographic characteristic curve having an optical density (D) and an exposure value (log E) along the rectangular coordinates having the equal axis-of-coordinate unit, it is preferred to adjust so that the thermal developed image may have the photographic characteristic curve where the average gamma (γ) made at the points of a density of fog+0.1 and a density of fog+0.5 is from 0.5 to 0.9, and the average gamma (γ) made at the points of a density of fog+1.2 and a density of fog+1.6 is from 3.2 to 4.0. For the X-ray radiography employed in the practice of the present invention, the use of photothermographic material having the aforesaid photographic characteristic curve would give the radiation images with excellent photographic properties that exhibit an extended bottom portion and high gamma value at a middle density area. According to this photographic property, the photographic properties mentioned have the advantage of that the depiction in a low density portion on the mediastinal region and the heart shadow region having little X-ray transmittance becomes excellent, and that the density becomes easy to view, and that gradation in the images on the lung field region having much X-ray transmittance becomes excellent.

The photothermographic material having a preferred photographic characteristic curve mentioned above can be easily prepared, for example, by the method where each of the image forming layer of both sides may be constituted of two or more image forming layers containing silver halide and having a sensitivity different from each other. Especially, the aforesaid image forming layer preferably comprises an emulsion of high sensitivity for the upper layer and an emulsion with photographic properties of low sensitivity and high gradation for the lower layer. In the case of preparing the image forming layer comprising two layers, the sensitivity difference between the silver halide emulsion in each layer is preferably from 1.5 times to 20 times, and more preferably from 2 times to 15 times. The ratio of the amounts of emulsion used for forming each layer depends on the sensitivity difference between emulsions used and the covering power. Generally, as the sensitivity difference is large, the ratio of the using amount of high sensitivity emulsion is reduced. For example, if the sensitivity difference is two times, and the covering power is equal, the ratio of the amount of high sensitivity emulsion to low sensitivity emulsion would be preferably adjusted to be in a range of from 1:20 to 1:50 based on a silver amount.

As the techniques for crossover cutting (in the case of double-sided photosensitive material) and anti-halation (in the case of single-sided photosensitive material), dyes or combined use of dye and mordant described in JP-A. No. 2-68539, (from page 13, left lower column, line 1 to page 14, left lower column, line 9) can be employed.

Next, the fluorescent intensifying screen of the present invention is explained below. The fluorescent intensifying screen essentially comprises a support and a fluorescent substance layer coated on one side of the support as the fundamental structure. The fluorescent substance layer is a layer where the fluorescent substance is dispersed in binders. On the surface of a fluorescent substance layer opposite to the support side (the surface of the side that does not face on the support), a transparent protective layer is generally disposed to protect the fluorescent substance layer from chemical degradation and physical shock.

Preferred fluorescent substances according to the present invention are described below. Tungstate fluorescent substances (CaWO₄, MgWO₄, CaWO₄:Pb, and the like), terbium activated rare earth sulfoxide fluorescent substances (Y₂O₂S:Tb, Gd₂O₂S:Tb, La₂O₂S:Tb, (Y, Gd)₂O₂S:Tb, (Y, Gd)O₂S:Tb, Tm, and the like), terbium activated rare earth phosphate fluorescent substances (YPO₄:Tb, GdPO₄:Tb, LaPO₄:Tb, and the like), terbium activated rare earth oxyhalogen fluorescent substances (LaOBr:Tb, LaOBr:Tb, Tm, LaOCl:Tb, LaOCl:Tb, Tm, LaOBr:Tb, GdOBr:Tb, GdOCl:Tb, and the like), thulium activated rare earth oxyhalogen fluorescent substances (LaOBr:Tm, LaOCl:Tm, and the like), barium sulfate fluorescent substances (BaSO₄:Pb, BaSO₄:Eu²⁺, (Ba, Sr)SO₄:Eu²⁺, and the like), divalent europium activated alkali earth metal phosphate fluorescent substances ((Ba₂PO₄)₂:Eu²⁺, (Ba_{2 PO}₄)₂:Eu²⁺, and the like), divalent europium activated alkali earth metal fluorinated halogenide fluorescent substances (BaFCl:Eu²⁺, BaFBr:Eu²⁺, BaFCl:Eu²⁺, Tb, BaFBr:Eu²⁺, Tb, BaF₂.BaCl.KCl:Eu²⁺, (Ba, Mg)F₂.BaCl.KCl:Eu²⁺, and the like), iodide fluorescent substances (Csl:Na, Csl:Tl, NaI, KI:Tl, and the like), sulfide fluorescent substances (ZnS:Ag(Zn, Cd)S:Ag, (Zn, Cd)S:Cu, (Zn, Cd)S:Cu, Al, and the like), hafnium phosphate fluorescent substances (HfP₂O₇:Cu and the like), YTaO₄ and a substance in which various activator is added as an emission center to YTaO₄. However, the fluorescent substance used in the present invention is not particularly limited to these specific examples, as far as the fluorescent substance emits light in visible or near ultraviolet region by exposure to a radioactive ray.

The fluorescent intensifying screen which is more preferred for the present invention is a screen where 50% or more of the emission light has a wavelength region from 350 nm to 420 nm. Especially, as the fluorescent substance, a divalent europium activated fluorescent substance is preferred, and a divalent europium activated barium halide fluorescent substance is more preferred. The emission wavelength region is preferably from 360 nm to 420 nm, and more preferably from 370 nm to 420 nm. Moreover, the preferred fluorescent screen can emit 70% or more of the above region, and more preferably 85% or more thereof.

The ratio of the emission light can be calculated from the following method; the emission spectrum is measured where an antilogarithm of the emission wavelength is plotted on the abscissa axis at equal interval and a number of the emitted photon is plotted on the ordinate. The ratio of the emission light in the wavelength region from 350 nm to 420 nm is defined as a value dividing the area from 350 nm to 420 nm on the chart by the entire area of the emission spectrum. The photothermographic materials of the present invention used in combination with the fluorescent substance emitting the above wavelength region can attain high sensitivity.

In order that most of the emission light of the fluorescent substance may exist in the above wavelength region, the narrower half band width is preferred. The preferred half band width is from 1 nm to 70 nm, more preferably from 5 nm to 50 nm, and still more preferably from 10 nm to 40 nm.

The fluorescent substance used in the present invention is not particularly limited as far as the fluorescent substance has the above emission, but the europium activated fluorescent substance where the divalent europium is an emission center is preferred to attain high sensitivity as the purpose of the invention.

Specific examples of these fluorescent substances are described below, but the scope of the present invention is not limited to the examples.

BaFCl:Eu, BaFBr:Eu, BaFI:Eu, and the fluorescent substances where their halogen composition is changed; BaSO₄:Eu, SrFBr:Eu, SrFCl:Eu, SrFI:Eu, (Sr, Ba)Al₂Si₂O₈:Eu, SrB₄O₇F:Eu, SrMgP₂O₇:Eu, Sr₃(PO₄)₂:Eu, Sr₂P₂O₇:Eu, and the like.

More preferred fluorescent substance is a divalent europium activated barium halide fluorescent substance expressed by the following formula:
MX₁X₂:Eu
wherein, M represents Ba as a main component, but a small amount of Mg, Ca, Sr, or other compounds may be included. X₁ and X₂ each represent a halogen atom, and can be selected from F, Cl, Br and I. Herein, X₁ is more preferably a fluorine atom. X₂ can be selected from Cl, Br, and I, and the mixture with other halogen composition may be used preferably. More preferably X=Br. Eu represents an europium atom. Eu as an emission center is preferably contained at a ratio from 10⁻⁷ to 0.1, based on Ba, more preferably from 10−4 to 0.05. Preferably the mixture with a small quantity of other compounds can be included. As most preferred fluorescent substance, BaFCl:Eu, BaFBr:Eu and BaFBr_{1-X}I_{X}:Eu can be described.

The fluorescent intensifying screen preferably consists of a support, an undercoat layer on the support, a fluorescent substance layer, and a surface protective layer.

The fluorescent substance layer is prepared as follows. A dispersion solution is prepared by dispersing the fluorescent substance particles described above in an organic solvent solution containing binder resins. The thus-prepared solution is coated directly on the support (or on the undercoat layer such as a light reflective layer provided beforehand on the support) and dried to form the fluorescent substance layer. Besides the above method, the fluorescent substance layer may be formed by the steps of coating the above dispersion solution on the temporary support, drying the coated dispersion to form a fluorescent substance layer sheet, peeling off the sheet from the temporary support, and fixing the sheet onto a permanent support by means of an adhesive agent.

The particle size of the fluorescent substance particles used in the present invention is not particularly restricted, but is usually in a range of from about 1 μm to 15 μm, and preferably from about 2 μm to 10 μm. The higher volume filling factor of the fluorescent substance particles in the fluorescent substance layer is preferred, usually in the range of from 60% to 85%, preferably from 65% to 80%, and particularly preferably from 68% to 75%. (The ratio of the fluorescent substance particles in the fluorescent substance layer is usually 80% by weight or more, preferably 90% by weight or more, and particularly preferably 95% by weight or more). Various kinds of known documents have described the binder resins, organic solvents, and the various additives used for forming the fluorescent substance layer. The thickness of the fluorescent substance layer may be set arbitrary according to the target sensitivity, but is preferably in a range of from 70 μm to 150 μm for the front side screen, and in a range of from 80 μm to 400 μm for the backside screen. The X-ray absorption efficiency of the fluorescent substance layer depends on the coating amount of the fluorescent substance particles in the fluorescent substance layer.

The fluorescent substance layer may consist of one layer, or may consist of two or more layers. It preferably consists of one to three layers, and more preferably, one or two layers. For example, the layer may be prepared by coating a plurality of layers comprising the fluorescent substance particles with different particle size having a comparatively narrow particle size distribution. In that case, the particle size of the fluorescent substance particles contained in each layer may gradually decrease from the top layer to the bottom layer provided next to the support. Especially, the fluorescent substance particles having a large particle size is preferably coated at the side of the surface protective layer and fluorescent substance particles having a small particle size is preferably coated at the side of the support. Hereto, the small particle size of fluorescent substance is preferably in a range from 0.5 μm to 2.0 μm and the large size is preferably in a range from 10 μm to 30 μm. The fluorescent substance layer may be formed by mixing the fluorescent substance particles with different particle sizes, or the fluorescent substances may be packed in a particle size graded structure as described in JP-A No. 55-33560 (page 3, line 3 on the left column to page 4, line 39 on the left column). Usually, a variation coefficient of a particle size distribution of the fluorescent substance is in a range of from 30% to 50%, but a monodispersed fluorescent substance particles with a variation coefficient of 30% or less can also be preferably used.

Attempts to attain a desired sharpness by dying the fluorescent substance layer with respect to the emission light wavelength are practiced. However, the layer with least dying is preferably required. The absorption length of the fluorescent substance layer is preferably 100 μm or more, and more preferably 1000 μm or more.

The scattering length of the fluorescent substance layer is preferably designed to be from 0.1 μm to 100 μm, and more preferably from 1 μm to 100 μm. The scattering length and the absorption length can be calculated from the equation based on the theory of Kubelka-Munk mentioned below.

Concerning the support, any support can be selected from various kinds of supports used in the well-known radiographic intensifying screen depending on the purpose. For example, a polymer film containing white pigments such as titanium dioxide or the like, and a polymer film containing black pigments such as carbon black or the like may be preferably used. An undercoat layer such as a light reflective layer containing a light reflective agent may be preferably coated on the surface of the support (the surface of the fluorescent substance layer side). The light reflective layer as described in JP-A No. 2001-124898 may be preferably used. Especially, the light reflective layer containing yttrium oxide described in Example 1 of the above patent or the light reflective layer described in Example 4 thereof is preferred. As for the preferred light reflective layer, the description in JP-A No. 23001-124898 (paragraph 3, 15 line on the right side to paragraph 4, line 23 on the right side) can be referred.

A surface protective layer is preferably coated on the surface of the fluorescent substance layer. The light scattering length measured at the main emission wavelength of the fluorescent substance is preferably in a range of from 5 μm to 80 μm, and more preferably from 10 μm to 70 μm, and particularly preferably from 10 μm to 60 μm. The light scattering length indicates a mean distance in which a light travels straight until it is scattered. Therefore a short scattering length means that the light scattering efficiency is high. On the other hand, the light absorption length, which indicates a mean free distance until a light is absorbed, is optional. From the viewpoint of the screen sensitivity, no absorption by the surface protective layer favors preventing the desensitization. In order to compensate the scattering loss, a very slightly absorption may be allowable. A preferred absorption length is 800 μm or more, and more preferably 1200 μm or more. The light scattering length and the light absorption length can be calculated from the equation based on the theory of Kubelka-Munk using the measured data obtained by the following method.

Three or more film samples comprising the same component composition as the surface protective layer of the aimed sample but a different thickness from each other are prepared, and then the thickness (μm) and the diffuse transmittance (%) of each of the samples is measured. The diffuse transmittance can be measured by means of a conventional spectrophotometer equipped with an integrating sphere. For the measurement of the present invention, an automatic recording spectrophotometer (type U-3210, manufactured by Hitachi Ltd.) equipped with an integrating sphere of 150 φ (150-0901) is used. The measuring wavelength must correspond to the wavelength of the main emission peak of the fluorescent substance in the fluorescent substance layer having the surface protective layer. Thereafter, the film thickness (μm) and the diffuse transmittance (%) obtained in the above measurement is introduced to the following equation (A) derived from the theoretical equation of Kubelka-Munk. For example, the equation (A) can be derived easily, under the boundary condition of the diffuse transmittance (%), from the equations 5·1·12 to 5·1·15 on page 403 described in “Keikotai Hando Bukku” (the Handbook of Fluorescent Substance) (edited by Keikotai Gakkai, published by Ohmsha Ltd. 1987).
T/100=4β/[(1+β)²·exp(αd)−(1−β)²·exp(−αd)] Equation (A)

wherein, T represents a diffuse transmittance (%), d represents a film thickness (μm) and, α and β are defined by the following equation respectively.
α=[K·(K+2S)]^{1/2}
β=[K/(K+2S)]^{1/2}

T (diffuse transmittance: %) and d (film thickness: μm) measured from three or more film samples are introduced respectively to the equation (A), and thereby the value of K and S are determined to satisfy the equation (A). The scattering length (μm) and the absorption length (μm) are defined by 1/S and 1/K respectively.

The surface protective layer may preferably comprise light scattering particles dispersed in a resin material. The light refractive index of the light scattering particles is usually 1.6 or more, and more preferably 1.9 or more. The particle size of the light scattering particles is in a range of from 0.1 μm to 1.0 μm. Examples of the light scattering particles can include the fine particles of aluminum oxide, magnesium oxide, zinc oxide, zinc sulfide, titanium oxide, niobium oxide, barium sulfate, lead carbonate, silicon oxide, polymethyl methacrylate, styrene, and melamine.

The resin materials used to form the surface protective layer are not particularly limited, but poly(ethylene terephthalate), poly(ethylene naphthalate), polyamide, aramid, fluororesin, polyesters, or the like are preferably used. The surface protective layer can be formed by the step of dispersing the light scattering particles set forth above in an organic solvent solution containing the resin material (binder resin) to prepare a dispersion solution, coating the dispersion solution on the fluorescent substance layer directly (or via an optionally provided auxiliary layer), and then drying the coated solution. By other way, the surface protective sheets prepared separately can be overlaid on the fluorescent substance layer by means of an adhesive agent. The thickness of the surface protective layer is usually in a range of from 2 μm to 12 μm, and preferably from 3.5 μm to 10 μm.

In addition, in respect with the preferred producting methods and the materials used for the process of the radiographic intensifying screen, references can be made to various publications, for example, JP-A No. 9-21899 (page 6, line 47 on left column to page 8, line 5 on left column), JP-A No. 6-347598 (page 2, line 17 on right column to page 3, line 33 on left column) and (page 3, line 42 on left column to page 4, line 22 on left column).

In the fluorescent intensifying sheets used for the present invention, the fluorescent substance is preferably packed in a particle size graded structure. Especially, the fluorescent substance particles having a large particle size are preferably coated at the side of the surface protective layer and fluorescent substance particles having a small particle size are preferably coated at the side of the support. The small particle size of fluorescent substance is preferably in a range of from 0.5 μm to 2.0 μm, and the large size is preferably in a range of from 10 μm to 30 μm.

(Single-Sided Type Photothermographic Material)

The single-sided type photothermographic material of the present invention is preferably applied for an X-ray photosensitive material used for mammography.

To use the single-sided type photothermographic material for that purpose, it is very important to design the gradation of the obtained image in a suitable range.

Concerning the preferable constitution for a photosensitive material used for mammography, reference can be made to JP-A Nos. 5-45807, 10-62881, 10-54900, 11-109564.

(Combined Use with Ultraviolet Fluorescent Intensifying Screen)

Concerning the image forming method using photothermographic material according to the present invention, it is preferred that the image forming method is perfomed in combination with a fluorescent substance having a main emission peak at 400 nm or lower. And more preferably, the image forming method is performed in combination with a fluorescent substance having a main emission peak at 380 nm or lower. Either single-sided photosensitive material or double-sided photosensitive material can be applied for the assembly. As the screen having a main emission peak at 400 nm or lower, the screens described in JP-A No. 6-11804 and WO No. 93/01521 and the like are used, but the present invention is not limited to these. As the techniques of crossover cutting (for double-sided photosensitive material) and anti-halation (for single-sided photosensitive material) of ultraviolet light, the technique described in JP-A No. 8-76307 can be applied. As ultraviolet absorbing dyes, the dye described in JP-A No. 2001-144030 is particularly preferred.

2-2. Thermal Development

Although any method may be used for the development of the photothermographic material of the invention, the thermal developing process is usually performed by elevating the temperature of the photothermographic material exposed imagewise. The temperature for development is preferably in a range of from 80° C. to 250° C., and more preferably, from 100° C. to 140° C.

Time period for development is preferably in a range of from 1 second to 60 seconds, more preferably from 5 seconds to 30 seconds, and particularly preferably from 5 seconds to 20 seconds.

In the process of thermal development, a process using a plate type heater is preferred. A preferable process for thermal development by a plate type heater is a process described in JP-A No. 11-133572, which discloses a thermal developing apparatus in which a visible image is obtained by bringing a photothermographic material with a formed latent image into contact with a heating means at a thermal developing section, wherein the heating means comprises a plate heater, and a plurality of pressing rollers are oppositely provided along one surface of the plate heater, the thermal developing apparatus is characterized in that thermal development is performed by passing the photothermographic material between the pressing rollers and the plate heater. It is preferred that the plate heater is divided into 2 to 6 steps, with the leading end having a lower temperature by about 1° C. to 10° C.

Such a process is also described in JP-A No. 54-30032, which allows for passage of moisture and organic solvents included in the photothermographic material out of the system, and also allows for suppressing the change of shapes of the support of the photothermographic material upon rapid heating of the photothermographic material.

FIG. 1 is a schematic view showing an embodiment of a thermal developing apparatus used for the image forming method of the present invention.

The photothermographic material A subjected to imagewise exposure is packed in a cassette 37, followed by loading into a thermal developing apparatus 100. In the apparatus, an opening lid 39 of the cassette 37 is uncovered, and then the photothermographic material A is taken out therefrom one by one with a suction cup 41. The material is conveyed into a preheating portion 44 by a conveyance roller 43, and then into a thermal developing portion 47. The thermal developing portion 47 comprises a plate heater 51, plural pressing rollers 53 which pushes the photothermographic material to the plate heater 51, a first heating means 49a represented by zone length L1, and a second heating means 49b represented by zone length L2. The first heating means and the second heating means are disposed separately in a back to back relation with each other so as to heat both sides of the photothermographic material. Thereafter, the material is conveyed to a cooling down portion 61 and discharged to the outside of the thermal developing apparatus 100.

3. Application of the Invention

The photothermographic material and the image forming method of the invention are preferably used for photothermographic materials for use in medical diagnosis, photothermographic materials for use in industrial photographs, photothermographic materials for use in graphic arts, as well as for COM, through forming black and white images by silver imaging and and the image forming method using the same. In particular, the photothermographic material and the image forming method of the invention are preferably used for medical diagnosis.

### EXAMPLES

The present invention is specifically explained by way of Examples below, which should not be construed as limiting the invention thereto.

### Example 1

1. Preparation of PET Support

1) Film Manufacturing

PET having IV (intrinsic viscosity) of 0.66 (measured in phenol/tetrachloroethane=6/4 (mass ratio) at 25° C.) was obtained according to a conventional manner using terephthalic acid and ethylene glycol. The product was pelletized, dried at 130° C. for 4 hours, and melted at 300° C. Thereafter, the mixture was extruded from a T-die and rapidly cooled to form a non-tentered film.

The film was stretched along the longitudinal direction by 3.3 times using rollers of different peripheral speeds, and then stretched along the transverse direction by 4.5 times using a tenter machine. The temperatures used for these operations were 110° C. and 130° C., respectively. Then, the film was subjected to thermal fixation at 240° C. for 20 seconds, and relaxed by 4% along the transverse direction at the same temperature. Thereafter, the chucking part was slit off, and both edges of the film were knurled. Then the film was rolled up at the tension of 4 kg/cm² to obtain a roll having the thickness of 175 μm.

2) Surface Corona Discharge Treatment

Both surfaces of the support were treated at room temperature at 20 m/minute using Solid State Corona Discharge Treatment Machine Model 6 KVA manufactured by Piller GmbH. It was proven that treatment of 0.375 kV·A·minute/m was executed, judging from the readings of current and voltage on that occasion. The frequency upon this treatment was 9.6 kHz, and the gap clearance between the electrode and dielectric roll was 1.6 mm.

3) Undercoating

(1) Preparation of Coating Solution for Undercoat Layer

Formula (1) (for undercoat layer on the image forming layer side)

| | |
|---|---|
| SnO₂/SbO (9/1 weight ratio, mean particle diameter of 0.5 μm, 17% by | 84 g |
| weight dispersion) | |
| Pesresin A-520 manufactured by Takamatsu Oil & Fat Co., Ltd. (30% | 46.8 g |
| by weight solution) | |
| BAIRONAARU MD-1200 manufactured by Toyo Boseki Co., Ltd. | 10.4 g |
| Polyethylene glycol monononylphenylether (average ethylene oxide | 11.0 g |
| number = 8.5) 1% by weight solution | |
| MP-1000 manufactured by Soken Chemical & Engineering Co., Ltd. (PMMA | 0.91 g |
| polymer fine particle, mean particle diameter of 0.4 μm) | |
| distilled water | 847 mL |

(2) Undercoating

Both surfaces of the aforementioned biaxially tentered polyethylene terephthalate support having the thickness of 175 μm were subjected to the corona discharge treatment as described above. Thereafter, the aforementioned formula (1) of the coating solution for the undercoat was coated with a wire bar so that the amount of wet coating became 6.6 mL/m² (per one side), and dried at 180° C. for 5 minutes. Thus, an undercoated support was produced.

2. Preparations of Coating Material

1) Preparation of Silver Halide Emulsion

(Preparation of Silver Halide Emulsion A)

<Preparation of Silver Halide Emulsion 1A (Tabular AgI Host Grains of 0.68 μm)>

A solution was prepared by adding 8 mL of a 10% by weight potassium iodide solution, and then 4.6 g of phthalated gelatin, and 160 mL of a 5% by weight methanol solution of 2,2′-(ethylene dithio)diethanol to 1421 mL of distilled water. The solution was kept at 75° C. while stirring in a stainless steel reaction vessel, and thereto were added total amount of: solution A prepared through diluting 22.7 g of silver nitrate by adding distilled water to give the volume of 223 mL; and solution B prepared through diluting 36.6 g of potassium iodide with distilled water to give the volume of 366 mL. A method of controlled double jet was executed through adding total amount of the solution A at a constant flow rate over 15 minutes and 22 seconds, accompanied by adding the solution B while maintaining the pAg at 9.96. Thereafter, 10 mL of a 3.5% by weight aqueous solution of hydrogen peroxide was added thereto, and 0.8 mL of a 10% by weight aqueous solution of benzimidazole was further added.

Moreover, a solution C prepared through diluting 53.1 g of silver nitrate by adding distilled water to give the volume of 520.2 mL and a solution D prepared through diluting 63.9 g of potassium iodide with distilled water to give the volume of 639 mL were added. A method of controlled double jet was executed through adding total amount of the solution C at a constant flow rate over 80 minutes, accompanied by adding the solution D while maintaining the pAg at 9.96. Potassium hexachloroiridate (III) was added in its entirety to give 1×10⁻⁴ mol per 1 mol of silver, at 10 minutes post initiation of the addition of the solution C and the solution D.

Moreover, at 5 seconds after completing the addition of the solution C, potassium hexacyanoferrate (II) in an aqueous solution was added in its entirety to give 3×10⁻⁴ mol per 1 mol of silver. The mixture was adjusted to the pH of 3.8 with 0.5 mol/L sulfuric acid. After stopping stirring, the mixture was subjected to precipitation/desalting/water washing steps. The mixture was adjusted to the pH of 5.9 with 1 mol/L sodium hydroxide to produce a silver halide dispersion having the pAg of 11.0.

The silver halide emulsion 1A was a pure silver iodide emulsion, and the obtained host grains had a mean projected area equivalent diameter of 1.36 μm, a variation coefficient of a projected area equivalent diameter distribution of 17.7%, a mean thickness of 0.113 μm, and a mean aspect ratio of 12.0. Tabular grains having an aspect ratio of 2 or more occupied 80% or more of the total projected area. A mean equivalent spherical diameter of the grains was 0.68 μm. 15% or more of the silver iodide existed in γ phase from the result of powder X-ray diffraction analysis.

<Preparation of Silver Halide Emulsion 2A (Epitaxial Grains of 0.68 μm)>

1 mol of the above silver iodide host grains was added to the reaction vessel. The pAg measured at 40° C. was 9.1. A solution containing 0.088 mol of potassium bromide and 0.038 mol of sodium chloride per one liter, and 0.125 mol/L silver nitrate solution were added at an addition speed of 28.7 mL/min over 31 minutes by double jet addition to precipitate substantially a 10 mol % of silver chlorobromide based on total siver amount at six corner portions on the silver iodide host grains as epitaxial form. During the operation, the pAg was kept at 7.13.

Furthermore, the mixture was adjusted to the pH of 3.8 with 0.5 mol/L sulfuric acid. After stopping stirring, the mixture was subjected to precipitation/desalting/water washing steps. The mixture was adjusted to the pH of 5.9 with 1 mol/L sodium hydroxide to produce a silver halide dispersion having the pAg of 11.0.

The average halogen composition of epitaxial portion was determined by a field emission-type analytical electron microscope with an ultrathin slice of the epitaxial portion of silver halide grain. As a result of the measurement, it was revealed that bromine being 80 mol %, chlorine being 17 mol %, and iodine being 3 mol %.

The above-mentioned silver halide dispersion was kept at 38° C. with stirring, and thereto was added 5 mL of a 0.34% by weight methanol solution of 1,2-benzisothiazoline-3-one, and after 40 minutes the temperature was elevated to 60° C. At 20 minutes after elevating the temperature, sodium benzene thiosulfonate in a methanol solution was added at 7.6×10⁻⁵ mol per 1 mol of silver. At additional 5 minutes later, tellurium sensitizer C in a methanol solution was added at 2.9×10⁻⁵ mol per 1 mol of silver and subjected to ripening for 91 minutes.

And then, 1.3 mL of a 0.8% by weight N,N′-dihydroxy-N″,N″-diethylmelamine in methanol was added thereto, and at additional 4 minutes thereafter, 5-methyl-2-mercaptobenzimidazole in a methanol solution at 4.8×10⁻³ mol per 1 mol of silver, 1-phenyl-2-heptyl-5-mercapto-1,3,4-triazole in a methanol solution at 5.4×10⁻³ mol per 1 mol of silver, and 1-(3-methylureido phenyl)-5-mercaptotetrazole in an aqueous solution at 8.5×10⁻³ mol per 1 mol of silver were added to produce silver halide emulsion 2A having an epitaxial junction.

(Preparation of Silver Halide Emulsion B)

<Preparation of Host Grain 1B>

Preparations of silver halide emulsion 1B was conducted in a similar manner to the process in the preparation of silver halide emulsion 1A, except that adequately changing the addition amount of a 5% by weight methanol solution of 2,2′-(ethylene dithio)diethanol, the temperature at grain formation step, and the time for adding the solution A. The obtained silver halide grains had a mean projected area equivalent diameter of 0.93 μm, a variation coefficient of a projected area equivalent diameter distribution of 17.7%, a mean thickness of 0.057 μm, and a mean aspect ratio of 16.3. A mean equivalent spherical diameter of the grains was 0.42 μm. 15% or more of the silver iodide existed in r phase from the result of powder X-ray diffraction analysis.

<Preparation of Grains Having an Epitaxial Junction>

Preparation of silver halide emulsion 2B was conducted in a similar manner to the process in the preparation of silver halide emulsion 2A except that using silver halide emulsion 1B as host grains. The silver halide emulsion 2B contained 10 mol % of silver chlorobromide epitaxial.

(Preparation of Silver Halide Emulsion C)

<Preparation of Host Grain 1C>

Preparation of silver halide emulsion 1C was conducted in a similar manner to the process in the preparation of silver halide emulsion 1A, except that adequately changing the addition amount of a 5% by weight methanol solution of 2,2′-(ethylene dithio)diethanol, the temperature at grain formation step, and the time for adding the solution A. The obtained silver halide grains had a mean projected area equivalent diameter of 0.443 μm, a variation coefficient of a projected area equivalent diameter distribution of 19.1%, a mean thickness of 0.053 μm, and a mean aspect ratio of 8.37. A mean equivalent spherical diameter of the grains was 0.25 μm. 15% or more of the silver iodide existed in r phase from the result of powder X-ray diffraction analysis.

<Preparation of Grains having an Epitaxial Junction>

Preparation of silver halide emulsion 2C was conducted in a similar manner to the process in the preparation of silver halide emulsion 2A except that using silver halide emulsion 1C as host grains. The silver halide emulsion 2C contained 10 mol % of silver bromide epitaxial.

(Preparation of Silver Halide Emulsion D)

<Preparation of Silver Halide Emulsion D (AgI Fine Grains of 0.04 μm)>

A liquid was prepared by adding 4.3 mL of a 1% by weight potassium iodide solution, and then 3.5 mL of 0.5 mol/L sulfuric acid and 36.7 g of phthalated gelatin to 1420 mL of distilled water. The liquid was kept at 42° C. while stirring in a stainless steel reaction vessel, and thereto were added total amount of: solution A prepared through diluting 22.22 g of silver nitrate by adding distilled water to give the volume of 195.6 mL; and solution B prepared through diluting 21.8 g of potassium iodide with distilled water to give the volume of 218 mL, over 9 minutes at a constant flow rate. Thereafter, 10 mL of a 3.5% by weight aqueous solution of hydrogen peroxide was added thereto, and 10.8 mL of a 10% by weight aqueous solution of benzimidazole was further added.

Moreover, a solution C prepared through diluting 51.86 g of silver nitrate by adding distilled water to give the volume of 317.5 mL and a solution D prepared through diluting 60 g of potassium iodide with distilled water to give the volume of 600 mL were added. A method of controlled double jet was executed through adding total amount of the solution C at a constant flow rate over 120 minutes, accompanied by adding the solution D while maintaining the pAg at 8.1. Potassium hexachloroiridate (III) was added in its entirety to give 1×10⁻⁴ mol per 1 mol of silver, at 10 minutes post initiation of the addition of the solution C and the solution D.

Moreover, at 5 seconds after completing the addition of the solution C, potassium hexacyanoferrate (III) in an aqueous solution was added in its entirety to give 3×10⁻⁴ mol per 1 mol of silver. The mixture was adjusted to the pH of 3.8 with 0.5 mol/L sulfuric acid. After stopping stirring, the mixture was subjected to precipitation/desalting/water washing steps. The mixture was adjusted to the pH of 5.9 with 1 mol/L sodium hydroxide to produce a silver halide dispersion having the pAg of 8.0.

The above-mentioned silver halide dispersion was kept at 38° C. with stirring, and thereto was added 5 mL of a 0.34% by weight methanol solution of 1,2-benzisothiazoline-3-one, and the temperature was elevated to 47° C. At 20 minutes after elevating the temperature, sodium benzene thiosulfonate in a methanol solution was added at 7.6×10⁻⁵ mol per 1 mol of silver. At additional 5 minutes later, tellurium sensitizer C in a methanol solution was added at 2.9×10⁻⁴ mol per 1 mol of silver and subjected to ripening for 91 minutes.

And then, 1.3 mL of a 0.8% by weight N,N′-dihydroxy-N″,N″-diethylmelamine in methanol was added thereto, and at additional 4 minutes thereafter, 5-methyl-2-mercaptobenzimidazole in a methanol solution at 4.8×10⁻³ mol per 1 mol of silver, and 1-phenyl-2-heptyl-5-mercapto-1,3,4-triazole in a methanol solution at 5.4×10⁻³ mol per 1 mol of silver were added to produce silver halide emulsion D.

Grains in thus prepared silver halide emulsion were pure silver iodide grains having a mean equivalent spherical diameter of 0.040 μm, a variation coefficient of an equivalent spherical diameter distribution of 18%, and tetradecahedral shaped grains having faces of (001), {100}, and {101}. The ratio of γ phase was 30%, determined by powder X-ray diffraction analysis. Grain size and the like were determined from the average of 1000 grains using an electron microscope.

Shapes of the prepared host grains are shown in Table 1.

TABLE 1

| | | Mean Equivalent | Mean Projected Area | | | |
|---|---|---|---|---|---|---|
| Emulsion | AgI content | Spherical Diameter | Equivalent Diameter | Mean Thickness | Mean Aspect | |
| No. | (mol %) | (μm) | (μm) | (μm) | Ratio | Note |
| 1A | 100 | 0.68 | 1.36 | 0.113 | 12.0 | Emulsion of the |
| | | | | | | Invention |
| 1B | 100 | 0.42 | 0.82 | 0.074 | 11.1 | Emulsion of the |
| | | | | | | Invention |
| 1C | 100 | 0.25 | 0.44 | 0.053 | 8.4 | Comparative |
| | | | | | | Emulsion |
| D | 100 | 0.04 | — | — | 1.0 | Comparative |
| | | | | | | Emulsion |

<<Preparations of Emulsion for Coating Solution>>

Each of the silver halide emulsion 2A to 2C, and D was dissolved and thereto was added benzothiazolium iodide in a 1% by weight aqueous solution at 7×10⁻³ mol per 1 mol of silver. Further, as “a compound that can be one-electron-oxidized to provide a one-electron oxidation product, which releases one or more electrons”, the compounds Nos. 1, 2, and 3 were added respectively in an amount of 2×10⁻³ mol per 1 mol of silver in silver halide. Thereafter, as “a compound having an adsorptive group and a reducing group”, the compound Nos. 1 and 2 were added respectively in an amount of 8×10⁻³ mol per 1 mol of silver halide.

Further, water was added thereto to give the content of silver halide of 15.6 g in terms of silver, per 1 liter of the emulsion for a coating solution.

2) Preparation of Dispersion of Organic Silver Salt

<<Preparation of Dispersion of Silver Salt of Fatty Acid>>

Preparation of Recrystallized Behenic Acid

Behenic acid manufactured by Henkel Co. (trade name: Edenor C22-85R) in an amount of 100 kg was admixed with 1200 kg of isopropyl alcohol, and dissolved at 50° C. The mixture was filtrated through a 10 μm filter, and cooled to 30° C. to allow recrystallization. Cooling speed for the recrystallization was controlled to be 3° C./hour.

The resulting crystal was subjected to centrifugal filtration, and washing was performed with 100 kg of isopropyl alcohol. Thereafter, the crystal was dried. The resulting crystal was esterified, and subjected to GC-FID analysis to give the results of the content of behenic acid being 96 mol %, lignoceric acid 2 mol %, and arachidic acid 2 mol %. In addition, erucic acid was included at 0.001 mol %.

Preparation of Nano-Particles of Silver Behenate

Into a reaction vessel, deionized water, 72 g of a 10% by weight aqueous solution of dodecylthio polyacrylamide surfactant (BUN-1), and 46.6 g of the above recrystallized behenic acid were added. The mixture was stirred at a rotating speed of 150 rpm and heated to 70° C., while adding 70.6 g of a 10% by weight aqueous solution of potassium hydroxide into the reaction vessel. Next, the resulting mixture was heated to 80° C. and allowed to stand for 30 minutes till the solution turned to be turbid. Thereafter, the mixture was cooled to 70° C. and then 21.3 g of 100% by weight solution of silver nitrate was added into the reaction vessel over a period of 30 minutes while adjusting the addition speed. The reaction temperature of the mixture was kept for 30 minutes and then cooled to room temperature, and the resultant was then decanted. The nano-particle dispersion of silver behenate having a median particle size of 150 nm was obtained (solid content: 3% by weight).

Purification and Condensation of Nano-Particles of Silver Behenate

12 kg of nano-particle dispersion (solid content: 3% by weight) was introduced into a filtration dialysis/ultrafiltration device equipped with a permeable membrane cartridge Osmonics Model 21-HZ20-S8J (the effective surface area: 0.34 m², nominal molecular weight cutoff of 50,000). The device was operated so that the pressure to the permeable membrane was set to be 3.5 kg/cm² (50 lb/in²), and the pressure of the downstream side of the permeable membrane was set to be 20 kg/cm² (285 lb/in²). The permeating liquid was replaced by deionized water until 24 kg of permeating liquid was removed from the dispersion, and then the replacement by deionized water was stopped. Thereafter, the device was operated until the dispersion reached to a concentration of 28% by weight based on the solid content. Thereby, purified and condensed nano-particle dispersion of silver behenate was obtained.

3) Preparation of Reducing Agent Dispersion

<<Preparation of Reducing Agent-1 Dispersion>>

To 10 kg of reducing agent-1 (2,2′-(3,5,5-trimethylhexylidene) bis(4,6-dimethylphenol)) and 16 kg of a 10% by weight aqueous solution of modified poly(vinyl alcohol) (manufactured by Kuraray Co., Ltd., Poval MP-203) was added 10 kg of water, and thoroughly mixed to give a slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 3 hours. Thereafter, 0.2 g of a benzoisothiazolinone sodium salt and water were added thereto, thereby adjusting the concentration of the reducing agent to be 25% by weight.

This dispersion was subjected to heat treatment at 60° C. for 5 hours to obtain reducing agent-1 dispersion. Particles of the reducing agent included in the resulting reducing agent dispersion had a median diameter of 0.40 μm, and a maximum particle diameter of 1.4 μm or less. The resultant reducing agent dispersion was subjected to filtration with a polypropylene filter having a pore size of 3.0 μm to remove foreign substances such as dust, and stored.

<<Preparations of Infectious Developing Reducing Agent Dispersion>>

To 10 kg of the reducing agent (No. R1-1) of formula (R1) and 16 kg of a 10% by weight aqueous solution of modified poly(vinyl alcohol) (manufactured by Kuraray Co., Ltd., Poval MP-203) was added 10 kg of water, and thoroughly mixed to give a slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 3 hours. Thereafter, 0.2 g of a benzoisothiazolinone sodium salt and water were added thereto, thereby adjusting the concentration of the reducing agent to be 25% by weight.

This dispersion was subjected to heat treatment at 60° C. for 5 hours to obtain reducing agent R1-1 dispersion. Particles of the reducing agent included in the resulting reducing agent dispersion had a median diameter of 0.40 μm, and a maximum particle diameter of 1.4 μm or less. The resultant reducing agent dispersion was subjected to filtration with a polypropylene filter having a pore size of 3.0 μm to remove foreign substances such as dust, and stored.

Concerning other reducing agents of formula (R1), dispersions were prepared similarly.

4) Preparations of Organic Polyhalogen Compound Dispersion

<<Preparation of Organic Polyhalogen Compound-1 Dispersion>>

10 kg of organic polyhalogen compound-1 (tribromomethane sulfonylbenzene), 10 kg of a 20% by weight aqueous solution of modified poly(vinyl alcohol) (manufactured by Kuraray Co., Ltd., Poval MP203), 0.4 kg of a 20% by weight aqueous solution of sodium triisopropylnaphthalenesulfonate and 14 kg of water were thoroughly admixed to give a slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 5 hours. Thereafter, 0.2 g of a benzisothiazolinone sodium salt and water were added thereto, thereby adjusting the concentration of the organic polyhalogen compound to be 26% by weight. Accordingly, organic polyhalogen compound-1 dispersion was obtained. Particles of the organic polyhalogen compound included in the resulting organic polyhalogen compound dispersion had a median diameter of 0.41 μm, and a maximum particle diameter of 2.0 μm or less.

The resultant organic polyhalogen compound dispersion was subjected to filtration with a polypropylene filter having a pore size of 10.0 μm to remove foreign substances such as dust, and stored.

<<Preparation of Organic Polyhalogen Compound-2 Dispersion>>

10 kg of organic polyhalogen compound-2 (N-butyl-3-tribromomethane sulfonylbenzamide), 20 kg of a 10% by weight aqueous solution of modified poly(vinyl alcohol) (manufactured by Kuraray Co., Ltd., Poval MP203) and 0.4 kg of a 20% by weight aqueous solution of sodium triisopropylnaphthalenesulfonate were thoroughly admixed to give a slurry.

This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 5 hours. Thereafter, 0.2 g of a benzisothiazolinone sodium salt and water were added thereto, thereby adjusting the concentration of the organic polyhalogen compound to be 30% by weight.

This dispersion was heated at 40° C. for 5 hours to obtain organic polyhalogen compound-2 dispersion. Particles of the organic polyhalogen compound included in the resulting organic polyhalogen compound dispersion had a median diameter of 0.40 μm, and a maximum particle diameter of 1.3 μm or less.

The resultant organic polyhalogen compound dispersion was subjected to filtration with a polypropylene filter having a pore size of 3.0 μm to remove foreign substances such as dust, and stored.

5) Preparation of Pigment-1 Dispersion

C.I. Pigment Blue 60 in an amount of 64 g and 6.4 g of DEMOL N manufactured by Kao Corporation were added to 250 g of water and thoroughly mixed to give a slurry. Zirconia beads having a mean particle diameter of 0.5 mm were provided in an amount of 800 g, and charged in a vessel with the slurry. Dispersion was performed with a dispersing machine (¼ G sand grinder mill: manufactured by AIMEX Co., Ltd.) for 25 hours. Thereto was added water to adjust so that the concentration of the pigment became 5% by weight to obtain a pigment-1 dispersion.

Particles of the pigment included in the resulting pigment dispersion had a mean particle diameter of 0.21 μm.

6) Preparation of Silver Iodide Complex-Forming Agent Solution

8 kg of modified poly(vinyl alcohol) MP203 was dissolved in 174.57 kg of water, and thereto were added 3.15 kg of a 20% by weight aqueous solution of sodium triisopropylnaphthalenesulfonate and 14.28 kg of a 70% by weight aqueous solution of compound No. 22 as a silver iodide complex-forming agent. Accordingly, a 5% by weight solution of silver iodide complex-forming agent compound was prepared.

7) Preparations of Aqueous Solution

The following compounds were added by preparing an aqueous solution thereof.

Compound of Formula (I) or (II)

A 5% by weight aqueous solution of succinimide was prepared.

4-methylphthalic acid

A 5% by weight aqueous solution of 4-methylphthalic acid was prepared.

3. Preparations of Coating Solution

1) Preparation of Coating Solution for Image Forming Layer

A vessel was kept at 40° C., and thereto were added 450 mL of water and 200 g of gelatin. After dissolving the gelatin, the dispersion of organic silver salt (shown in Table 2), the reducing agent dispersion (shown in Table 2), the pigment-1 dispersion, the organic polyhalogen compound-1 dispersion, the organic polyhalogen compound-2 dispersion, the compound of formula (I) or (II) (shown in Table 2), the 4-methylphthalic acid aqueous solution, and sodium iodide were serially added. The mixed emulsion for coating solution was added thereto, followed by thorough mixing just prior to the coating, which is fed directly to a coating die.

The amount of zirconium in the coating solution was 0.18 mg per 1 g of silver.

2) Preparation of Coating Solution for Surface Protective Layer

A vessel was kept at 40° C., and thereto were added 2400 mL of water and 300 g of gelatin. After dissolving the gelatin, 60 g of a 5% by weight aqueous solution of di(2-ethylhexyl) sodium sulfosuccinate, and 900 g of succinimide aqueous solution were serially added and then stirred well to prepare a coating solution.

4. Preparation of Photothermographic Material

Both surfaces of the support were subjected to simultaneous overlaying coating by a slide bead coating method in order of the image forming layer and surface protective layer from the undercoat layer, and thus sample of photothermographic material was produced. In this method, the temperature of the coating solution was adjusted to 37° C. for the image forming layer and surface protective layer.

The coating amount of each compound (g/m²) per one side for the image forming layer of sample No. 1 is as follows. The surface protective layer was coated to give the coating amount of dry gelatin of 2.0 g/m².

| | |
|---|---|
| Organic silver salt (shown in the amount of coated silver) | 0.686 |
| Pigment (C.I.Pigment Blue 60) | 0.036 |
| Organic polyhalogen compound-1 | 0.028 |
| Organic polyhalogen compound-2 | 0.094 |
| 4-Methyl phthalic acid | 0.04 |
| Compound of formula (I) or (II) | (see Table 2) |
| Gelatin | 1.95 |
| Sodium iodide | 0.02 |
| Reducing agent | (see Table 2) |
| Silver iodide complex-forming agent | 0.46 |
| Silver halide (on the basis of Ag content) | (see Table 2) |

Chemical structures of the compounds used in Examples of the invention are shown below.
Tellurium Sensitizer C

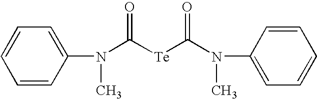

Compound 1 that can be one-electron-oxidized to provide a one-electron oxidation product which releases one or more electrons

TABLE 2

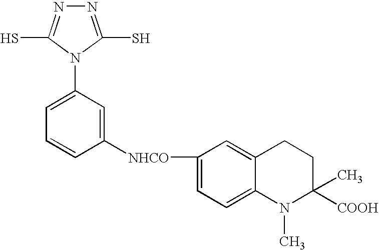

| | | | |
|---|---|---|---|
| Silver | | | Compound of Formula |
| Halide Emulsion | Organic Silver Salt | Reducing Agent | (I) or (II) |

| | | Amount of | | Amount of | | Coating | | Coating | |
|---|---|---|---|---|---|---|---|---|---|
| Sam- | | Coated Silver | | Coated | | Amount | | Amount | |
| ple | | (one side) | | Silver (one | | (one side) | | (one side) | |
| No. | No. | (g/m²) | Kind | side) (g/m²) | No. | (g/m²) | Kind | (g/m²) | Note |
| 1 | 2A | 0.175 | Nano-particle | 0.686 | Reducing | 0.46 | succinimide | 0.38 | Comparative |
| | | | | | agent-1 | | | | |
| 2 | 2A | 0.250 | Nano-particle | 0.686 | Reducing | 0.46 | succinimide | 0.38 | Comparative |
| | | | | | agent-1 | | | | |
| 3 | 2A | 0.175 | Nano-particle | 0.686 | R1-1 | 0.43 | succinimide | 0.38 | Invention |
| 4 | 2A | 0.250 | Nano-particle | 0.686 | R1-1 | 0.43 | succinimide | 0.38 | Invention |
| 5 | 2B | 0.175 | Nano-particle | 0.686 | Reducing | 0.46 | succinimide | 0.38 | Comparative |
| | | | | | agent-1 | | | | |
| 6 | 2B | 0.250 | Nano-particle | 0.686 | Reducing | 0.46 | succinimide | 0.38 | Comparative |
| | | | | | agent-1 | | | | |
| 7 | 2B | 0.175 | Nano-particle | 0.686 | R1-1 | 0.43 | succinimide | 0.38 | Invention |
| 8 | 2B | 0.250 | Nano-particle | 0.686 | R1-1 | 0.43 | succinimide | 0.38 | Invention |
| 9 | 2C | 0.175 | Nano-particle | 0.686 | Reducing | 0.46 | succinimide | 0.38 | Comparative |
| | | | | | agent-1 | | | | |
| 10 | 2C | 0.250 | Nano-particle | 0.686 | Reducing | 0.46 | succinimide | 0.38 | Comparative |
| | | | | | agent-1 | | | | |
| 11 | 2C | 0.175 | Nano-particle | 0.686 | R1-1 | 0.43 | succinimide | 0.38 | Comparative |
| 12 | 2C | 0.250 | Nano-particle | 0.686 | R1-1 | 0.43 | succinimide | 0.38 | Comparative |
| 13 | D | 0.175 | Nano-particle | 0.686 | Reducing | 0.46 | succinimide | 0.38 | Comparative |
| | | | | | agent-1 | | | | |
| 14 | D | 0.250 | Nano-particle | 0.686 | Reducing | 0.46 | succinimide | 0.38 | Comparative |
| | | | | | agent-1 | | | | |
| 15 | D | 0.175 | Nano-particle | 0.686 | R1-1 | 0.43 | succinimide | 0.38 | Comparative |
| 16 | D | 0.250 | Nano-particle | 0.686 | R1-1 | 0.43 | succinimide | 0.38 | Comparative |

Compound 2 that can be one-electron-oxidized to provide a one-electron oxidation product which releases one or more electrons 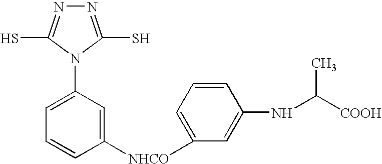
Compound 3 that can be one-electron-oxidized to provide a one-electron oxidation product which releases one or more electrons 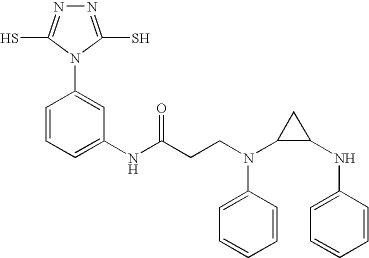
Compound 1 having an adsorptive group and a reducing group 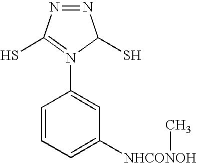
Compound 2 having an adsorptive group and a reducing group 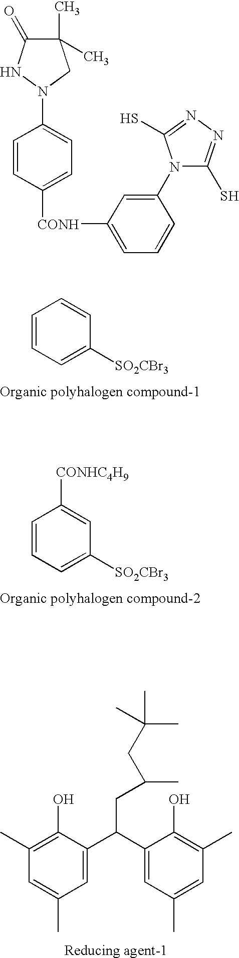
5. Evaluation of Photographic Properties
5-1. Preparation

The obtained sample was cut into a half-cut size (43 cm in length×35 cm in width), and was wrapped with the following packaging material under an environment of 25° C. and 50% RH, and stored for 2 weeks at an ambient temperature. Thereafter, the following evaluation was performed.

<<Packaging Material>>

A film laminated with PET 10 μm/PE 12 μm/aluminum foil 9 μm/Ny 15 μm/polyethylene 50 μm containing carbon at 3% by weight:

oxygen permeability at 25° C.: 0.02 mL·atm⁻¹ m⁻² day⁻¹;

vapor permeability at 25° C.: 0.10 g·atm⁻¹ m⁻¹ day⁻¹.

5-2. Condition for Evaluation of Photographic Properties

1) Exposure

Two sheets of the fluorescent intensifying screen A described below were used. The assembly for image formation was provided by inserting the sample between them. This assembly was subjected to X-ray exposure for 0.05 seconds, and then X-ray sensitometry was performed. The X-ray apparatus used was DRX-3724HD (trade name) produced by Toshiba Corp., and a tungsten target tube was used. X-ray emitted by a pulse generator operated at three phase voltage of 80 kVp and penetrated through a filter comprising 7 cm thickness of water having the absorption ability almost the same as human body was used as the light source. Whlie changing the exposure value of X-ray by a distance method, the sample was subjected to exposure with a step wedge tablet having a width of 0.15 in terms of log E.

<Preparation of Fluorescent Intensifying Screen A>

(1) Undercoating

A light reflecting layer comprising alumina powder was coated on a polyethylene terephthalate film (support) having a thickness of 250 μm in a similar manner to the Example 4 in JP-A. No. 2001-124898. The light reflecting layer which had a film thickness of 50 μm after drying, was prepared.

(2) Preparation of Fluorescent Substance Sheet

250 g of BaFBr:Eu fluorescent substance (mean particle size of 3.5 μm), 8 g of polyurethane type binder resin (manufactured by Dai Nippon Ink & Chemicals, Inc., trade name: PANDEX T5265M), 2 g of epoxy type binder resin (manufactured by Yuka Shell Epoxy Co., Ltd., trade name: EPIKOTE 101) and 0.5 g of isocyanate compounds (manufactured by Nippon Polyurethane Industry Co., Ltd., trade name: CORONATE HX) were added into methylethylketone, and the mixture was then dispersed by a propeller mixer to prepare the coating solution for the fluorescent substance layer having a viscosity of 25 PS (25° C.). This coating solution was coated on the surface of a temporary support (pretreated by coating a silicone agent on the surface of polyethylene terephthalate film), and dried to make the fluorescent substance layer. Thereafter, the fluorescent substance sheet was prepared by peeling the fluorescent substance layer from the temporary support.

(3) Overlaying the Fluorescent Substance Sheet on Light Reflective Layer.

The fluorescent substance sheet prepared above was overlaid on the surface of the light reflective layer of the support having a light reflective layer made in the above process (1), and then pressed by a calendar roller at the pressure of 400 kgw/cm² and the temperature of 80° C. to form the fluorescent substance layer on the light reflective layer. The thickness of the obtained fluorescent substance layer was 125 μm and the volume filling factor of fluorescent substance particles in the fluorescent substance layer was 68%.

(4) Preparation of Surface Protective Layer

Polyester type adhesive agents were coated on one side of a polyethylene terephthalate (PET) film having a thickness of 6 μm, and thereafter the surface protective layer was formed on the fluorescent substance layer by a laminating method. As described above, the fluorescent intensifying screen A comprising a support, a light reflective layer, a fluorescent substance layer and a surface protective layer was prepared.

(5) Emission Characteristics

The emission spectrum of the intensifying screen A was measured by X-ray at 40 kVp and is shown in FIG. 2. The fluorescent intensifying screen A showed an emission having a peak at 390 nm and a narrow half band width.

2) Thermal Development

After exposure, the samples were thermally developed using the thermal developing apparatus shown in FIG. 1, under the following thermal developing conditions.

TABLE 3

| | Temperature | Time Period |
|---|---|---|
| | (° C.) | (sec) |
| Preheating | 100 | 12 |
| First Heating Means | 119 | 10 |
| Second Heating Means | 121 | 12 |

3) Terms for Evaluation

(1) Measurement of Haze of Film

The term “haze” indicates the degree of diffusion of the light incident to a photosensitive material, and the ratio of the amount of diffused transmitted light to total amount of transmitted light is expressed in percentage. The haze measuring apparatus Model 1001DP produced by NIPPON DENSHOKU Co., Ltd. was used for the measurement of haze.

The haze of the film was measured before and after thermal development of each unexposed sample.

(2) Other Photographic Properties

Fog: Fog is expressed in terms of a density of the unexposed portion. Sensitivity: Sensitivity is expressed by a reciprocal of the exposure value necessary to give an optical density of fog+1.0. Sensitivities are shown in relative values, detecting the sensitivity of Sample No. 1 to be 100.

Average gradient: Average gradient is gradient of a straight line connecting the points at fog+(optical density of 0.25) and fog+(optical density of 2.0) on the photographic characteristic curve (i.e., the value equals tan θ when the angle between the line and the horizontal axis is θ).

Distinguishability of Images: The sample was subjected to X-ray exposure using a chest phantom image while adjusting the exposure value to give a proper density (D=1.8) for lung field portion. The imaging characteristics of mediastinum portion of the chest phantom image and the distinguishability of artificial blood vessels were evaluated by visual observation and classified into the following criteria as (⊚, ◯, Δ, and X. Concerning the color tone of developed silver images, the overall image was evaluated by visual observation and classified into the following criteria as ◯, Δ, and X.

Evaluation was performed according to the following criteria.

⊚: Streak is not observed, excellent.

◯: Streak having a low density is slightly observed.

Δ: Streak having a high density is slightly observed.

X: Coating streak is seen in overall surface.

(3) Image Storability

Evaluation of Image Stroability (Print-Out):

Image samples obtained by thermally developing the sample Nos. 1 to 16 were left for 5 days under an illumination condition of fluorescent lamp of 6000 Lux at 40° C. and 50% relative humidity. Thereafter, an optical density of an unexposed portion was measured. The obtained density was denoted as fog₂ and a density of the unexposed portion before leaving under a fluorescent lamp was denoted as fog₁, and then the difference (Δ fog) between fog₂ and fog, was calculated as follows;
Δfog=fog₂−fog₁

Evaluation of Raw Stock Storability:

Samples were sealed in the packaging materials described above and stored under an accelerated storage condition at 45° C. for 7 days. Thereafter, the samples were subjected to imagewise exposure and thermal development. The samples were evaluated about the sensitivity change by comparing with the sample stored in a refrigerator.
Raw stock storability (Sensitivity change)=−log((Sensitivity of a sample after being stored under the accelerated storage condition at 45° C. for 7 days)/(Sensitivity of the sample stored in a refrigerator))

5-3. Results of Evaluation

The obtained results are shown in Table 4.

The photothermographic materials of the present invention give a high image quality image having high sensitivity, excellent distinguishability of images, excellent quality in haze, gradation, and color tone suitable for medical diagnosis, and were excellent in image storability and raw stock storability.

### Example 2

1. Preparations of Sample

Preparations of sample Nos. 21 to 36 shown in Table 5 were conducted similar to Example 1, except that using reducing agent-1 and a nucleator instead of using an infectious developing reducing agent. The nucleator was used by preparing a dispersion as follows.

<<Preparation of Nucleator Dispersion>>

2.5 g of poly(vinyl alcohol) (manufactured by Kuraray Co., Ltd., PVA-217) and 87.5 g of water were added to 10 g of compound No. SH-7 as a nucleator, and thoroughly admixed to give a slurry. This slurry was allowed to stand for 3 hours. Zirconia beads having a mean particle diameter of 0.5 mm were provided in an amount of 240 g, and charged in a vessel with the slurry. Dispersion was performed with a dispersing machine (¼ G sand grinder mill: manufactured by AIMEX Co., Ltd.) for 10 hours to obtain a solid fine particle dispersion of nucleator. Particles of the nucleator included in the resulting nucleator dispersion had a mean particle diameter of 0.5 μm, and 80% by weight of the particles had a particle diameter of from 0.1 μm to 1.0 μm.

TABLE 4

| | Silver Halide | | | | | | | |
|---|---|---|---|---|---|---|---|---|
| | Emulsion | | | Haze | | | | |
| | | Amount of | | Before | After | | | |
| | | Coated Silver | | Thermal | Thermal | Photographic Properties | | |
| Sample | | (one side) | Reducing | Development | Development | | | Maximum |
| No. | No. | (g/m²) | Agent | (A) | (B) | Fog | Sensitivity | Density |
| 1 | 2A | 0.175 | Reducing | 55 | 25 | 0.20 | 100 | 0.8 |
| | | | agent-1 | | | | | |
| 2 | 2A | 0.250 | Reducing | 65 | 35 | 0.23 | 115 | 1.2 |
| | | | agent-1 | | | | | |
| 3 | 2A | 0.175 | R1-1 | 55 | 25 | 0.21 | 120 | 3.4 |
| 4 | 2A | 0.250 | R1-1 | 65 | 35 | 0.25 | 135 | 3.8 |
| 5 | 2B | 0.175 | Reducing | 48 | 24 | 0.19 | 24 | 1.2 |
| | | | agent-1 | | | | | |
| 6 | 2B | 0.250 | Reducing | 56 | 32 | 0.22 | 28 | 1.9 |
| | | | agent-1 | | | | | |
| 7 | 2B | 0.175 | R1-1 | 48 | 24 | 0.20 | 32 | 3.6 |
| 8 | 2B | 0.250 | R1-1 | 56 | 32 | 0.23 | 35 | 3.8 |
| 9 | 2C | 0.175 | Reducing | 39 | 23 | 0.18 | 5 | 1.5 |
| | | | agent-1 | | | | | |
| 10 | 2C | 0.250 | Reducing | 47 | 31 | 0.21 | 7 | 2.3 |
| | | | agent-1 | | | | | |
| 11 | 2C | 0.175 | R1-1 | 39 | 23 | 0.19 | 6 | 3.6 |
| 12 | 2C | 0.250 | R1-1 | 47 | 31 | 0.20 | 9 | 3.8 |
| 13 | D | 0.175 | Reducing | 27 | 22 | 0.18 | 0.02 | 3.4 |
| | | | agent-1 | | | | | |
| 14 | D | 0.250 | Reducing | 32 | 27 | 0.19 | 0.03 | 3.6 |
| | | | agent-1 | | | | | |
| 15 | D | 0.175 | R1-1 | 27 | 22 | 0.18 | 0.04 | 3.9 |
| 16 | D | 0.250 | R1-1 | 32 | 27 | 0.19 | 0.06 | 4.2 |

| | Photographic Properties | | | | | |
|---|---|---|---|---|---|---|
| | | Color | | | | |
| | | Tone of | | | | |
| | | Developed | Raw | | Distinguishability | |
| Sample | | Silver | Stock | Image | of Phantom | |
| No. | Gradation | Images | Storability | Storability | Images | Note |
| 1 | 0.4 | X | 0.25 | 0.01 | X | Comparative |
| 2 | 0.8 | X | 0.35 | 0.08 | X | Comparative |
| 3 | 3.2 | ◯ | 0.03 | 0.01 | ⊚ | Invention |
| 4 | 3.6 | Δ | 0.04 | 0.08 | ◯ | Invention |
| 5 | 0.7 | X | 0.20 | 0.01 | X | Comparative |
| 6 | 1.3 | X | 0.35 | 0.05 | X | Comparative |
| 7 | 3.5 | ◯ | 0.04 | 0.01 | ⊚ | Invention |
| 8 | 3.8 | Δ | 0.06 | 0.05 | ◯ | Invention |
| 9 | 1.1 | Δ | 0.15 | 0.01 | X | Comparative |
| 10 | 1.9 | Δ | 0.18 | 0.03 | X | Comparative |
| 11 | 3.7 | ◯ | 0.05 | 0.01 | Δ | Comparative |
| 12 | 4.0 | Δ | 0.07 | 0.03 | X | Comparative |
| 13 | 3.8 | Δ | 0.13 | 0.01 | X | Comparative |
| 14 | 4.2 | Δ | 0.15 | 0.01 | X | Comparative |
| 15 | 5.2 | ◯ | 0.09 | 0.01 | X | Comparative |
| 16 | 5.5 | Δ | 0.12 | 0.01 | X | Comparative |

TABLE 5

| | Silver Halide | | | | | | | | |
|---|---|---|---|---|---|---|---|---|---|
| | Emulsion | | | | | | | | |
| | | Amount | Nucleator | | Haze | | | | |
| | | of Coated | | Coating | Before | After | | | |
| | | Silver | | Amount | Thermal | Thermal | Photographic Properties | | |
| Sample | | (one side) | | (one side) | Development | Development | | | Maximum |
| No. | No. | (g/m²) | No. | (g/m²) | (A) | (B) | Fog | Sensitivity | Density |
| 21 | 2A | 0.175 | — | 0 | 55 | 25 | 0.20 | 100 | 0.8 |
| 22 | 2A | 0.250 | — | 0 | 65 | 35 | 0.23 | 115 | 1.2 |
| 23 | 2A | 0.175 | SH-7 | 0.039 | 55 | 25 | 0.22 | 135 | 3.2 |
| 24 | 2A | 0.250 | ″ | 0.039 | 65 | 35 | 0.24 | 150 | 3.6 |
| 25 | 2B | 0.175 | — | 0 | 48 | 24 | 0.19 | 24 | 1.2 |
| 26 | 2B | 0.250 | — | 0 | 56 | 32 | 0.22 | 28 | 1.9 |
| 27 | 2B | 0.175 | SH-7 | 0.039 | 48 | 24 | 0.19 | 39 | 3.2 |
| 28 | 2B | 0.250 | ″ | 0.039 | 56 | 32 | 0.22 | 43 | 3.5 |
| 29 | 2C | 0.175 | — | 0 | 39 | 23 | 0.18 | 5 | 1.5 |
| 30 | 2C | 0.250 | — | 0 | 47 | 31 | 0.21 | 7 | 2.3 |
| 31 | 2C | 0.175 | SH-7 | 0.039 | 39 | 23 | 0.19 | 12 | 3.2 |
| 32 | 2C | 0.250 | ″ | 0.039 | 47 | 31 | 0.19 | 15 | 3.6 |
| 33 | D | 0.175 | — | 0 | 27 | 22 | 0.18 | 0.02 | 3.4 |
| 34 | D | 0.250 | — | 0 | 32 | 27 | 0.19 | 0.03 | 3.6 |
| 35 | D | 0.175 | SH-7 | 0.039 | 27 | 22 | 0.18 | 0.06 | 3.4 |
| 36 | D | 0.250 | ″ | 0.039 | 32 | 27 | 0.18 | 0.09 | 3.6 |

| | Photographic Properties | | | | | |
|---|---|---|---|---|---|---|
| | | Color | | | | |
| | | Tone of | | | Distinguishability | |
| | | Developed | Raw | | of | |
| Sample | | Silver | Stock | Image | Phantom | |
| No. | Gradation | Images | Storability | Storability | Images | Note |
| 21 | 0.4 | X | 0.25 | 0.01 | X | Comparative |
| 22 | 0.8 | X | 0.35 | 0.08 | X | Comparative |
| 23 | 2.9 | ◯ | 0.02 | 0.01 | ⊚ | Invention |
| 24 | 3.3 | Δ | 0.03 | 0.08 | ◯ | Invention |
| 25 | 0.7 | X | 0.20 | 0.01 | X | Comparative |
| 26 | 1.3 | X | 0.35 | 0.05 | X | Comparative |
| 27 | 3.1 | ◯ | 0.03 | 0.01 | ⊚ | Invention |
| 28 | 3.5 | Δ | 0.04 | 0.05 | ◯ | Invention |
| 29 | 1.1 | Δ | 0.15 | 0.01 | X | Comparative |
| 30 | 1.9 | Δ | 0.18 | 0.03 | X | Comparative |
| 31 | 3.3 | ◯ | 0.05 | 0.01 | Δ | Comparative |
| 32 | 3.7 | Δ | 0.06 | 0.03 | X | Comparative |
| 33 | 3.8 | Δ | 0.13 | 0.01 | X | Comparative |
| 34 | 4.2 | Δ | 0.15 | 0.01 | X | Comparative |
| 35 | 4.8 | Δ | 0.08 | 0.01 | X | Comparative |
| 36 | 5.1 | X | 0.11 | 0.01 | X | Comparative |

2. Evaluation of Photographic Properties

Evaluation was performed similar to Example 1.

The obtained results are shown in Table 5.

The photothermographic materials of the present invention give a high image quality image having high sensitivity, excellent distinguishability of images, excellent quality in haze, gradation, and color tone suitable for medical diagnosis, and were excellent in image storability and raw stock storability.

### Example 3

1. Preparations of Sample

<<Preparation of Dispersion B of Organic Silver Salt>>

A solution was prepared by dissolving 85 g of lime processed gelatin, 25 g of phthalated gelatin in 2 liters of ion-exchange water in a reaction vessel and stirred well (solution A). A solution containing 185 g of benzotriazole and 1405 mL of ion-exchange water (solution B), and 680 g of 2.5 mol/L sodium hydroxide solution were prepared. The solution of the reaction vessel was adjusted to keep the pAg and pH at 7.25 and 8.0, respectively, if required, by adding solution B and 2.5 mol/L sodium hydroxide solution. And the temperature of the mixture was kept at 36° C.

Solution C containing 228.5 g of silver nitrate and 1222 mL of ion-exchange water was added into the reaction vessel at an accelerated flow rate (flow rate: 16 (1+0.002t²) mL/min, wherein t represents time expressed in minute). And then solution B was concurrently added to keep the pAg at 7.25. When the addition of solution C was finished, the process was stopped. And then, solution D containing 80 g of phthalated gelatin and 700 mL of ion-exchange water was added thereto at 40° C., while stirring the resulting reaction solution mixture, the pH of the mixture was adjusted at 2.5 by adding 2 mol/L sulfuric acid to aggregate silver salt emulsion. The aggregates were washed well twice by 5 liters of ion-exchange water. Thereafter the pH and pAg were adjusted to 6.0 and 7.0, respectively, by adding 2.5 mol/L sodium hydroxide solution and solution B to redisperse the aggregates. The obtained silver salt dispersion contained fine crystals of silver salt of benzotriazole.

TABLE 6

| | Silver Halide | | Organic Silver | | | | | | | | |
|---|---|---|---|---|---|---|---|---|---|---|---|
| | Emulsion | | Salt | | Reducing | | | | Compound of Formula | | |
| | | Amount of | | Amount of | Agent | | Nucleator | | (I) or (II) | | |
| | | Coated | | Coated | | Coating | | Coating | | Coating | |
| Sample | | Silver | | Silver | | Amount | | Amount | | Amount | |
| No. | No. | (g/m²) | No. | (g/m²) | No. | (g/m²) | No. | (g/m²) | Kind | (g/m²) | Note |
| 41 | 2A | 0.175 | B | 0.73 | R-1 | 0.46 | — | — | succinimide | 0.38 | Comparative |
| 42 | 2A | 0.175 | B | 0.73 | R-1 | 0.46 | — | — | phthalimide | 0.45 | Comparative |
| 43 | 2A | 0.175 | B | 0.73 | R-1 | 0.46 | — | — | II-1 | 0.48 | Comparative |
| 44 | 2A | 0.175 | B | 0.73 | R-1 | 0.46 | SH-7 | 0.039 | succinimide | 0.38 | Invention |
| 45 | 2A | 0.175 | B | 0.73 | R-1 | 0.46 | SH-7 | 0.039 | phthalimide | 0.45 | Invention |
| 46 | 2A | 0.175 | B | 0.73 | R-1 | 0.46 | SH-7 | 0.039 | II-1 | 0.48 | Invention |
| 47 | 2A | 0.175 | B | 0.73 | R-1 | 0.46 | SH-4 | 0.039 | succinimide | 0.38 | Invention |
| 48 | 2A | 0.175 | B | 0.73 | R-1 | 0.46 | SH-4 | 0.035 | phthalimide | 0.45 | Invention |
| 49 | 2A | 0.175 | B | 0.73 | R-1 | 0.46 | SH-4 | 0.035 | II-1 | 0.48 | Invention |
| 50 | 2A | 0.175 | B | 0.73 | R-1 | 0.46 | SH-9 | 0.042 | succinimide | 0.38 | Invention |
| 51 | 2A | 0.175 | B | 0.73 | R-1 | 0.46 | SH-9 | 0.042 | phthalimide | 0.45 | Invention |
| 52 | 2A | 0.175 | B | 0.73 | R-1 | 0.46 | SH-9 | 0.042 | II-1 | 0.48 | Invention |
| 53 | 2A | 0.175 | B | 0.73 | R1-1 | 0.43 | — | — | succinimide | 0.38 | Invention |
| 54 | 2A | 0.175 | B | 0.73 | R1-1 | 0.43 | — | — | phthalimide | 0.45 | Invention |
| 55 | 2A | 0.175 | B | 0.73 | R1-1 | 0.43 | — | — | II-1 | 0.48 | Invention |
| 56 | 2A | 0.175 | B | 0.73 | R1-3 | 0.48 | — | — | succinimide | 0.38 | Invention |
| 57 | 2A | 0.175 | B | 0.73 | R1-3 | 0.48 | — | — | phthalimide | 0.45 | Invention |
| 58 | 2A | 0.175 | B | 0.73 | R1-3 | 0.48 | — | — | II-1 | 0.48 | Invention |

TABLE 7

| | | | | Haze | | | | |
|---|---|---|---|---|---|---|---|---|
| | | | | Before | After | | | |
| | Reducing | | Compound | Thermal | Thermal | Photographic Properties | | |
| Sample | Agent | | of Formula | Development | Development | | | Maximum |
| No. | No. | Nucleator | (I) or (II) | (A) | (B) | Fog | Sensitivity | Density |
| 41 | R-1 | — | succinimide | 55 | 25 | 0.20 | 100 | 0.5 |
| 42 | R-1 | — | phthalimide | 55 | 25 | 0.19 | 85 | 0.4 |
| 43 | R-1 | — | II-1 | 55 | 25 | 0.21 | 105 | 0.6 |
| 44 | R-1 | SH-7 | succinimide | 55 | 25 | 0.22 | 127 | 3.0 |
| 45 | R-1 | SH-7 | phthalimide | 55 | 25 | 0.21 | 98 | 2.8 |
| 46 | R-1 | SH-7 | II-1 | 55 | 25 | 0.24 | 133 | 2.9 |
| 47 | R-1 | SH-4 | succinimide | 55 | 25 | 0.23 | 135 | 2.8 |
| 48 | R-1 | SH-4 | phthalimide | 55 | 25 | 0.22 | 106 | 2.6 |
| 49 | R-1 | SH-4 | II-1 | 55 | 25 | 0.26 | 138 | 2.7 |
| 50 | R-1 | SH-9 | succinimide | 55 | 25 | 0.20 | 130 | 3.1 |
| 51 | R-1 | SH-9 | phthalimide | 55 | 25 | 0.19 | 105 | 2.9 |
| 52 | R-1 | SH-9 | II-1 | 55 | 25 | 0.21 | 140 | 3.0 |
| 53 | R1-1 | — | succinimide | 55 | 25 | 0.21 | 115 | 3.2 |
| 54 | R1-1 | — | phthalimide | 55 | 25 | 0.20 | 103 | 3.0 |
| 55 | R1-1 | — | II-1 | 55 | 25 | 0.22 | 118 | 3.3 |
| 56 | R1-3 | — | succinimide | 55 | 25 | 0.23 | 121 | 3.5 |
| 57 | R1-3 | — | phthalimide | 55 | 25 | 0.21 | 108 | 3.2 |
| 58 | R1-3 | — | II-1 | 55 | 25 | 0.25 | 125 | 3.6 |

| | Photographic Properties | | | | | |
|---|---|---|---|---|---|---|
| | | Color Tone | | | | |
| | | of | | | Distinguishability | |
| | | Developed | Raw | | of | |
| Sample | | Silver | Stock | Image | Phantom | |
| No. | Gradation | Images | Storability | Storability | Images | Note |
| 41 | 0.4 | X | 0.25 | 0.01 | X | Comparative |
| 42 | 0.3 | X | 0.35 | 0.01 | X | Comparative |
| 43 | 0.5 | X | 0.30 | 0.02 | X | Comparative |
| 44 | 2.7 | ◯ | 0.03 | 0.01 | ⊚ | Invention |
| 45 | 2.5 | Δ | 0.04 | 0.01 | ◯ | Invention |
| 46 | 2.8 | ◯ | 0.05 | 0.02 | ⊚ | Invention |
| 47 | 3.3 | ◯ | 0.05 | 0.01 | ⊚ | Invention |
| 48 | 3.1 | Δ | 0.07 | 0.01 | ◯ | Invention |
| 49 | 3.5 | ◯ | 0.06 | 0.02 | ⊚ | Invention |
| 50 | 3.0 | ◯ | 0.02 | 0.01 | ⊚ | Invention |
| 51 | 2.8 | Δ | 0.03 | 0.01 | ◯ | Invention |
| 52 | 3.2 | ◯ | 0.04 | 0.02 | ⊚ | Invention |
| 53 | 2.9 | ◯ | 0.04 | 0.01 | ⊚ | Invention |
| 54 | 2.7 | Δ | 0.06 | 0.01 | ◯ | Invention |
| 55 | 3.1 | ◯ | 0.05 | 0.02 | ⊚ | Invention |
| 56 | 3.5 | ◯ | 0.07 | 0.01 | ⊚ | Invention |
| 57 | 3.2 | Δ | 0.09 | 0.01 | ◯ | Invention |
| 58 | 3.6 | ◯ | 0.08 | 0.02 | ⊚ | Invention |

The shape of the obtained fine particles of silver salt of benzotriazole was evaluated by an electron microscope. The particles were flake shaped crystals having a mean projected area equivalent diameter of 0.05 μm, a long axis length of 0.2 μm, a short axis length of 0.05 μm, a thickness of 0.05 μm, and a variation coefficient of an projected area equivalent diameter distribution between the particles of 21%.

<<Preparations of Coated Sample>>

The above-described organic silver salt B was used instead of the silver salt of fatty acid of Example 1. The silver halide emulsion, reducing agent, nucleator, and compound of formula (I) or (II), which were used, are shown in Table 6.

2. Evaluation of Photographic Properties

Evaluation was performed similar to Example 1.

The obtained results are shown in Table 7.

The photothermographic materials of the present invention give a high image quality image having high sensitivity, excellent distinguishability of images, excellent quality in haze, gradation, and color tone suitable for medical diagnosis, and were excellent in image storability and raw stock storability.

### Example 4

1. Preparations of Coating Material

1) Preparation of Silver Halide Emulsion E

A tabular silver iodobromide emulsion was prepared.

(Grain Formation)

1178 mL of an aqueous solution prepared by dissolving 0.8 g of potassium bromide and 3.2 g of acid-treated gelatin having an average molecular weight of 20,000 was stirred while maintaining the temperature at 35° C. An aqueous solution containing 1.6 g of silver nitrate, an aqueous solution containing 1.16 g of potassium bromide, and an aqueous solution containing 1.1 g of acid-treated gelatin having an average molecular weight of 20,000 were added to the mixture over a period of 45 seconds by the method of triple jet addition. The concentration of the silver nitrate solution was 0.3 mol/L. Thereafter, the temperature of the mixture was increased to 76° C. over a period of 20 minutes. And then an aqueous solution containing 26 g of succinated gelatin having an average molecular weight of 100,000 was added thereto. An aqueous solution containing 209 g of silver nitrate and the aqueous potassium bromide solution were added by controlled double jet method at an accelerated flow rate over a period of 75 minutes while keeping the pAg at 8.0. For the stage where the grain growth reached to an equivalent to 30 mol % to 90 mol % with respect to total silver amount, silver iodide fine grain having a diameter of 0.03 μm was concurrently added to make the iodide content to a concentration of 6 mol %.

The entire amount of potassium hexachloroiridate (III) was added thereto to give a concentration of 2×10⁻⁵ mol % per 1 mol of silver at 30 minutes after starting the addition of the aqueous silver nitrate solution and the aqueous potassium bromide solution. After addition of gelatin having an average molecular weight of 100,000, the mixture was desalted according to the conventional method. Thereafter, the mixture was dispersed by adding gelatin having an average molecular weight of 100,000. The pH and pAg of the resulting emulsion was then adjusted to 5.8 and 8.0 at 40° C., respectively. Thus prepared emulsion contained 1 mol of silver and 40 g of gelatin per 1 kg of emulsion.

(Chemical Sensitization)

The emulsion prepared above was stirred and subjected to chemical sensitization while keeping the temperature at 56° C. Thiosulfonate compound-1 set forth below was added in an amount of 10⁻⁴ mol per 1 mol of silver halide, and then silver iodide grain having a diameter of 0.03 μm was added thereto in an amount of 0.15 mol %, based on the total silver amount. Three minutes later, thiourea dioxide was added in an amount of 1×10⁻⁶ mol per 1 mol of silver and was subjected to reduction sensitization while keeping the temperature for 22 minutes. Thereafter, 4-hydroxy-6-methyl-1,3,3a,7-tetrazaindene was added in an amount of 3×10⁻⁴ mol equivalent per 1 mol of silver halide, and sensitizing dye-1, -2, and -3 were added in an amount of 1×10⁻⁴ mol equivalent per 1 mol of silver halide, respectively. Furthermore, calcium chloride was added thereto.

Sequentially, sodium thiosulfate and selenium compound-1 were added in an amount of 6×10⁻⁶ mol equivalent, and 4×10⁻⁶ mol equivalent per 1 mol of silver halide, respectively. After the addition, chloroauric acid was added in an amount of 2×10⁻³ mol equivalent per 1 mol of silver halide. Further, nucleic acid (RNA-F, trade name, available from Sanyo-Kokusaku Pulp Co., Ltd.) was added thereto in an amount of 67 mg equivalent per 1 mol of silver halide. 40 minutes later, water-soluble mercapto compound-1 was added in an amount of 1×10⁻⁴ mol equivalent per 1 mol of silver halide, and the mixture was then cooled to 35° C. Thereby, chemical sensitization was finished to obtain silver halide emulsion E.

Chemical sensitization was conducted similar to emulsion A, adjusting the amount of chemical sensitizer so as to show an optimum photographic property.

(Shape of Obtained Grains)

The obtained tabular silver halide grains were tabular silver iodobromide grains having an average iodide content of 3.75 mol %, and 30 mol % to 90 mol % of total silver amount had an iodide content of 6 mol %. The shape of the prepared grains was observed by an electron microscope. The grains had a mean projected area equivalent diameter of 1.004 μm, a mean equivalent spherical diameter of 0.420 μm, a mean grain thickness of 0.049 μm, a mean aspect ratio of 21, and a variation coefficient of a projected area equivalent diameter distribution of 21%.

(Preparation of Silver Halide Emulsion E for Coating Solution)

The silver halide emulsion E was dissolved at 40° C. and thereto was added benzothiazolium iodide in a 1% by weight aqueous solution at 7×10⁻³ mol per 1 mol of silver.

Further, water was added thereto to give the content of silver halide of 38.2 g in terms of silver, per 1 kg of the emulsion for a coating solution. 1-(3-methylureidophenyl)-5-mercaptotetrazole was added to give 0.34 g per 1 kg of the emulsion for a coating solution.

Further, similar to Example 1, “a compound that can be one-electron-oxidized to provide a one-electron oxidation product, which releases one or more electrons” and “a compound having an adsorptive group and a reducing group”, were added in an amount of 2×10⁻⁴ mol per 1 mol of silver in silver halide, respectively.

2) Preparation of Coating Solution for Image Forming Layer

Preparation of coating solution for image forming layer was conducted in a similar manner to the process in the preparation of coating solution for image froming layer of Example 3, except that using silver halide emulsion E for coating solution instead of using silver halide emulsion 2A for coating solution.

3) Preparation of Coating Solution for Crossover Cutting Layer

17 g of poly(vinyl alcohol) PVA-205 (manufactured by Kuraray Co., Ltd.), 9.6 g of polyacrylamide, 70 g of the following dispersion of the solid fine particles of the base precursor, 56 g of the following dispersion of the solid fine particles of the orthochromatic thermal bleaching dye, 0.03 g of benzisothiazolinone, 2.2 g of poly(sodium styrenesulfonate), and 844 mL of water were admixed to give a coating solution for the crossover cutting layer.

The coating solution for the crossover cutting layer was fed to the coating station by controlling the flow speed of the coating solution to give the coating amount of solid content of the orthochromatic thermal bleaching dye of 0.04 g/m².

<Preparation of Dispersion of Solid Fine Particles of Base Precursor>

2.5 kg of base precursor-1, 300 g of a surfactant (trade name: DEMOL N, manufactured by Kao Corporation), 800 g of diphenylsulfone, and 1.0 g of benzoisothiazolinone sodium salt were mixed with distilled water to give the total amount of 8.0 kg. This mixed liquid was subjected to beads dispersion using a horizontal sand mill (UVM-2: manufactured by AIMEX Co., Ltd.). Process of dispersion includs feeding the mixed liquid to UVM-2 packed with zirconia beads having a mean particle diameter of 0.5 mm with a diaphragm pump, followed by the dispersion at the inner pressure of 50 hPa or higher until desired mean particle diameter could be achieved.

Dispersion was continued until the ratio of the optical density at 450 nm to the optical density at 650 nm for the spectral absorption of the dispersion (D₄₅₀/D₆₅₀) became 3.0 upon spectral absorption measurement. The obtained dispersion was diluted with distilled water so that the concentration of the base precursor becomes 25% by weight, and was subjected to filtration (with a polypropylene filter having a mean fine pore diameter of 3 μm) for removing dust to put into practical use.

<Preparation of Dispersion of Solid Fine Particle of Orthochromatic Thermal Bleaching Dye>

Orthochromatic thermal bleaching dye-1 (λ max=566 nm) described in JP-A No. 11-231457 in an amount of 6.0 kg, 3.0 kg of sodium p-dodecylbenzenesulfonate, 0.6 kg of DEMOL SNB (a surfactant manufactured by Kao Corporation), and 0.15 kg of a defoaming agent (trade name: SURFYNOL 104E, manufactured by Nissin Chemical Industry Co., Ltd.) were mixed with distilled water to give the total amount of 60 kg. The mixed liquid was subjected to dispersion with 0.5 mm zirconia beads using a horizontal sand mill (UVM-2: manufactured by AIMEX Co., Ltd.). Dispersion was continued until the ratio of the optical density at 650 nm to the optical density at 750 nm for the spectral absorption of the dispersion (D₆₅₀/D₇₅₀) becomes 5.0 or higher upon spectral absorption measurement. The obtained dispersion was diluted with distilled water so that the concentration of the cyanine dye became 6% by weight, and was subjected to filtration with a filter (mean fine pore diameter: 1 μm) for removing dust to put into practical use. 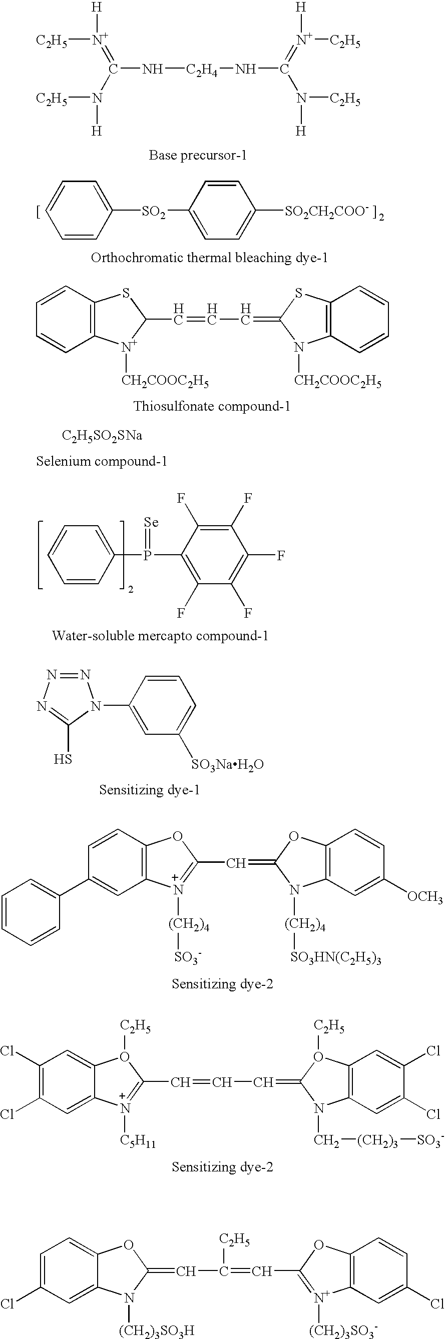
2. Preparations of Coated Sample

Simultaneous overlaying coating by a slide bead coating method was subjected in order of the crossover cutting layer, image forming layer, and surface protective layer on the undercoated support same as that of Example 3, and thus sample photothermographic material was produced. In this method, the temperature of the coating solution was adjusted to 31° C. for the image forming layer and to 36° C. for the surface protective layer. After drying, reverse surface of the support was coated similarly to obtain a double-sided type photosensitive material.

3. Evaluation of Photographic Properties

Thus prepared double-sided coated photothermographic material was evaluated as follows.

Two sheets of X-ray orthochomatic screen HG-M (using as fluorescent substance a terbium activated gadolinium oxysulfide fluorescent substance, emission peak wavelength of 545 nm) produced by Fuji Photo Film Co., Ltd. were used. The assembly for image formation was provided by inserting the sample between them. This assembly was subjected to X-ray exposure for 0.05 seconds, and then X-ray sensitometry is performed. The X-ray apparatus used was DRX-3724HD (trade name) produced by Toshiba Corp., and a tungsten target tube was used. X-ray emitted by a pulse generator operated at three phase voltage of 80 kVp and penetrated through a filter comprising 7 cm thickness of water having the absorption ability almost the same as human body was used as the light source. By the method of distance, varying the exposure value of X-ray, the sample was subjected to exposure with a step wedge tablet having a width of 0.15 in terms of log E. After exposure, the samples were thermally developed under the following thermal developing process condition. Evaluation on an obtained image was performed with a densitometer.

Other than these, evaluation was performed similar to Example 1.

4. Results of Evaluation

Similar to Example 1, the photothermographic materials of the present invention have high sensitivity and low fog, and also exhibit excellent quality in color tone of developed silver images, raw stock storability, and print-out resistance.

What is claimed is:

1. A photothermographic material comprising, on at least one side of a support, an image forming layer comprising at least a photosensitive silver halide, a non-photosensitive organic silver salt, a reducing agent, and a binder, wherein
(1) the photosensitive silver halide comprises tabular grains having a mean aspect ratio of 2 to 100 and a mean equivalent spherical diameter of 0.3 μm to 10 μm;
(2) 50% by weight or more of the binder is a hydrophilic binder;
(3) the photothermographic material comprises a means for nucleation; and
(4) an average gradient of a photographic characteristic curve of the photothermographic material is from 1.8 to 4.3.

2. The photothermographic material according to claim 1, further comprising, as a silver ion carrier, at least one compound represented by the following formula (I) or (II): 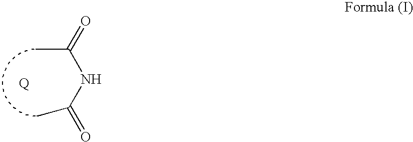
wherein in formula (I), Q represents an atomic group necessary for forming a 5- or 6-membered imide ring; and 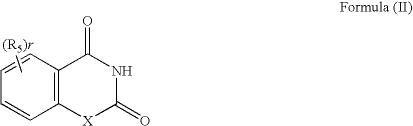
wherein in formula (II), R₅ independently represents one selected from a hydrogen atom, an alkyl group, a cycloalkyl group, an alkoxy group, an alkylthio group, an arylthio group, a hydroxy group, a halogen atom, or an N(R₈R₉) group, wherein R₈ and R₉ each independently represent one selected from a hydrogen atom, an alkyl group, an aryl group, a cycloalkyl group, an alkenyl group, or a heterocyclic group; r represents 0, 1, or 2; R₈ and R₉ may bond to each other to form a substituted or unsubstituted 5 to 7-membered heterocycle; two R₅'s may link together to form an aromatic, heteroaromatic, alicyclic, or heterocyclic condensed ring; and X represents one selected from O, S, Se, or N(R₆), wherein R₆ represents one selected from a hydrogen atom, an alkyl group, an aryl group, a cycloalkyl group, an alkenyl group, or a heterocyclic group.

3. The photothermographic material according to claim 1, wherein the non-photosensitive organic silver salt is a silver salt of fatty acid prepared in the presence of at least one compound selected from among polyacrylamide and derivatives thereof.

4. The photothermographic material according to claim 3, wherein the silver salt of fatty acid has a silver behenate content of 50 mol % or higher.

5. The photothermographic material according to claim 3, wherein the silver salt of fatty acid is nano-particles.

6. The photothermographic material according to claim 5, wherein the nano-particles have a mean particle size of from 10 nm to 1000 nm.

7. The photothermographic material according to claim 1, wherein the means for nucleation is at least one of a nucleator and an infectious developing reducing agent.

8. The photothermographic material according to claim 7, wherein the nucleator is a compound selected from the group consisting of a hydrazine derivative, a vinyl compound, and a quaternary onium compound.

9. The photothermographic material according to claim 8, wherein the hydrazine derivative is a compound represented by the following formula (V): 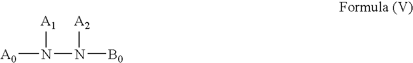
wherein A₀ represents one selected from an aliphatic group, an aromatic group, a heterocyclic group, or a -G₀-D₀ group, each of which may have a substituent; B₀ represents a blocking group; A₁ and A₂ both represent hydrogen atoms, or one of A₁ or A₂ represents a hydrogen atom and the other represents one selected from an acyl group, a sulfonyl group, or an oxalyl group; G₀ represents one selected from a —CO— group, a —COCO— group, a —CS-group, a —C(═NG₁D₁)— group, an —SO— group, an —SO₂— group, or a —P(O)(G₁D₁) group; G₁ represents one selected from a mere bonding hand, an —O— group, an —S— group, or an —N(D₁) group; D₁ represents one selected from an aliphatic group, an aromatic group, a heterocyclic group, or a hydrogen atom, and when a plurality of D₁ exists in one molecule, they may be the same as or different from each other; and D₀ represents one selected from a hydrogen atom, an aliphatic group, an aromatic group, a heterocyclic group, an amino group, an alkoxy group, an aryloxy group, an alkylthio group, or an arylthio group.

10. The photothermographic material according to claim 8, wherein the vinyl compound is a compound represented by the following formula (VI): 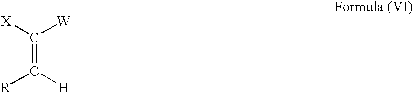
wherein X represents an electron-attracting group; W represents one selected from a hydrogen atom or a group substitutable for a carbon atom; and R represents a group substitutable for a carbon atom.

11. The photothermographic material according to claim 7, wherein the infectious developing reducing agent is a compound represented by the following formula (R1): 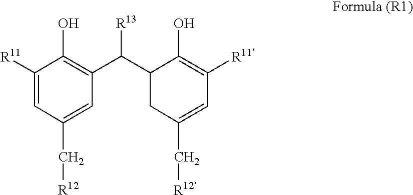
wherein R¹¹ and R^{11′} each independently represent a secondary or tertiary alkyl group having 3 to 20 carbon atoms; R¹² and R^{12′} each independently represent one selected from a hydrogen atom or a group connected through a nitrogen, oxygen, phosphorous, or sulfur atom; and R¹³ represents one selected from a hydrogen atom or an alkyl group having 1 to 20 carbon atoms.

12. The photothermographic material according to claim 11, wherein, in formula (R1), R¹² and R^{12′} each independently represent one selected from a hydrogen atom, a hydroxy group, an alkoxy group, a carbonyloxy group, an aryloxy group, an acyloxy group, an alkylthio group, an arylthio group, an amino group, an anilino group, an acylamino group, a ureido group, a urethane group, a heterocyclic group, or a heterocyclic thio group.

13. The photothermographic material according to claim 12, wherein, in formula (R1), R¹² and R^{12′} each independently represent one selected from a hydrogen atom, a hydroxy group, an alkoxy group, an amino group, or an anilino group.

14. The photothermographic material according to claim 1, wherein the hydrophilic binder is a binder selected from gelatin or a gelatin derivative.

15. The photothermographic material according to claim 1, wherein a ratio of the non-photosensitive organic silver salt relative to the binder in the image forming layer is from 1.0 to 2.5 by mass ratio.

16. The photothermographic material according to claim 1, further comprising a non-photosensitive layer comprising gelatin or a gelatin derivative.

17. The photothermographic material according to claim 16, wherein the non-photosensitive layer is a surface protective layer of the image forming layer.

18. The photothermographic material according to claim 1, comprising the image forming layer on both sides of the support.

19. The photothermographic material according to claim 18, wherein a total coating amount of the photosensitive silver halide on both sides of the support is in a range of from 0.01 g/m² to 0.45 g/m², based on a silver amount.

20. The photothermographic material according to claim 1, wherein an average silver bromide content of the photosensitive silver halide is 60 mol % or higher.

21. The photothermographic material according to claim 20, wherein the average silver bromide content of the photosensitive silver halide is 80 mol % or higher.

22. The photothermographic material according to claim 1, wherein an average silver iodide content of the photosensitive silver halide is 40 mol % or higher.

23. The photothermographic material according to claim 22, wherein the average silver iodide content of the photosensitive silver halide is 80 mol % or higher.

24. The photothermographic material according to claim 23, wherein the silver iodide content of the photosensitive silver halide is 90 mol % or higher.

25. The photothermographic material according to claim 22, further comprising a compound which substantially reduces haze by the photosensitive silver halide after thermal development.

26. The photothermographic material according to claim 25, which comprises a silver iodide complex-forming agent as the compound which substantially reduces haze by the photosensitive silver halide after thermal development.

27. An image forming method comprising:
(a) providing a photothermographic material comprising, on at least one side of a support, an image forming layer comprising at least a photosensitive silver halide, a non-photosensitive organic silver salt, a reducing agent, and a binder, wherein the photosensitive silver halide comprises tabular grains having a mean aspect ratio of 2 to 100 and a mean equivalent spherical diameter of 0.3 μm to 10 μm, 50% by weight or more of the binder is a hydrophilic binder, the photothermographic material comprises a means for nucleation, and an average gradient of a photographic characteristic curve of the photothermographic material is from 1.8 to 4.3;
(b) providing an assembly for forming an image by placing the photothermographic material between a pair of fluorescent intensifying screens;
(c) putting an analyte between the assembly and an X-ray source;
(d) irradiating the analyte with X-rays;
(e) taking the photothermographic material out of the assembly; and,
(f) heating the removed photothermographic material in a temperature range of 90° C. to 180° C.
